(19) United States
(12) Patent Application Publication
(10) Pub. No.: US 2026/0353009 A1
(43) Pub. Date: Nov. 5, 2026

(54) MOTOR ASSEMBLY, TRANSDUCER AND PLAYBACK DEVICE

(71) Applicant: Sonos, Inc., Goleta, CA (US)

(72) Inventors: Naphur van Apeldoorn, Amsterdam (NL); Job Koreman, Delft (NL); Luis Esparza, Boston, MA (US); Daniel Brim, Boston, MA (US); Anthony Ferraro, Somerville, MA (US); Andrei Kozhevnikov, The Hague (NL); Damien Rogers, Amsterdam (NL)

(21) Appl. No.: 19/718,956

(22) Filed: Jun. 24, 2026

Related U.S. Application Data
(63) Continuation of application No. PCT/US2024/061693, filed on Dec. 23, 2024.
(60) Provisional application No. 63/615,008, filed on Dec. 27, 2023.
(60) Provisional application No. 63/657,640, filed on Jun. 7, 2024.
(60) Provisional application No. 63/657,622, filed on Jun. 7, 2024.
(60) Provisional application No. 63/736,477, filed on Dec. 19, 2024.

(51) Int. Cl. H04R 9/02; H04R 1/24; H04R 1/32; H04R 9/04; H04R 9/06

(52) U.S. Cl. CPC H04R 9/025; H04R 1/323; H04R 9/022; H04R 9/045; H04R 9/06; H04R 1/24; H04R 2209/022

(57) ABSTRACT

There is provided a motor assembly for a transducer. The motor assembly comprises a magnetic element, a voice coil at least partially surrounding the magnetic element, and a cover at least partially enclosing the voice coil and the magnetic element. The cover may delimit an opening aligned with a direction of movement of the voice coil. At least part of a magnetic field of the magnetic element is concentrated within the cover. A member coupled to the voice coil may extend through the opening.

### CROSS-REFERENCE TO RELATED APPLICATIONS

This application is a continuation of International Patent Application No. PCT/US 2024/061693, filed Dec. 23, 2024, which claims the benefit of priority to: U.S. Provisional Application No. 63/736,477, filed Dec. 19, 2024; U.S. Provisional Application No. 63/657,622, filed Jun. 7, 2024; U.S. Provisional Application No. 63/657,640, filed Jun. 7, 2024; and U.S. Provisional Application No. 63/615,008, filed Dec. 27, 2023, each of which is hereby incorporated by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, examples, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with examples of the present technology;

FIG. 1B is a schematic diagram of the media playback system of FIG. 1A and one or more networks;

FIG. 1C is a block diagram of a playback device;

FIG. 1D is a block diagram of a playback device;

FIG. 1E is a block diagram of a network microphone device;

FIG. 1F is a block diagram of a network microphone device;

FIG. 1G is a block diagram of a playback device;

FIG. 1H is a partially schematic diagram of a control device;

FIG. 2A is a perspective view depicting an example transducer;

FIG. 2B is a schematic cross-sectional view depicting an example motor assembly of FIG. 2A;

FIG. 3A is a perspective view depicting another example transducer;

FIG. 3B is a schematic cross-sectional view of the transducer of FIG. 3A;

FIG. 4A is a perspective view depicting an example cover with endpieces;

FIG. 4B is a perspective view of the cover of FIG. 4A with one endpiece separated from the cover;

FIG. 5 depicts a plot of magnetic field strength around an example magnetic element;

FIG. 6A depicts a plot of magnetic field strength around another example magnetic element without a cover;

FIG. 6B depicts a plot of magnetic field strength around the magnetic element of FIG. 6A with a first cover having a first thickness;

FIG. 6C depicts a plot of magnetic field strength around the magnetic element of FIG. 6A and a second cover having a second thickness;

FIG. 6D depicts a plot of magnetic field strength around the magnetic element and second cover of FIG. 6C, and two endpieces;

FIG. 7 depicts BL curves for a transducer with and without a cover;

FIG. 8 is a perspective view depicting an example cover formed in two parts;

FIG. 9 is a schematic cross-sectional view of a transducer including two auxiliary magnetic elements;

FIG. 10 is a cross-section perspective view of a part of a transducer including at least one auxiliary magnetic element;

FIG. 11 is a schematic cross-sectional view of a transducer including four auxiliary magnetic elements;

FIG. 12 is a cross-section perspective view of a part of the transducer shown in FIG. 11;

FIG. 13 is a plot of magnetic field flux density around an example magnetic element; and

FIG. 14 is a schematic cross-sectional view of another transducer including two auxiliary magnetic elements.

FIG. 15 is a cross section of a motor assembly of a transducer;

FIG. 16 is a top-down view of the motor assembly of FIG. 2;

FIG. 17 depicts a plot of magnetic flux for an example motor assembly;

FIG. 18A depicts a plot of magnetic flux for an example motor assembly having a central spacer element;

FIG. 18B depicts a plot of the BL value against excursion distance for a voice coil;

FIG. 19 depicts a plot of magnetic flux for an example motor assembly having end pieces;

FIG. 20 depicts a plot of magnetic flux for another example motor assembly having end pieces;

FIG. 21A depicts a plot of magnetic flux for an example motor assembly having end pieces which vary in thickness;

FIG. 21B is a schematic diagram of the motor assembly of FIG. 8A;

FIGS. 22 to 24 depict plots of magnetic flux for example motor assemblies having spacer elements with varying cross-sectional widths;

FIG. 25 depicts a plot of magnetic flux for an example motor assembly having a gap between the magnetic portions;

FIG. 26 depicts a plot of magnetic flux for an example motor assembly having a wider central spacer element between the magnetic portions;

FIG. 27 is a cross section of a motor assembly having two voice coils;

FIG. 28 is a cross section of a motor assembly having a single magnetic portion extending around the voice coil, the voice coil being in a rest position;

FIG. 29 is a cross section of the motor assembly of FIG. 28, the voice coil being displaced from the rest position;

FIG. 30 is a cross section of another motor assembly having two voice coils;

FIG. 31A is a perspective view depicting an example transducer;

FIG. 31B is an exploded view depicting the example transducer of FIG. 31A;

FIG. 32 is a schematic cross-sectional view of the transducer of FIG. 31A;

FIG. 33A is a perspective view of a blank for use in producing an example cover of the transducer of FIG. 31A;

FIG. 33B is a perspective view of an example cover formed from the blank of FIG. 31A;

FIG. 34 is a perspective view depicting another example transducer; and

FIG. 35 is an exploded view depicting an example cover for use with the transducer of FIG. 34.

The drawings are for the purpose of illustrating example examples, but those of ordinary skill in the art will understand that the technology disclosed herein is not limited to the arrangements and/or instrumentality shown in the drawings.

### DETAILED DESCRIPTION

### I. Overview

Embodiments described herein relate to motor assemblies for transducers, where a motor assembly comprises a magnetic element (such as a stack of magnets), around which one or more voice coils extend, and a cover extending around the magnetic element and voice coil(s). In some examples, a motor assembly comprises a plurality of magnetic elements, around which respective voice coils extend, and the cover extends around at least two of the plurality of magnetic elements and respective voice coils. Example covers described herein are made from a material that causes a magnetic field of the magnetic element to be concentrated within the cover. For example, the magnetic field may flow out of the magnetic element, through the cover and back into the magnetic element.

In examples described herein, the motor assembly further includes a member coupled to the voice coil, and the member extends through an opening formed in the cover. The cover therefore delimits an opening through which the member can extend. The use of an opening through the cover allows the motor assembly to have a low profile for at least the reason that the member does not need to be routed around the cover, such as out of one end of the cover. Having an opening may also provide thermal benefits, such as reducing heat retained by the cover. As will be explained in more detail below, the member may form at least part of a spider or an actuating element for transferring movement of the voice coil to a membrane of the transducer.

The cover itself may act as a magnetic field return path, and form part of a magnetic circuit for the magnetic field of the magnetic element. At least part of the magnetic field of the magnetic element may therefore be “captured”, “concentrated” or “contained” within the cover. This reduces the reluctance of the motor, and may improve efficiency. The use of a cover may also allow the volume of magnetic material in the magnetic element to be reduced (such as by around 50-75%) while maintaining the same BL value for the transducer, or substantially the same BL (e.g., a BL approximately 90% or greater compared to the BL of an uncovered magnetic assembly). Alternatively, the use of a cover can increase the BL value for the same volume of magnetic material in the magnetic element. A higher BL value on a BL curve can mean the transducer has a higher sensitivity, better efficiency and/or improved control. Surprisingly, covers with one or more openings formed in them have been found to perform similarly to continuous covers. As such, having the member extend through the opening may combine the benefits of the opening with the benefits of the cover.

Accordingly, in a first aspect of the present disclosure, there is provided a motor assembly for a transducer, the motor assembly comprising: (i) a magnetic element, (ii) a voice coil at least partially surrounding the magnetic element, (iii) a cover at least partially enclosing the voice coil and the magnetic element, and delimiting an opening, the opening aligned with a direction of movement of the voice coil. At least part of a magnetic field of the magnetic element is concentrated within the cover. The motor assembly further comprises: (iv) a member coupled to the voice coil, the member extending through the opening.

In examples, “concentrated within the cover” may mean that at least part of the magnetic field of the magnetic element flows through the cover, such as within the cover, and/or that at least part of the magnetic field is diverted or directed along the cover. The magnetic field of the magnetic element may flow through the cover in a direction generally parallel to the direction of movement of the voice coil.

The cover may be referred to as a “magnetic shield” or “shield” because it may fully or partially block the magnetic field from extending beyond an outer surface of the cover.

The cover may comprise a material that causes the magnetic field to be concentrated within it.

The term “concentrated” may not necessarily mean the magnetic field is the strongest (i.e., most concentrated) inside the cover, but instead may mean that the magnetic field is more concentrated at this point in space than it would be if the cover was not present. The cover may therefore cause the magnetic flux density at this point in space to be increased.

In examples, “a magnetic field of the magnetic element” may mean that the magnetic element has or generates the magnetic field.

In examples “at least partially enclosing the voice coil and the magnetic element” may mean that the cover at least partially extends around or surrounds the voice coil and magnetic element. The magnetic element, such as one or more ends of the magnetic element, may extend beyond and/or out of one or more ends of the cover. In other examples, the cover has a length (measured in the direction of movement of the voice coil) that is greater than a length of the magnetic element such that the magnetic element does not extend out of one or more ends of the cover. In both examples, the magnetic element and voice coil may be said to be at least partially enclosed within a space defined by the cover. In some cases, the magnetic element and voice coil may be fully enclosed by the cover, such as when ends of the cover are closed.

The cover may be tubular, such as cylindrical. The voice coil and magnetic element may have the same shaped profile as the magnetic element (for example, the magnetic element and voice coil may both be cylindrical, and the cover may also be cylindrical). Having the same shaped profile can mean the components can have a closer fit, reducing the spacing between the components and reducing the overall size of the motor assembly.

In examples, “aligned with a direction of movement of the voice coil” may mean that the opening may extend at least partially along the cover in the direction of movement of the voice coil. The opening may extend at least partially along a surface of the cover. In some examples, the opening may extend fully along the length of the cover.

The opening may be elongated, an aperture, a slit, a slot, an elongated opening, an elongated aperture, a hole, a gap, a receptacle, a void, etc. The opening may have a longest dimension in the direction of movement of the voice coil.

The opening may extend through a surface of the cover. The opening may be formed through the cover in a direction perpendicular to the direction of movement. The opening may be formed through the cover from an outer surface of the cover to an inner surface of the cover, the inner surface being closer to the magnetic element than the outer surface. The direction perpendicular to the direction of movement may be referred to as a radial direction. In some examples, the opening is delimited or defined by one or more edges or boundaries of the cover.

A surface of the cover may extend parallel to the direction of movement of the voice coil. In other examples, at least some parts of the surface do not extend parallel to the direction of movement (for example, the cover may bend towards or away from the magnetic element at various points along its length, rather than having a continuous cross-sectional dimension, or width, along its length). In such cases, the opening may nevertheless still extend at least partially along the cover in a direction of movement of the voice coil, even if the surface of the cover is not parallel to the direction of movement.

The member may be a moveable member and may move along the opening in the direction of movement of the voice coil in use (i.e., as the voice coil moves).

The member may be coupled directly to the voice coil in some examples, or may be indirectly coupled, such as via a voice coil support, in other examples.

The cover may delimit one or more openings, such as two or more openings. One or more members may extend through each opening. In some examples, some openings do not have a member extending therethrough.

The voice coil(s) may at least partially extend around the magnetic element.

The voice coil may be arranged to generate a magnetic field for interacting with the magnetic field of the magnetic element to move a membrane of the transducer along an axis of the magnetic element relative to the magnetic element. The axis of the magnetic element may be a longitudinal axis and the axis may be aligned with the direction of movement of the voice coil. The direction of movement of the voice coil may therefore be parallel to a longitudinal axis of the magnetic element. The voice coil(s) may remain stationary while one or more corresponding magnetic elements move.

The cover may fully or at least partially surround the voice coil(s) along an entire excursion range(s) of the voice coil(s), or at least a portion thereof.

The magnetic element (which may alternatively be referred to as a magnet stack or a magnet assembly) may comprise one or more magnets, such as a stack of two or more magnets. The magnetic field of the magnetic element may therefore be a combined magnetic field from two or more magnets. In some cases, magnets may be separated by one or more spacer elements. A spacer element may be referred to as a pole piece, in some examples. The magnetic element may comprise two or more magnets coupled together (and in some cases, with one or more spacer elements between the magnets). In other examples, the magnetic element may be monolithic, and may comprise two or more magnets formed from a single piece of material that has been magnetized. The magnets within the magnetic element may be linearly arranged, along an axis of the magnetic element. The magnetic element may therefore be a linear magnetic element.

The cover may be integrally formed (that is, formed as a single piece, and is therefore monolithic). In other examples, the cover may be comprised of separate parts, such as one or more parts that are joined or otherwise coupled together.

The motor assembly may comprise one or more motors for driving one or more membranes. A motor, for example, may comprise a magnetic element and one or more voice coils that are coupled to a membrane (or one or more membranes). The motor may drive the membrane to generate acoustic waves that propagate away from the membrane. At least one motor and at least one membrane may form a transducer. A single membrane may be driven by one or more motors. A single motor may drive one or more membranes. For example, in some cases, a motor may comprise two voice coils, each voice coil being coupled to a different membrane to drive the membranes.

The member may form at least part of either: (i) a suspension element for coupling the voice coil to a support structure, or (ii) an actuating element for coupling the voice coil to a membrane of the transducer.

The suspension element or actuating element can therefore extend through the opening in the cover, reducing the volume occupied by the motor assembly. Having the opening aligned with the direction of movement of the voice coil, and therefore extend at least partially along the cover, allows the member to move along the opening as the voice coil moves and transfers motion to the member.

The suspension element may alternatively be referred to as a spider. The member may form an arm of the suspension element/spider. The support structure may be a basket or frame of a speaker or playback device within which the motor assembly and transducer are located. The actuating element may be or comprise a rib, for example, and the rib may therefore extend through the opening. The actuating element may be rigid, in some examples, and transfer movement of the voice coil to the membrane.

The suspension element may be directly or indirectly coupled to the voice coil. Similarly, the actuating element may be directly or indirectly coupled to the voice coil. In an example, the voice coil is at least partially contained within or is affixed to a voice coil support and the suspension element and/or actuating element may be coupled to the voice coil support. The voice coil support may extend around the magnetic element.

The opening may be a first opening and the member may be a first member, and the cover may further delimit a second opening and the motor assembly may further comprise a second member coupled to the voice coil, the second member extending through the second opening, where the first and second members both form at least part of a suspension element (either a separate or the same suspension element) that couples the voice coil to the support structure, or both form at least part of an actuating element (either a separate or the same actuating element) that couples the voice coil to the membrane. In other words, both members may therefore perform the same function.

The membrane may be a first membrane, and the transducer may comprise a second membrane.

The cover may comprise a magnetizable material. The material may comprise a material with a high relative permeability (μᵣ), such as greater than 100, so that the cover has a generally low reluctance.

The cover may comprise at least one of: a ferromagnetic material, a ferrimagnetic material, or a paramagnetic material. Such materials are expected to have the effect of concentrating the magnetic field within the cover, thereby providing a low reluctance return path. The cover may comprise one or more of these materials.

The material may consist or comprise soft iron, or may consist of or comprise steel, such as a low carbon steel, 1010 carbon steel, 1018 carbon steel, and/or an alloy(s) thereof. In some examples, the material may consist of or comprise cobalt, nickel, and/or an alloy(s) therof.

The cover may have a thickness, measured perpendicular to the direction of movement of the voice coil (or magnet(s)), of between about 0.5 mm and about 3 mm. For typical transducers (and magnets used within the magnetic element) thicknesses within this range are expected to provide a good balance between avoiding or reducing magnetic field saturation within the cover and reducing the cost/weight of the cover. In particular examples, the thickness may be between about 1 mm and about 3 mm, such as between about 1.5 mm and about 2.5 mm, such as 2 mm. More generally, the cover may have a thickness based on a magnetic field strength of the magnetic element. The thickness may be a wall thickness of the cover.

The cover may have a thickness measured perpendicular to the direction of movement of the voice coil, and the thickness is non-uniform along its length. This can allow the thickness of the cover to be varied at different points along its length, which can be useful to minimize the weight/cost of the cover. For example, the cover can be made thicker in places where the magnetic field strength/flux is stronger, and thinner at other points. The length of the cover may be a longest dimension of the cover and/or be measured in a direction parallel to the direction of movement of the voice coil, or a longitudinal axis of the voice coil.

The cover may compris a first end and at least a second end, and wherein the cover is closed at at least one of the first end and the second end, such that at least part of the magnetic field is concentrated within the cover at at least one of the first end and the second end. In a particular example, the cover comprises first and second ends, and one or both ends are closed. At the closed end(s), at least part of the magnetic field may be concentrated within the cover as a result of the end(s) being closed. Closing one or both ends of the cover further reduces the reluctance of the motor assembly (thereby increasing the efficiency). Having all, such as both, ends closed can close the magnetic return path of the magnetic element.

The ends may be closed by an endpiece of the cover. For example, a first end of the cover may be closed by a first endpiece and a second end of the cover may be closed by a second endpiece. The magnetic field may therefore be concentrated in the endpiece(s). The cover may comprise a body portion and one or more endpieces. The endpiece(s) may be integrally formed with the body portion (so formed as a single piece, and therefore be monolithic) or may be affixed to the body portion. The endpiece(s) may be formed from the same material as the body portion. The magnetic element may be fully enclosed by the cover at one or both ends of the cover as a result of the cover being closed. The cover may therefore form an enclosure for the magnetic element.

The cover may comprise a body portion and an endpiece, the endpiece and body portion being integrally formed. Having the endpiece integrally formed with the body portion of the cover may allow the magnetic element to be assembled inside the cover, with the endpiece acting as a base or support for the magnetic element. Having the components integrally formed rather than affixed to each other can also further reduce the reluctance by avoiding discontinuities in the material. In an example, the cover is integrally formed with one end piece (such as a first end piece), and a second endpiece may be affixed to the cover at the opposite end during manufacture. The cover may be cup-shaped, such as having a generally U-shaped cross section.

The cover may delimit a plurality of openings, each opening aligned with the direction of movement of the voice coil and the cover has at least one of: (i) rotational symmetry about an axis that is parallel to the direction of movement of the voice coil, or (ii) mirror symmetry about a line of symmetry that is perpendicular to the direction of movement of the voice coil.

Having rotational and/or mirror symmetry (by having the openings spaced apart from each other (and/or having particular widths/gaps) means that magnetic field is more uniformly distributed through the cover, which improves efficiency and operation of the motor assembly.

Rotational symmetry may mean that the cover has a rotational order of at least 2. Mirror symmetry may mean that the cover has at least one line of symmetry, each line of symmetry being perpendicular to the direction of movement of the voice coil.

The plurality of openings may be spaced apart from each other (distributed around the surface of cover) such that the cover has the rotational symmetry and/or mirror symmetry. Each opening may have a width or gap, the widths/gaps being dimensioned such that the cover has the rotational symmetry and/or mirror symmetry. For example, the openings may all have the same width or at least one opening may have a different width to another opening.

Additional openings may be present that are not aligned with the direction movement (that is, additional to the plurality of openings).

The cover may be stamped from a sheet of material. Stamping is a relatively inexpensive manufacturing process and allows the shape, and/or thickness of the cover to be easily controlled. The sheet of material may have a desired thickness, and in some cases, may have a varied thickness along the sheet.

In other examples, the cover could be forged, 3D printed, or cast.

In some examples, the opening is a first opening, the member is a first member, the voice coil is a first voice coil, and the motor assembly further comprises: (i) a second voice coil at least partially surrounding the magnetic element and offset along the magnetic element from the first voice coil, and (ii) a second member coupled to the second voice coil, the cover further delimiting a second opening aligned with the direction of movement of the second voice coil (such as extending at least partially along the cover in the direction of movement of the second voice coil), the second member extending through the second opening, and (iii) a midpiece extending between the first and second voice coils, wherein at least part of the magnetic field of the magnetic element is concentrated within the midpiece, and wherein the magnetic element comprises a first magnetic portion and a second magnetic portion, the midpiece extending between the first and second magnetic portions.

The midpiece may be part of the cover, or may be a separate element, but may nevertheless perform the same function as the cover, concentrating the magnetic field within it, and reducing the reluctance. The midpiece also reduces magnetic field interference between the two voice coils.

The midpiece may be formed of the same material as the cover.

A midpiece may alternatively be referred to as an extension pole piece.

As mentioned, the midpiece may be a part of the cover (the midpiece and a body portion of the cover may be integrally formed/monolithic), or they may be affixed to each other, or may be separate. The midpiece may be part of a magnetic assembly, the magnetic assembly comprising the magnetic element and the midpiece extending through the magnetic element (one or more magnets of the magnetic element may be separated by the midpiece). The midpiece and cover may abut.

The first voice coil may drive a first membrane of the transducer and the second voice coil may drive a second membrane of the transducer, where the first and second membranes are arranged at opposite ends of the magnetic element. As such, the first and second membranes may be said to be arranged back-to-back. This “back-to-back” configuration may allow sound to be directed in different directions into a room, filling the room and/or providing a particular sound profile. In examples, the first membrane is configured to generate a first acoustic wave, the second membrane is configured to generate a second acoustic wave, and the first and second acoustic waves are directed away from the motor assembly in substantially opposite directions.

The magnetic element may be arranged along an axis that extends through midpoints of the first and second membranes.

The second member may form at least part of either: (i) a second suspension element for coupling the second voice coil to a support structure, or (ii) a second actuating element for coupling the second voice coil to a second membrane of the transducer.

In examples where the midpiece and cover are not integrally formed, a single opening of the cover may form the first and second openings as a result of the midpiece being arranged relative to the opening (effectively partitioning the opening into two separate openings separated by the midpiece).

The first and second openings may be aligned with each other along the cover in the direction of movement of the voice coils, such as above and below the midpiece. The two openings may be aligned in a direction parallel to an axis of the magnetic element, such as above and below the midpiece.

The cover may delimit a plurality of openings (including the first and second openings), and the plurality of openings each have the same width/gap and are equally spaced apart around the cover. The cover may therefore have rotational symmetry.

In a particular example, the cover has 6 or 8 openings, and at least two members extend through each opening, one of the at least two members forming part of a suspension element and another of the at least two members forming at least part of an actuating element.

In examples where the midpiece and cover are integrally formed or affixed to each other, the cover may have an H-shaped cross section.

The midpiece may comprise one or more protrusions extending beyond an outer surface of the cover. One or more protrusions can allow the cover and/or midpiece to be secured to a support structure, such as a basket or frame of the speaker/playback device.

In some examples, the cover comprises: (i) a first cover part, the first cover part delimiting the first opening and comprising a first base, (ii) a second cover part, the second cover part delimiting the second opening and comprising a second base, and wherein the first and second cover parts are arranged relative to each other such that the first base abuts the second base, and the first and second base form the midpiece.

The cover comprising the midpiece may therefore be manufactured easily from two parts, which are joined during manufacture. The midpiece being formed in this way also helps to locate the magnetic element. The first magnetic portion of the magnetic element can be located on the first base and be at least partially enclosed within the first cover part, and the second magnetic portion can be located on the second base and be at least partially enclosed within the second cover part.

The midpiece may therefore be a part of the cover. The first and second cover parts may be cup-shaped, such as having a U-shaped cross section. The first and second cover parts may be affixed to each other via the two bases. The first and second cover parts may each form half of the cover.

The first and second cover parts may be identical.

The motor assembly may further comprise a third member coupled to the first voice coil and extending through the first opening, wherein the first member forms at least part of a suspension element for coupling the first voice coil to a support structure and the third member forms at least part of an actuating element for coupling the voice coil to a membrane of the transducer. Accordingly, in examples where the magnetic element can be used to drive two membranes (by having first and second voice coils), the same opening in the cover can be used for two members performing different functions. This can reduce the number of openings required.

As briefly mentioned, in some examples, at least part of the cover and at least part of the midpiece are integrally formed. Having the midpiece integrally formed with the cover provides an effective method of assembly by allowing the first and second magnetic portions of the magnetic element to be assembled inside the cover, with the midpiece acting as a base or support for the first and second magnetic portions. Having the components integrally formed rather than affixed to each other may also further reduce the reluctance by avoiding discontinuities in the material.

Open ends of the cover may be closed by one or more endpieces, such as after first and second magnetic portions and voice coils have been assembled within the cover.

In some examples, the opening is a first opening, and the cover delimits a plurality of openings including the first opening, a second opening, a third opening and a fourth opening, each opening of the plurality of openings aligned with the direction of movement of the voice coil. The member is a first member, and the motor assembly comprises a plurality of members coupled to the voice coil, the plurality of members including the first member, a second member, a third member and a fourth member, the second member extending through the second opening, the third member extending through the third opening and the fourth member extending through the fourth opening. The first and second members form at least part of a suspension element for coupling the voice coil to a support structure and the third and fourth members form at least part of an actuating element for coupling the voice coil to a membrane of the transducer.

Accordingly, two members provide suspension for the voice coil and two members transfer motion to the membrane of the transducer. Having two members for each function allows forces exerted on the members to be balanced and distributed more evenly.

The suspension element may comprise two arms, for example. The first and second members may be arms of the suspension element. As such, one arm may extend through the first opening and another arm may extend through the second opening. The actuating element may comprise two ribs, for example. The third and fourth members may be ribs. As such, one rib may extend through the third opening and another rib may extend through the fourth opening.

The first and second openings may have a first width, and the third and fourth openings may have a second width, the first and second widths being different. A width of an opening may be measured around the surface of the cover, in a plane perpendicular to the direction of movement of the voice coil. For example, if the cover is cylindrical, the width may be measured around the circumference. Adapting the widths of the different openings for the different functions can decrease the size of the openings where their function permits, which may reduce the reluctance by concentrating a higher proportion of the magnetic field.

The plurality of openings may be spaced apart around the cover such that the cover has mirror symmetry.

The voice coil may have a first thickness in a radial direction that is perpendicular to the direction of movement of the voice coil, and wherein the magnetic element and the cover are separated, at at least one position along an excursion path of the voice coil, by a distance in the radial direction that is less than four times the first thickness. In other examples the distance may be less than 1.3×, less than 1.5×, less than 1.67×, less than 2×, or less than 3× the first thickness. Reducing the distance between the cover and the voice coil reduces the overall size of the motor assembly, enabling a more compact transducer and playback device.

The motor assembly may further comprise an auxiliary magnetic element arranged between the magnetic element and the cover. The auxiliary magnetic element: (i) is coupled to the voice coil, such that movement of the voice coil causes the auxiliary magnetic element to move, and (ii) has a second magnetic field arranged relative to the magnetic field of the magnetic element such that a magnetic flux density through the voice coil and cover is increased. As will be explained in more detail below, the presence of an auxiliary magnetic field may provide a magnetic assist or boost that effectively overcomes inherent stiffnesses in the system. The motor assembly may comprise one or more auxiliary magnetic elements in certain examples. The one or more auxiliary magnetic elements may have any or all of the features/arrangements discussed below in the third aspect.

According to a second aspect of the present disclosure, there is provided a media playback system comprising the playback device of the third aspect, and at least one further playback device. The system may further comprise a controller configured to send an instruction to the playback device to cause the playback device to play back audio.

In some examples, the cover does not delimit an opening. As such, in some cases, the motor assembly may not include a member that extends through the opening.

According to a third aspect of the present disclosure, there is provided a motor assembly for a transducer, the motor assembly comprising: (i) a magnetic element having a longitudinal axis, (ii) a voice coil at least partially surrounding the magnetic element, the voice coil being moveable in a direction parallel to the longitudinal axis, (iii) a cover at least partially enclosing the voice coil and the magnetic element, wherein at least part of a magnetic field of the magnetic element is concentrated within the cover, and (iv) an auxiliary magnetic element arranged between the magnetic element and the cover. The auxiliary magnetic element: (a) is coupled to the voice coil, such that movement of the voice coil causes the auxiliary magnetic element to move, and (b) has a second magnetic field arranged relative to the magnetic field of the magnetic element such that a magnetic flux density through the voice coil and cover is increased.

As briefly mentioned earlier, the presence of the second magnetic field from the auxiliary magnetic element increases the magnetic flux density through the voice coil and increases the magnetic flux that is concentrated within the cover. The presence of the auxiliary magnetic element can cause a greater proportion of the magnetic field of the magnetic element to be focused onto the voice coil. The increased flux through the voice coil provides a magnetic assist or boost that effectively overcomes inherent stiffnesses in the system. The auxiliary magnetic element may therefore contribute a negative stiffness to movement of the voice coil. In particular, as the voice coil moves axially away from a rest position (i.e., along the longitudinal axis due to current passing through the voice coil), the magnetic interactions between the magnetic field of the magnetic element and the magnetic field of the auxiliary magnetic element amplifies this motion over at least a portion of an excursion range/path of the voice coil, thereby urging both the voice coil and the auxiliary magnetic element further away from the rest position. This amplification may contribute a negative stiffness to movement of the voice coil and a coupled membrane along the excursion axis. The use of the cover (within which the magnetic field of the magnetic element is concentrated) reduces the reluctance of the motor, and may improve efficiency, as discussed earlier. The presence of the auxiliary magnetic element can cause a greater proportion of the magnetic field of the magnetic element to be concentrated within the cover.

The use of an auxiliary magnetic element and cover also allows the volume of magnetic material in the magnetic element to be reduced while maintaining substantially the same BL value for the transducer. Alternatively, the use of the auxiliary magnetic element and cover can increase the BL value for the same volume of magnetic material in the magnetic element. A higher BL value on a BL curve can mean the transducer has a higher sensitivity, better efficiency and/or improved control. Together, the cover and auxiliary magnetic element interact synergistically to provide an improved motor assembly.

The magnetic flux density through the coil may be increased in a direction perpendicular to the longitudinal axis and/or a winding axis of the voice coil (the winding axis being arranged parallel to the longitudinal axis). This results in a larger force exerted on the coil due to the interaction between the coil's magnetic field and the magnetic field of the magnetic element.

The magnetic flux density entering the cover may be increased in a direction perpendicular to the longitudinal axis. This causes the magnetic field lines to be concentrated within the cover, and the flux density through the cover is increased in a direction parallel to an outer surface of the cover, the outer surface of the cover being arranged parallel to the longitudinal axis. As mentioned, this may result in a lower reluctance for the motor.

The auxiliary magnetic element may be arranged above or below the voice coil, that is, displaced/offset from the voice coil in a direction parallel to a direction of movement of the voice coil. In such cases, the auxiliary magnetic element may have a magnetic axis that is aligned parallel to the direction of movement of the voice.

In other examples, the auxiliary magnetic element may be arranged inside or outside of the voice coil relative to the magnetic element, that is, displaced/offset from the voice coil in a direction perpendicular to the direction of movement of the voice coil. In such cases, the auxiliary magnetic element may have a magnetic axis aligned perpendicular to the direction of movement of the voice coil. In one arrangement, the voice coil is arranged between the magnetic element and the auxiliary magnetic element.

In examples, “offset” may mean that the elements offset from each other are spaced apart by a gap. In other examples, the elements offset from each other may abut each other, i.e., they may be contiguous.

The motor assembly (and in particular the cover) may have any or all of features discussed above in respect of the first aspect. For example, the cover may delimit an opening, and the opening is aligned with a direction of movement of the voice coil. As discussed above, a member that is coupled to the voice coil may extend through the opening. In other examples, the cover does not include an opening.

The auxiliary magnetic element may extend fully or partially around the magnetic element (for example, the auxiliary magnetic element may be ring shaped/annular).

The auxiliary magnetic element may be directly or indirectly coupled to the voice coil, and be moveable with the voice coil. For example, the auxiliary magnetic element may be directly coupled to a voice coil support or an actuating element (where the actuating element is coupled to a membrane). As such, in one example, the motor assembly may further comprise a voice coil support, and the auxiliary magnetic element and voice coil are coupled to the voice coil support. In another example, the motor assembly may further comprise an actuating element which is coupled to a membrane of the transducer, and the auxiliary magnetic element is coupled to the actuating element. For example, the auxiliary magnetic element may be coupled to one or more ribs. In an example, the actuating element is coupled to the voice coil support.

The motor assembly may comprise a membrane actuating element, and the membrane actuating element includes one or more voice coils and, in some examples, the auxiliary magnetic element.

The auxiliary magnetic element may be injection molded or overmolded on the voice coil support or actuating element.

The auxiliary magnetic element may be a permanent magnet or an electromagnet.

As mentioned, movement of the voice coil causes the auxiliary magnetic element to move. The voice coil and auxiliary magnetic element therefore move together/in unison/tandem. In examples, the voice coil and auxiliary magnetic element move together with a fixed/constant spacing between them.

The cover may be spaced apart from the magnetic element to provide a gap in which the voice coil and auxiliary magnetic element are arranged.

The voice coil is moveable along the magnetic element.

The auxiliary magnetic element may be offset from the voice coil along the direction of movement of the voice coil, and wherein the magnetic flux density through the voice coil and cover is increased by arranging the second magnetic field relative to the magnetic field of the magnetic element such that the magnetic field of the magnetic element is focused onto the voice coil and into the cover. For example, the auxiliary magnetic element may be arranged above or below the voice coil (in an outward or inward direction relative to the direction of movement of the voice coil).

Arranging the auxiliary magnetic element in this manner, and in particular the second magnetic field, may “focus”, “push” or “deflect” any stray magnetic flux of the magnetic element onto the voice coil. This results in a larger force exerted on the voice coil due to the interaction of the magnetic field of the voice coil and the magnetic field of the magnetic element. A greater proportion of the magnetic field of the magnetic element is therefore arranged perpendicular to the direction of movement of the voice coil. This arrangement may also focus a greater proportion of the magnetic field into the cover, which reduces the reluctance of the motor.

The magnetic flux density may be increased in a direction that is perpendicular to the longitudinal axis and/or a winding axis of the voice coil. In some cases, the auxiliary magnetic element is displaced/offset from the voice coil by a distance that is less than a maximum excursion distance of the voice coil. A winding axis of a voice coil is the axis around which the wire(s) of the voice coil extend around.

“Arranging the second magnetic field relative to the magnetic field of the magnetic element” may mean arranging the auxiliary magnetic element itself.

The auxiliary magnetic element may have a magnetic axis substantially aligned with the direction of movement of the voice coil. Magnetic poles of the auxiliary magnetic element may be aligned in substantially the same direction as a part of the magnetic element arranged adjacent the auxiliary magnetic element.

The voice coil may have a first dimension in a radial direction perpendicular to the longitudinal axis, and the auxiliary magnetic element may have a second dimension in the radial direction, wherein the second dimension is greater than the first dimension.

Having the auxiliary magnetic element extend further between the magnetic element and the cover than the voice coil may help guide the magnetic field of the magnetic element into the cover even after it has passed through the voice coil, which further reduces the reluctance of the motor assembly.

The first and second dimensions are measured in the gap between the magnetic element and the cover. The auxiliary magnetic element therefore spans a larger distance within the gap than the voice coil. The first and second dimensions may be first and second thicknesses or cross-sectional widths.

An inner surface of the cover may be spaced from the magnetic element by a gap width in a radial direction perpendicular to the longitudinal axis, and the auxiliary magnetic element may have a dimension in the radial direction which is between about 50% and 95% of the gap width, between about 50% and 75% of the gap width, between about 50% and 60% of the gap width, or about 50% of the gap width. The dimension may be a thickness or cross-sectional width.

To guide/focus a high proportion of the magnetic flux of the magnetic element into the cover, the auxiliary magnetic element may occupy a high proportion of the space within the gap. However, tolerance or space must be left for the voice coil to move perpendicular to the longitudinal axis so that movement in the direction of the longitudinal axis is possible. A dimension/thickness within these ranges has been found to provide a good balance between these considerations. In a particular example, the voice coil and the auxiliary magnetic element have the same dimension in the radial direction.

The radial extent of the auxiliary magnetic element may be dependent on the radial movement of the voice coil and the spacings between the magnetic element and the auxiliary magnetic element and between the auxiliary magnetic element and the cover. These spacings may each be 0.8-1.0 mm, in certain examples.

The voice coil and auxiliary magnetic element are arranged in the gap between the magnetic element and the cover. The dimension/thickness of the auxiliary magnetic element is less than the gap width.

The gap may be the sum of: (i) the thickness of the auxiliary magnetic element or thickness of the voice coil in examples where the auxiliary magnetic element has the same dimension as the voice coil), (ii) the spacing between the magnetic element and the auxiliary magnetic element, and (iii) the spacing between the auxiliary magnetic element and the cover. As mentioned, the spacings may each be 0.8-1.0mm. In general, a transducer designed for lower frequencies has a larger voice coil resulting in a larger gap between the magnetic element and the cover. In examples, the radial extent of the voice coil may be between 2 mm to 13 mm. This results in a range for the gap between the magnetic element and the cover being between ~3.6 mm and 15 mm. In the future, the spacings may be reduced to 0.35-0.5mm.

In examples, the gap width is between about 3 mm and 15 mm, such as 3.6 mm and 15 mm, and the dimension in the radial direction is between about 2 mm and 13 mm.

Widths and dimensions/thicknesses within these ranges have been found to provide an efficient motor assembly for typical transducers.

In examples: (i) the auxiliary magnetic element is offset from the voice coil in a direction perpendicular to the direction of movement of the voice coil, (ii) the auxiliary magnetic element has a magnetic axis, and (iii) the magnetic flux density through the voice coil and cover is increased by arranging the magnetic axis substantially perpendicular to the direction of movement of the voice coil.

Thus, rather than being offset in a direction of movement of the voice coil, the auxiliary magnetic element may be offset to one side of the voice coil (in a direction perpendicular to the longitudinal axis). Arranging the auxiliary magnetic element in this manner increases the magnetic flux density through the voice coil. The magnetic flux from the second magnetic field therefore adds to the magnetic flux from the magnetic field of the magnetic element. This results in a larger force exerted on the coil due to the interaction between the coil's magnetic field and the magnetic field of the magnetic element, and therefore provides a negative stiffness.

The magnetic flux density is increased in a direction that is perpendicular to a winding axis of the voice coil. The magnetic axis is aligned with the part of the magnetic field of the magnetic element that is passing through the voice coil. The magnetic field of the magnetic element and the second magnetic field are therefore aligned in a region through the voice coil. The magnetic axis is substantially perpendicular to the longitudinal axis.

The direction perpendicular to the direction of movement of the voice coil may be a radial direction.

In one arrangement, the auxiliary magnetic element is arranged between the voice coil and cover (i.e., outside the voice coil).

The auxiliary magnetic element may extend at least partially around the voice coil (or at least partially around the magnetic element and the voice coil may extend around the auxiliary magnetic element). In examples, the auxiliary magnetic element and voice coil are concentric.

The motor assembly may further comprise a second auxiliary magnetic element arranged between the magnetic element and the cover, wherein the second auxiliary magnetic element: (i) is coupled to the voice coil, such that movement of the voice coil causes the second auxiliary magnetic element to move, and (ii) has a third magnetic field arranged relative to the magnetic field of the magnetic element such that the magnetic flux density through the voice coil and cover is further increased.

Having two auxiliary magnetic elements further increases the magnetic flux density, which further improves the motor assembly. The second auxiliary magnetic element may be one of the types of auxiliary magnetic elements described above, and may therefore either be: (i) offset from the voice coil along the direction of movement of the voice coil, or (ii) offset from the voice coil in a direction perpendicular to the direction of movement of the voice coil.

The motor assembly may further comprise a third auxiliary magnetic element arranged between the magnetic element and the cover, wherein the third auxiliary magnetic element: (i) is coupled to the voice coil, such that movement of the voice coil causes the third auxiliary magnetic element to move, and (ii) has a fourth magnetic field arranged relative to the magnetic field of the magnetic element such that the magnetic flux density through the voice coil and cover is further increased. The auxiliary magnetic element is offset from the voice coil along the direction of movement of the voice coil in a first direction, the second auxiliary magnetic element is offset from the voice coil along the direction of movement of the voice coil in a second direction, opposite to the first direction, and the third auxiliary magnetic element is offset from the voice coil in a direction perpendicular to the direction of movement of the voice coil.

Three (or more) auxiliary magnetic elements arranged in this way provides a full range of the benefits discussed above.

In examples, the voice coil is a first voice coil, the auxiliary magnetic element is a first auxiliary magnetic element, and the motor assembly further comprises: (i) a second voice coil at least partially surrounding the magnetic element and offset along the magnetic element from the first voice coil, the cover at least partially enclosing the second voice coil, (ii) a midpiece extending between the first and second voice coils, and (iii) a second auxiliary magnetic element arranged between the magnetic element and the cover, wherein the second auxiliary magnetic element: (a) is coupled to the second voice coil, such that movement of the second voice coil causes the second auxiliary magnetic element to move, and (b) is offset from the second voice coil along the direction of movement of the second voice coil and positioned between the second voice coil and the midpiece along the direction of movement of the second voice coil. The first auxiliary magnetic element is offset from the first voice coil along the direction of movement of the first voice coil and positioned between the first voice coil and the midpiece along the direction of movement of the first voice coil.

The second auxiliary magnetic element may function in the same way as the first auxiliary magnetic element.

As discussed earlier, a midpiece arranged between the first and second voice coils and first and second auxiliary magnetic elements can reduce the magnetic interference between the coils and auxiliary magnetic elements.

The first and second voice coils may each be moveable from a rest position to a maximum excursion position, and wherein the first and second auxiliary magnetic elements are arranged such that when the first and second voice coils are both at the maximum excursion positions, the first and second auxiliary magnetic elements are separated by a distance that is great enough to avoid magnetic interference. This separation distance may be the sum of: (i) the thickness of the midpiece, (ii) the maximum excursion of the first voice coil, (iii) a tolerance to avoid a collision between the first auxiliary magnetic element and the midpiece (such as 1 mm), (iv) the maximum excursion of the second voice coil, and (v) a tolerance to avoid a collision between the second auxiliary magnetic element and the midpiece (such as 1 mm). For one particular example, the maximum excursion of each voice coil is 6 mm and the thickness of the midpiece is 5 mm. The distance between the first and second auxiliary magnetic elements may therefore be about 19 mm. It will be appreciated this can vary depending on the design of the transducer.

The first and second voice coils may each be moveable from a rest position to a maximum excursion position, and the first and second auxiliary magnetic elements may be arranged such that when the first and second voice coils are both at the rest positions, the first and second auxiliary magnetic elements are spaced apart from the midpiece by a distance of between about 5.5 mm and about 6.5 mm, or between about 5.6 mm and about 6 mm, such as about 5.8 mm or about 6 mm. This distance includes the maximum excursion distance (for example 5mm) plus some tolerance to avoid a collision between the auxiliary magnetic elements and the midpiece (such as 1 mm). This distance can be increased by increasing the longitudinal extent of the magnet(s) arranged adjacent the midpiece.

The first and second auxiliary magnetic elements (in their rest positions) may be spaced apart from the midpiece by a distance greater than a maximum excursion of the first and second voice coils. The spacing may be about 1 mm greater than the maximum excursion, to account for some tolerance in the excursion.

In examples, the midpiece has a thickness measured in a direction parallel to the longitudinal axis of between about 1.5 mm and about 2.5 mm. In another example, the thickness of the midpiece is between about 4 mm and about 6 mm, such as about 5 mm. The thickness may be chosen to avoid magnetic saturation, and may therefore be dependent on the size and thickness of the magnets in the magnetic element.

In examples, the maximum excursion distance of each coil may be between about 4.5 mm and about 5.5 mm, such as about 5 mm. It will be appreciated that the maximum excursion distance can vary based on transducer design, ranging from as low as 1 mm to more than 20 mm.

Embodiments described herein relate to motor assemblies for speaker transducers, where a motor assembly comprises a magnetic element (such as a stack of magnets), around which one or more voice coils extend. The example embodiments described herein further include one or more magnetic portions extending at least partially around the magnetic element. The magnetic field(s) of these magnetic portions are arranged in a particular way relative to the voice coil and the magnetic field of the magnetic element. The presence of one or more magnetic portions increases the magnetic flux through the voice coil, which in turn increases the BL value of the motor assembly. A higher BL value on a BL curve can mean the transducer has a higher sensitivity, better efficiency and/or improved control.

In further embodiments, magnetic material (in the form of one or more spacer elements, for example) can also surround the magnetic element, which causes a magnetic field of the magnetic element to be concentrated within the magnetic material. The magnetic material may act as a magnetic field return path, and form part of a magnetic circuit for the magnetic field of the magnetic element. At least part of the magnetic field of the magnetic element may therefore be “captured”, “concentrated” or “contained” within the magnetic material. This reduces the reluctance of the motor, and may improve efficiency.

In a first embodiment, two or more magnetic portions extend at least partially around the magnetic element. For example, they may be arranged symmetrically about the voice coil. As such, in a fourth aspect of the present disclosure, there is provided a motor assembly for a transducer, the motor assembly comprising: (i) a magnetic element having a longitudinal axis and comprising a first magnetic portion and a second magnetic portion, (ii) a voice coil extending at least partially around the magnetic element, the voice coil being moveable parallel to the longitudinal axis, wherein the first and second magnetic portions are magnetized in generally opposite directions to each other, such that magnetic fields of the first and second magnetic portions pass through the voice coil, (iii) a third magnetic portion extending at least partially around the magnetic element, and (iv) a fourth magnetic portion extending at least partially around the magnetic element. The third and fourth magnetic portions are: (a) each spaced apart further from the longitudinal axis than the voice coil, and (b) magnetized in generally opposite directions to each other and magnetically oriented with respect to the magnetic fields of the first and second magnetic portions, such that the magnetic fields of the first, second, third and fourth magnetic portions are in generally the same direction through the voice coil.

As mentioned, the inclusion of the third and fourth magnetic portions increase the magnetic flux through the voice coil, thereby increasing the BL value for the same overall volume of magnetic material in the motor assembly (which can allow the height profile of the motor assembly to be reduced). For example, the volume of magnetic material in the magnetic element can be reduced, and instead that magnetic material can be used in the third and fourth portions. As will become apparent, different arrangements/configurations of the third and fourth magnetic portions yield different impacts on the maximum BL value and linearity of the BL curve, with different considerations on design.

The voice coil may be arranged to generate a magnetic field for interacting with the magnetic field of the magnetic element (that is, the magnetic fields of the first and second magnetic portions) to move a membrane of the transducer along the longitudinal axis relative to the magnetic element. In other examples, the voice coil may remain stationary while the magnetic element moves.

The magnetic element (which may alternatively be referred to as a magnet stack or a magnet assembly) may comprise one or more magnets, such as a stack of two or more magnets. For example, a first magnet may comprise the first magnetic portion and a second magnet may comprise the second magnetic portion. In some cases, the magnets may be separated by one or more spacer elements. A spacer element may be referred to as a pole piece, in some examples. The magnetic element may comprise two or more magnets coupled together (and in some cases, with one or more spacer elements between the magnets). In other examples, the magnetic element may be monolithic, and may comprise two or more magnets formed from a single piece of material that has been magnetized (and again, in some cases, one or more spacer elements may be formed between the magnets). The magnets within the magnetic element may be linearly arranged, along the longitudinal axis of the magnetic element. The magnetic element may therefore be a linear magnetic element. Similarly, a third magnet may comprise the third magnetic portion and a fourth magnet may comprise the fourth magnetic portion. In one example, the third and fourth magnetic portions form part of a monolithic element, or they may be affixed to each other, either directly or indirectly.

The motor assembly may comprise one or more motors for driving one or more membranes. A motor, for example, may comprise a magnetic element and one or more voice coils that are coupled to a membrane (or one or more membranes). The motor may drive the membrane to generate acoustic waves that propagate away from the membrane. At least one motor and at least one membrane may form a transducer. A single membrane may be driven by one or more motors. A single motor may drive one or more membranes.

The third and fourth magnetic portions are positioned further from the longitudinal axis than the voice coil in a direction perpendicular to the longitudinal axis. That is, a minimum spacing or gap between the third/fourth magnetic portions and the magnetic element is greater than a minimum spacing or gap between the voice coil and the magnetic element.

The third and fourth magnetic portions may be offset from each other in a direction parallel to the longitudinal axis. For example, there may be a spacing between the magnetic portions—either an air gap or a pole piece/spacer element, or they may be contiguous. In some cases, when the third and fourth magnetic portions are positioned closer together, the magnetic flux passing through the voice coil may be more concentrated, which can result in a greater BL value, but at the expense of reduced linearity. Accordingly, the spacing between the third and fourth magnetic portions may be chosen to balance BL value and linearity.

Similarly, the first and second magnetic portions may be offset from each other along the longitudinal axis. For example, there may be a spacing between the portions—such as a pole piece/spacer element, or they may be contiguous.

The magnetic fields of the first, second, third and fourth magnetic portions may pass through the voice coil in a direction that is substantially perpendicular to the longitudinal axis.

In an example, the third and/or fourth magnetic portions extend fully around the magnetic element, and therefore may be ring-shaped. In another example, the third and/or fourth magnetic portions extend partially around the magnetic element. In some cases, the third and/or fourth magnetic portions may be comprised of separate magnetic portions distributed around the magnetic element. In examples, the third and/or fourth magnetic portions have at least two orders of rotational symmetry around the magnetic element, which may balance the magnetic forces acting on the voice coil.

In example arrangements, the first magnetic portion is positioned closer to the third magnetic portion than the fourth magnetic portion and the second magnetic portion is positioned closer to the fourth magnetic portion than the third magnetic portion.

In examples, the first and second magnetic portions may have the same dimensions/volume (and therefore be the same size) as each other. Similarly, the third and fourth magnetic portions may have the same dimensions/volume (and therefore be the same size) as each other. This again may balance the magnetic forces acting on the voice coil.

In some examples, the first and second magnetic portions may be axially magnetized, such as along the longitudinal axis. Similarly, the third and fourth magnetic portions may be axially magnetized, such as along a direction that is parallel to the longitudinal axis. Magnetic axes of the magnetic portions may therefore be parallel to the longitudinal axis.

In examples, the first and third magnetic portions are magnetized in opposite directions to each other. Similarly, the second and fourth magnetic portions are magnetized in opposite directions to each other.

The first, second, third and fourth magnetic portions may comprise neodymium.

In one particular example, the third and fourth magnetic portions form part of a cover, the cover comprising magnetic material and extending at least partially around the magnetic element and voice coil. The magnetic fields of the first, second, third and fourth magnetic portions may be concentrated within the cover. In examples, “concentrated within the cover” may mean that the magnetic fields flow through the cover, such as within the cover, and/or that the magnetic fields are diverted or directed along the cover. The cover may be referred to as a “magnetic shield” or “shield” because it may fully or partially block the magnetic fields from extending beyond an outer surface of the cover. The term “concentrated” may not necessarily mean the magnetic field is the strongest (i.e., most concentrated) inside the cover, but instead may mean that the magnetic field is more concentrated at this point in space than it would be if the cover was not present. The cover may therefore cause the magnetic flux density at this point in space to be increased. The cover may be tubular, such as cylindrical. The cover may fully or at least partially surround the voice coil(s) along an entire excursion range(s) of the voice coil(s), or at least a portion thereof.

The cover may be integrally formed (that is, formed as a single piece, and is therefore monolithic). In other examples, the cover may be comprised of separate parts, such as one or more parts that are joined or otherwise coupled together. As will become apparent below, the cover may be formed from one or more spacer elements.

The cover (and/or the spacer element(s)) may comprise magnetic material. For example, the magnetic material may be at least one of: a ferromagnetic material, a ferrimagnetic material, or a paramagnetic material. Such materials are expected to have the effect of concentrating the magnetic field within the cover/spacer element, thereby providing a low reluctance return path. The material may consist or comprise soft iron, or may consist of or comprise steel, such as a low carbon steel, 1010 carbon steel, 1006 carbon steel, 1018 carbon steel, and/or an alloy(s) thereof. In some examples, the material may consist of or comprise Vanadium, cobalt, nickel, and/or alloy(s) thereof.

The cover (and/or the spacer element(s)) may have a thickness, measured perpendicular to the longitudinal axis of between about 0.5 mm and about 3 mm. For typical transducers (and magnets used within the magnetic element) thicknesses within this range are expected to provide a good balance between avoiding or reducing magnetic field saturation within the cover and reducing the cost/weight of the cover. In particular examples, the thickness may be between about 1 mm and about 3 mm, such as between about 1.5 mm and about 2.5 mm, such as 2 mm.

In examples, the motor assembly further comprises a spacer element positioned between the third and fourth magnetic portions, the spacer element comprising magnetic material. The presence of the spacer element (also known as a pole piece), helps focus the magnetic fields of the third and fourth magnetic portions onto the voice coil, which results in increased efficiency of the motor assembly and improved control of the voice coil. It has been found that use of such a spacer element can increase the magnetic flux by around 20% compared to a motor assembly without such a spacer element.

In such arrangements, the voice coil is positioned between the magnetic element and the spacer element. The spacer element may therefore at least partially extend around the voice coil and the magnetic element.

In an example, the spacer element may abut both the third and fourth portions (such that there is no gap between the third and fourth magnetic portions where the spacer element is positioned). In other examples, there may be a gap between the spacer element and at least one of the third and fourth portions.

In examples, the first, second, third and fourth magnetic portions may all have at least one of: (i) the same depth dimension, or (ii) the same volume, the depth dimension being measured parallel to the longitudinal axis, and when the voice coil is in a rest position: the first and third magnetic portions are at a same position along the longitudinal axis, and the second and fourth magnetic portions are at a same position along the longitudinal axis. This configuration provides a more balanced arrangement of magnetic field, and can result in an increased BL value for the motor assembly.

In examples, the motor assembly further comprises an end piece arranged at one end of the magnetic element and extending at least partially between the first magnetic portion and the third magnetic portion, the end piece comprising magnetic material such that the magnetic fields of the first and third magnetic portions are concentrated within the end piece. The end piece can act as a low reluctance path for the magnetic fields, helping reduce the reluctance of the motor and improve efficiency. The end piece also increases magnetic flux through the voice coil.

In examples, the end piece has a depth dimension, measured in a direction parallel to the longitudinal axis, that is large enough to avoid saturation of the magnetic fields within the end piece. The end piece may be a first end piece arranged at a first end of the magnetic element, and the assembly may further comprise a second end piece arranged at a second (opposite) end of the magnetic element and extending at least partially at between the second magnetic portion and the fourth magnetic portion such that the magnetic fields of the second and fourth magnetic portions are concentrated within the second end piece. The end piece may comprise the same material as the cover or spacer elements mentioned above, such as 1010 carbon steel.

In examples, the end piece has a depth dimension, measured parallel to the longitudinal axis, and the end piece has a greater depth dimension closer to the longitudinal axis than at an outer edge of the end piece, the outer edge being spaced apart from the longitudinal axis.

Having an end piece of this form (such as end piece that is deeper toward the center of the endpiece than at its outer edges), can increase the BL value of the motor assembly by capturing a greater amount of the magnetic fields. Such an end piece therefore increases the magnetic flux through the voice coil.

In some cases, at its deepest point, the end piece may be deeper than the end piece at its thinnest point by at least 1.5 mm, such as by about 2 mm.

In some examples, an outer surface of the end piece may be angled with respect to a plane that is perpendicular to the longitudinal axis (such that an angle extends between the plane and the outer surface, the angle being non-zero).

In examples, the motor assembly further comprises a spacer element positioned between the third magnetic portion and the end piece, the spacer element comprising magnetic material. The spacer element provides a greater separation between the third magnetic portion and the end piece, thereby reducing the likelihood of the magnetic field lines from “short circuiting” across the gap between the third magnetic portion and the magnetic element. A spacer element positioned in here can increase the magnetic flux through the voice coil, thereby increasing the BL value of the motor assembly. In examples, the end piece and spacer element are integrally formed (that is, formed from a single piece of material). In another example, the spacer element may be constructed separately from the end piece, and they may be connected or assembled together. The spacer element may be positioned at or towards the outer edge of the end piece. The magnetic fields of the first and third magnetic portions may be concentrated within the end piece and the spacer element. The spacer element may be a first spacer element, and the assembly may further comprise a second spacer element positioned between the fourth magnetic portion and the second end piece. As mentioned, these one or more spacer elements may form part of a cover. In examples, there may be a further spacer element positioned between the first magnetic portion and the end piece (for example, the further spacer element may form part of the magnetic element). In some cases, there may be another spacer element positioned between the second magnetic portion and the second end piece (for example, the other spacer element may form part of the magnetic element).

In examples, the spacer element has a cross-sectional width, measured perpendicular to the longitudinal axis, that varies along a direction parallel to the longitudinal axis. Having a non-uniform cross-sectional width may result in some of the magnetic flux being directed to an outer portion of the motor assembly. While this may lower the BL value, this may be useful to focus magnetic flux into other areas. A non-unform cross-sectional width may also minimize the weight/cost of the cover. For example, the spacer element can be made thicker in places where the magnetic field strength/flux is stronger, and thinner at other points.

The cross-sectional width may taper from a thinner portion to a thicker portion. The thinner portion may be at an end of the spacer element that is closest to the third magnetic portion and the thicker portion may be at an end of the spacer element that is furthest from the third magnetic portion (or vice versa). In one example, at its widest point, the spacer element may be wider than a greatest cross-sectional width of the third magnetic portion. In one example, at its thinnest point, the spacer element may have the same cross-sectional width as the third magnetic portion.

In examples, the third and fourth magnetic portions are spaced apart from each other in a direction parallel to the longitudinal axis and a gap extends at least partially between the third and fourth magnetic portions. While removing the spacer element from between the third and fourth magnetic portions (or reducing the size of the spacer element) may reduce the BL value slightly, a gap may provide thermal benefits, such as allowing air circulation and/or to allow a member that is coupled to the voice coil, such as a spider, to extend through the gap.

In some arrangements, when the voice coil is in a rest position: at least part of: (i) the voice coil, (ii) the first magnetic portion and (iii) the third magnetic portion overlap along the longitudinal axis, and at least part of: (i) the voice coil, (ii) the second magnetic portion and (iii) the fourth magnetic portion overlap along the longitudinal axis. Having the magnetic portions overlap with the voice coil may increase the magnetic flux through the voice coil and can mean that a higher proportion of the magnetic field lines passing through the voice coil is in a direction that is substantially perpendicular to the longitudinal axis.

Put another way, the voice coil, the first magnetic portion and the third magnetic portion may intersect a first plane that is arranged perpendicular to the longitudinal axis, and the voice coil, the second magnetic portion and the fourth magnetic portion intersect a second plane that is arranged perpendicular to the longitudinal axis. The first and second planes may be spaced apart from each other along the longitudinal axis.

In some examples, a second voice coil may also extend around the magnetic element. For example, the second voice coil may drive a second membrane arranged towards a second end of the magnetic element. In such cases, and in the same way as described above, two further magnetic portions may be arranged relative to the second voice coil to provide the same advantages discussed earlier. Accordingly, in examples, the voice coil may be a first voice coil, and the magnetic element comprises a fifth magnetic portion and a sixth magnetic portion, and the motor assembly further comprises: (i) a second voice coil extending at least partially around the magnetic element, wherein the fifth and sixth magnetic portions are magnetized in generally opposite directions to each other, such that magnetic fields of the fifth and sixth magnetic portions pass through the second voice coil, (ii) a midpiece extending between the first and second voice coils, (iii) a seventh magnetic portion extending at least partially around the magnetic element, and (iv) an eighth magnetic portion extending at least partially around the magnetic element. The seventh and eighth magnetic portions are: (a) each spaced apart further from the longitudinal axis than the second voice coil, and (b) magnetized in generally opposite directions to each other and magnetically oriented with respect to the magnetic fields of the fifth and sixth magnetic portions, such that the magnetic fields of the fifth, sixth, seventh and eighth magnetic portions are in generally the same direction through the second voice coil.

As such, when the motor assembly comprises a second voice coil, further magnetic portions can be added to increase the magnetic flux through the second voice coil, in the same way as described above. Any of the above-described features/components may additionally be added/replicated for the second voice coil.

In examples, the midpiece may comprise the same material as the cover or spacer elements mentioned above, such as 1010 carbon steel. The midpiece can reduce magnetic field interference between the two voice coils. A midpiece may alternatively be referred to as an extension pole piece.

The first voice coil may drive a first membrane of the transducer and the second voice coil may drive a second membrane of the transducer, where the first and second membranes are arranged at opposite ends of the magnetic element. As such, the first and second membranes may be said to be arranged back-to-back. This “back-to-back” configuration may allow one or more of: force cancelling between the membranes; increasing the efficiency of audio reproduction; sound to be directed in different directions into a room; and providing a particular sound profile. In examples, the first membrane is configured to generate a first acoustic wave, the second membrane is configured to generate a second acoustic wave, and the first and second acoustic waves are directed away from the motor assembly in substantially opposite directions. The longitudinal axis may extend through midpoints of the first and second membranes.

In examples, the motor assembly further comprises a first spacer element positioned between the third and fourth magnetic portions, and a second spacer element positioned between the seventh and eighth magnetic portions, the first and second spacer elements comprising magnetic material.

In examples, the motor assembly further comprises a first end piece arranged at a first end of the magnetic element and extending at least partially between the first magnetic portion and the third magnetic portion, and a second end piece arranged at a second end of the magnetic element and extending at least partially between the sixth magnetic portion and the eighth magnetic portion, wherein the first and second end pieces comprise magnetic material such that the magnetic fields of the first and third magnetic portions are concentrated within the first end piece and the magnetic fields of the sixth and eighth magnetic portions are concentrated within the second end piece.

In examples, the motor assembly further comprises a third spacer element positioned between the third magnetic portion and the first end piece, and a fourth spacer element positioned between the eighth magnetic portion and the second end piece, wherein the third and fourth spacer elements comprise magnetic material.

In examples, the motor assembly further comprises a fifth spacer element positioned between the fourth magnetic portion and the midpiece, and a sixth spacer element positioned between the seventh magnetic portion and the midpiece, wherein the fifth and sixth spacer elements comprise magnetic material. Such further spacer elements help enclose a greater portion of the magnetic fields, further increasing the BL value.

In any of the above examples, the third and fourth magnetic portions may be positioned stationary relative to the magnetic element, and wherein the voice coil moves relative to the third and fourth magnetic portions. Similarly, in example assemblies comprising seventh and eighth magnetic portions, the seventh and eighth magnetic portions may be positioned stationary relative to the magnetic element, and wherein the second voice coil moves relative to the seventh and eighth magnetic portions.

In any of the above examples, the third and fourth magnetic portions may be referred to as first and second auxiliary magnets or magnetic elements. Similarly, the seventh and eighth magnetic portions may be referred to as third and fourth auxiliary magnets or magnetic elements.

In the above-described examples of the first embodiment there are two or more magnetic portions arranged relative to the, or each, voice coil. As mentioned, these magnetic portions may be axially magnetized parallel to the longitudinal axis. In a second embodiment, a magnetic portion may be offset from the voice coil in a direction perpendicular to the longitudinal axis, and may be positioned inside or outside of the voice coil relative to the magnetic element. In such cases, the magnetic portion may be axially magnetized in a direction perpendicular to the longitudinal axis (and therefore have a magnetic axis aligned perpendicular to the longitudinal axis).

In the same way as described above, the presence of a magnetic field from this magnetic portion increases the magnetic flux through the voice coil.

As such, in a fifth aspect of the present disclosure, there is provided a motor assembly for a transducer, the motor assembly comprising: (i) a magnetic element having a longitudinal axis and comprising a first magnetic portion and a second magnetic portion, (ii) a voice coil extending at least partially around the magnetic element, the voice coil being moveable parallel to the longitudinal axis, wherein the first and second magnetic portions are magnetized in generally opposite directions to each other, such that magnetic fields of the first and second magnetic portions pass through the voice coil, and (iii) a third magnetic portion extending at least partially around the magnetic element and the voice coil. The third magnetic portion: (a) is spaced further from the longitudinal axis than the voice coil, and (b) has a magnetic axis arranged substantially perpendicular to the longitudinal axis, and oriented such that a magnetic field of the third magnetic portion is in generally the same direction through the voice coil as the magnetic fields of the first and second magnetic portions.

The inclusion of the third magnetic portion increases the magnetic flux through the voice coil, thereby increasing the BL value for the same overall volume of magnetic material in the motor assembly (which can allow the height profile of the motor assembly to be reduced). For example, the volume of magnetic material in the magnetic element can be reduced, and instead that magnetic material can be used in the third magnetic portion.

The magnetic fields of the first, second and third magnetic portions may pass through the voice coil in a direction that is substantially perpendicular to the longitudinal axis.

The third magnetic portion may extend fully or partially around the magnetic element (for example, the third magnetic portion may be ring shaped/annular). In some cases, the third magnetic portion may be comprised of separate magnetic portions distributed around the magnetic element. In examples, the third magnetic portion has at least two orders of rotational symmetry around the magnetic element, which may balance the magnetic forces acting on the voice coil.

In examples, the third magnetic portion may be arranged symmetrically about the voice coil to balance the magnetic forces acting on the voice coil.

In examples, the third magnetic portion is coupled to the voice coil, such that movement of the voice coil causes the third magnetic portion to move. The third magnetic portion being coupled, and therefore move with the voice coil, provides a magnetic assist or boost that effectively overcomes inherent stiffnesses in the system. The third magnetic portion may therefore contribute a negative stiffness to movement of the voice coil. In particular, as the voice coil moves axially away from a rest position (i.e., along the longitudinal axis due to current passing through the voice coil), the magnetic interactions between the magnetic field of the magnetic element and the magnetic field of the third magnetic portion amplifies this motion over at least a portion of an excursion range/path of the voice coil, thereby urging both the voice coil and the third magnetic portion further away from the rest position. This amplification may contribute a negative stiffness to movement of the voice coil and a coupled membrane along the excursion axis.

As mentioned, movement of the voice coil causes the auxiliary magnetic element to move. The voice coil and auxiliary magnetic element therefore move together/in unison/tandem. In examples, the voice coil and auxiliary magnetic element move together with a fixed/constant spacing between them.

The third magnetic portion may be directly or indirectly coupled to the voice coil, and be moveable with the voice coil. For example, the third magnetic portion may be directly coupled to a voice coil support or an actuating element (where the actuating element is coupled to a membrane). As such, in one example, the motor assembly may further comprise a voice coil support, and the third magnetic portion and voice coil are coupled to the voice coil support. In another example, the motor assembly may further comprise an actuating element which is coupled to a membrane of the transducer, and the third magnetic portion is coupled to the actuating element. In an example, the actuating element is coupled to the voice coil support.

The motor assembly may further comprise a cover at least partially enclosing the voice coil, the magnetic element and the third magnetic portion, wherein at least part of the magnetic fields of the first and second magnetic portions are concentrated within the cover, the cover comprising magnetic material. As discussed above, the cover may act as a magnetic field return path, and form part of a magnetic circuit for the magnetic fields of the first and second magnetic portions. This reduces the reluctance of the motor, and may improve efficiency. The use of a cover may also allow the volume of magnetic material in the magnetic element to be reduced while maintaining the same BL value for the transducer.

The cover may be spaced apart from the magnetic element to provide a gap in which the voice coil and third magnetic portion are arranged.

In examples, the voice coil is a first voice coil, the magnetic element comprises a fourth magnetic portion and a fifth magnetic portion, and the motor assembly further comprises: (i) a second voice coil extending at least partially around the magnetic element, wherein the fourth and fifth magnetic portions are magnetized in generally opposite directions to each other, such that magnetic fields of the fourth and fifth magnetic portions pass through the second voice coil, (ii) a midpiece extending between the first and second voice coils, and (iii) a sixth magnetic portion extending at least partially around the magnetic element and the second voice coil, wherein the sixth magnetic portion: (a) is spaced further from the longitudinal axis than the second voice coil, and (b) has a magnetic axis arranged substantially perpendicular to the longitudinal axis, and oriented such that a magnetic field of the sixth magnetic portion is in generally the same direction through the second voice coil as the magnetic fields of the fourth and fifth magnetic portions.

Accordingly, when the motor assembly comprises a second voice coil, a further magnetic portion can be added to increase the magnetic flux through the second voice coil, in the same way as described above for the third magnetic portion.

According to a sixth aspect of the present disclosure, there is provided a motor assembly for a transducer, the motor assembly comprising: (i) a first magnetic element and a first voice coil at least partially surrounding the first magnetic element, (ii) a second magnetic element and a second voice coil at least partially surrounding the second magnetic element, and (iii) a cover comprising a first portion at least partially enclosing the first voice coil and the first magnetic element, a second portion at least partially enclosing the second voice coil and the second magnetic element, and a connecting element connecting the first portion and the second portion. At least part of a first magnetic field of the first magnetic element is concentrated within the cover. At least part of a second magnetic field of the second magnetic element is concentrated within the cover. The first portion, the second portion and the connecting element are integrally formed.

The cover is integrally formed; i.e. formed as a single piece and may also be referred to as monolithic.

The first and second voice coils may be arranged to generate respective magnetic fields for interacting with the magnetic field of the respective first and second magnetic elements to move a membrane of the transducer along an axis of each of the first and second magnetic elements relative to the first and second magnetic elements. The axis of each of the first and second magnetic elements may be a longitudinal axis, and the axis may be aligned with the direction of movement of the respective first and second voice coil. The direction of movement of the first and second voice coils may therefore be parallel to a longitudinal axis of the first and second magnetic elements.

The first magnetic element and first voice coil may together be considered as a first motor of the motor assembly. The second magnetic element and the second voice coil may together be considered as a second motor of the motor assembly. The first and second motors may drive a membrane to generate acoustic waves that propagate away from the membrane, as described with reference to at least the first aspect. A single motor may drive one or more membranes. For example, in some cases, a motor may comprise two voice coils, each voice coil being coupled to a different membrane to drive the membranes.

In examples, the direction of movement of the first voice coil is parallel to the direction of movement of the second voice coil. Accordingly, the longitudinal axis of the first magnetic element may be parallel to the longitudinal axis of the second magnetic element. In some examples, the first and second voice coils may remain stationary while the corresponding first and second magnetic elements move.

In examples, the first magnetic element axially overlaps the second magnetic element in a direction of movement of the first and second voice coils. This may provide a space-efficient arrangement.

In examples, the connecting element extends between the first portion and the second portion in a direction generally perpendicular to the direction of movement of the first voice coil and the direction of movement of the second voice coil. This can provide a space-efficient arrangement, reducing the overall size, in particular the overall height, of the motor assembly.

In examples, the first and/or second portion may be generally tubular, such as cylindrical and has a surface extending parallel to a direction of movement of the respective first or second voice coil. In other examples, the first and/or second portion may be generally prismatic, for example generally octagonal, in cross-section in a plane perpendicular to a direction of movement of the respective first or second voice coil. The first and second voice coils and first and second magnetic elements may have the same shaped profile as the respective first and second portions of the cover (for example, the first magnetic element and first voice coil may both be cylindrical, and the first portion of the cover may also be cylindrical). Having the same shaped profile can mean the components can have a closer fit, reducing the spacing between the components and reducing the overall size of the motor assembly.

In examples, the cover at least partially surrounds the first and second voice coils along an entire excursion range of the respective voice coils, or at least a portion thereof.

In examples, the first and/or second magnetic elements may have any suitable arrangement, for example any arrangement described herein with respect to at least the first aspect.

The cover may be formed by stamping, for example stamped from a sheet of material. Stamping is a relatively inexpensive manufacturing process and allows the shape, and/or thickness of the cover to be easily controlled. The sheet of material may have a desired thickness, and in some cases, may have a varied thickness along the sheet. The cover may be formed by sheet metal bending, for example formed by bending a blank formed from sheet metal. The blank may have a desired thickness, and in some cases, may have a varied thickness along the sheet. Sheet metal bending is also a relatively inexpensive manufacturing process and allows the shape, and/or thickness of the cover to be easily controlled. Other manufacturing methods can also be used, for example the cover could be forged, 3D printed, or cast.

In examples, the first and second portions of the cover have a thickness of between about 1 mm and about 4 mm. The thickness is measured perpendicular to the direction of movement of the first and second voice coils (or first and second magnetic element(s)). For typical transducers (and magnets used within the magnetic element) thicknesses within this range are expected to provide a good balance between avoiding or reducing magnetic field saturation within the first and second portions of the cover and reducing the cost/weight of the cover. In particular examples, the thickness may be between about 2 mm and about 3 mm. More generally, the cover may have a thickness based on a magnetic field strength of the first and second magnetic elements. The thickness may be a wall thickness of the first and second portions of the cover. The connecting element may have a thickness, measured parallel to the direction of movement of the first and second voice coils (of first and second magnet(s)), that is substantially equal to the wall thickness of the first and second portions of the cover.

In some examples, the thickness of the cover may be non-uniform. This can allow the thickness of the cover to be varied at different points, which can be useful to minimize the weight/cost of the cover. For example, the cover can be made thicker in places where the magnetic field strength/flux is stronger, and thinner at other points.

In examples, the cover may comprise a magnetizable material. In particular, the first and/or second portions may comprise a magnetizable material. In some examples, the material may comprise a material with a high relative permeability (μᵣ), such as greater than 100, so that the cover has a generally low reluctance.

In examples, the cover comprises at least one of: a ferromagnetic material, a ferrimagnetic material, or a paramagnetic material. Such materials are expected to have the effect of concentrating the magnetic field within the cover, thereby providing a low reluctance return path. In examples, the cover may comprise one or more of these materials. Such materials may be comprised in the first and second portions and omitted from the connecting element.

In particular examples, the material may consist or comprise soft iron, or may consist of or comprise steel, such as a low carbon steel, 1010 carbon steel, 1018 carbon steel, and/or an alloy(s) thereof. In some examples, the material may consist of or comprise cobalt, nickel, and/or an alloy(s) thereof.

In examples, at least part of the cover is magnetized. This may increase a strength of the first or second magnetic field within the at least part of the cover. The magnetized part may be a permanent magnet or an electromagnet, such as from one or more coils wound around a part of the cover to form an electromagnet. The at least part of the cover may be comprised in the first and/or second portion of the cover.

In examples, the first portion of the cover delimits a first opening which is aligned with the direction of movement of the first voice coil, and the motor assembly comprises a member coupled to the first voice coil and extending through the first opening.

In examples, the second portion delimits a second opening which is aligned with a direction of movement of the second voice coil, and the member is coupled to the second voice coil and extends through the second opening.

The opening may be elongated, an aperture, a slit, a slot, an elongated opening, an elongated aperture, a hole, a gap, a receptacle, a void, etc. In examples, the opening may have a longest dimension in the direction of movement of the respective voice coil.

The opening(s) may extend through a surface of the cover. The opening(s) may be formed through the cover in a direction perpendicular to the direction of movement. The opening(s) may be formed through the cover from an outer surface of the cover to an inner surface of the cover, the inner surface being closer to the magnetic element than the outer surface. The direction perpendicular to the direction of movement may be referred to as a radial direction. In some examples, the opening(s) is/are delimited or defined by one or more edges or boundaries of the cover.

The member may be a moveable member and may move along the opening(s) in the direction of movement of the respective voice coil(s) in use (i.e., as the voice coil moves).

The member may be coupled directly to the first and second voice coils in some examples, or may be indirectly coupled, such as via a voice coil support, in other examples.

In some examples, the member forms at least part of either: (i) a suspension element for coupling the first and second voice coils to a support structure, or (ii) an actuating element for coupling the first and second voice coils to a membrane of the transducer.

The suspension element or actuating element can therefore extend through the opening(s) in the cover, reducing the volume occupied by the motor assembly. Having the opening(s) aligned with the direction of movement of the voice coil, and therefore extend at least partially along the first and/or second portions of the cover, allows the member to move along the opening(s) as the first and second voice coils move and transfer motion to the member.

The suspension element may alternatively be referred to as a spider. The member may form an arm of the suspension element/spider. The support structure may be a basket or frame of a speaker or playback device within which the motor assembly and transducer are located. The actuating element may be or comprise a rib, for example, and the rib may therefore extend through the opening(s). The actuating element may be rigid, in some examples, and transfer movement of the first and second voice coils to the membrane.

The suspension element may be directly or indirectly coupled to the first and second voice coils. Similarly, the actuating element may be directly or indirectly coupled to the first and second voice coils. In an example, the first and second voice coils are at least partially contained within or affixed to a voice coil support and the suspension element and/or actuating element may be coupled to the voice coil support. The voice coil support may extend around the first and/or second magnetic element.

In examples, the membrane may be a first membrane, and the transducer may comprise a second membrane.

The first voice coil may drive a first membrane of the transducer and the second voice coil may drive a second membrane of the transducer, where the first and second membranes are arranged at opposite ends of the magnetic element. As such, the first and second membranes may be said to be arranged back-to-back. This “back-to-back” configuration may allow one or more of: force cancelling between the membranes; increasing the efficiency of audio reproduction; sound to be directed in different directions into a room; and providing a particular sound profile. In examples, the first membrane is configured to generate a first acoustic wave, the second membrane is configured to generate a second acoustic wave, and the first and second acoustic waves are directed away from the motor assembly in substantially opposite directions. The longitudinal axis may extend through midpoints of the first and second membranes.

In some examples, the first portion and/or the second portion comprises a first end and a second end, and an endpiece that closes the first end. Accordingly, at least part of the magnetic field of the respective magnetic element is concentrated within the cover at the first end. At the closed end(s), at least part of the respective magnetic field may be concentrated within the cover as a result of the end(s) being closed. Closing one or both ends of the first and/or second portion further reduces the reluctance of the motor assembly (thereby increasing the efficiency). Having all, such as both, ends closed can close the magnetic return path of the magnetic element.

In examples, the endpiece(s) may be integrally formed with a remainder of the cover (so formed as a single piece, and therefore be monolithic). In examples, the endpiece(s) may be formed from the same material as the connecting element and/or the respective first or second portion. The respective magnetic element may be fully enclosed by the cover at one or both ends of the cover as a result of the first and/or second portion of the cover being closed. The cover may therefore form an enclosure for the magnetic element. Having the endpiece integrally formed with the respective first or second portion of the cover may allow the magnetic element to be assembled inside the cover, with the endpiece acting as a base or support for the magnetic element. Having the components integrally formed rather than affixed to each other can also further reduce the reluctance by avoiding discontinuities in the material. In an example, the first and/or second portion is integrally formed with one endpiece at the first end, and a separate endpiece may be affixed to the respective first or second portion at the second end during manufacture. The first and/or second portions may be cup-shaped, such as having a generally U-shaped cross section.

In examples, a surface of the first portion and/or the second portion of the cover extends parallel to the direction of movement of the voice coil. In other examples, at least some parts of the surface do not extend parallel to the direction of movement (for example, the first and/or second portion may bend towards or away from the respective magnetic element at various points along its length, rather than having a continuous cross-sectional dimension, or width, along its length). In such cases, the opening may nevertheless still extend at least partially along the respective first or second portion of the cover in a direction of movement of the voice coil, even if the surface of the cover is not parallel to the direction of movement.

In some examples, the first and/or second portion delimits a plurality of openings, each opening aligned with the direction of movement of the voice coil and the first and/or second portion has rotational symmetry about an axis that is parallel to the direction of movement of the respective voice coil.

Having rotational symmetry (by having the openings spaced apart from each other and/or having particular widths/gaps) means that the respective magnetic field is more uniformly distributed through the first and/or second portion of the cover, which improves efficiency and operation of the motor assembly.

Rotational symmetry may mean that the first and/or second portion has a rotational order of at least 2.

In examples, the plurality of openings are spaced apart from each other (distributed around the surface of first and/or second portion) such that the first and/or second portion has the rotational symmetry. Each opening may have a width or gap, the widths/gaps being dimensioned such that the first and/or second portion has the rotational symmetry. For example, the openings may all have the same width or at least one opening may have a different width to another opening.

In examples, additional openings may be present that are not aligned with the direction movement (that is, additional to the plurality of openings).

In examples, the first portion and the second portion of the cover have mirror symmetry about a plane that is equidistant between the first portion and the second portion and parallel to the direction of motion of the first and second voice coils. This may balance forces across the cover. A revolution of the first portion about the axis of the first magnetic element may be equal to a revolution of the second portion about the axis of the second magnetic element.

In examples, the cover is symmetrical, for example rotationally symmetrical. Accordingly, the respective magnetic fields may be more uniformly distributed with respect to an axis or plane or symmetry, which improves efficiency and operation of the motor assembly. It may also benefit the operation by more evenly distributing forces in use.

Rotational symmetry may mean that the cover has a rotational order of at least 2. The cover may have a rotational order equal to a number of magnetic elements, or a number of motors, of the motor assembly.

In some examples, the first and/or second voice coil has a first thickness in a radial direction that is perpendicular to the direction of movement of the respective voice coil, and wherein the respective magnetic element and first or second portion of the cover are separated, at at least one position along an excursion path of the respective voice coil, by a distance in the radial direction that is less than four times the first thickness. In other examples the distance may be less than 1.3×, less than 1.5×, less than 1.67×, less than 2×, or less than 3× the first thickness. Reducing the distance between the cover and the voice coil reduces the overall size of the motor assembly, enabling a more compact transducer and playback device.

In examples, the first portion, second portion and/or the connecting element may comprise one or more apertures, or perforations, extending therethrough. This may reduce an overall weight of the cover and/or allow other elements, such as wiring, to pass through the connecting element. The apertures may be positioned at locations through which a relatively low magnetic field strength/flux passes when the motor assembly is in use.

In examples, one or more electronic components may be attached to the cover. This may provide a particularly space-efficient arrangement, for example because another structure for mounting the one or more electronic components may be omitted. The one or more electronic components may be attached to one or more of the connecting elements. The one or more electronic components may comprise a position sensor to detect a position of a voice coil of the motor assembly, for example the first or second voice coil, relative to a respective magnetic element. The one or more electronic components may comprise a thermistor, which may be arranged to detect and/or regulate a temperature of the motor assembly. However, the electronic components are not limited to position sensors and thermistors, for example a PCB may be mounted to the cover or other elements such as amplifying transistors may be attached or mounted to the cover.

In examples, the cover comprises a heat sink. The cover first portion, second portion and or the connecting element may form part of the heat sink. Additionally or alternatively, the cover may comprise one or more additional heat-dissipating features such as fins. This may help to reduce heat accumulation within the motor assembly in use. Where other electronic components are attached to the cover, the cover functioning as a heat sink may also be beneficial to dissipate heat from those components.

In examples, the cover is a first cover, and the motor assembly comprises a second cover. The second cover may have any of the features of the cover described above, including some or all of the optional features also described. The second cover comprises a third portion at least partially enclosing the first voice coil and the first magnetic element, a fourth portion at least partially enclosing the second voice coil and the second magnetic element, and a second connecting element connecting the third portion and the fourth portion. At least part of the magnetic field of the first magnetic element and at least part of the magnetic field of the second magnetic element is concentrated within the second cover. The third portion, fourth portion and second connecting element are integrally formed. The first cover and the second cover are arranged opposite each other.

Provision of a second cover may enable opposing ends of the first and second magnetic elements to be covered by the cover and the second cover, respectively. This may improve the efficiency by containing a greater portion of the magnetic field within the cover. It may also assist with electromagnetic compatibility by reduced magnetic field leakage.

Provision of a second cover may also enable the magnetic elements to be assembled within the cover or second cover, and then covered by the other of the cover and the second cover, to provide a simple assembly process.

In examples, the first cover is identical to the second cover. This can simplify manufacturing as fewer unique parts are required.

According to a seventh aspect of the present disclosure, there is provided a transducer, comprising the motor assembly of the first, second, third, fourth, fifth or sixth aspect and a membrane coupled to the voice coil(s). The transducer may comprise further membranes coupled to further voice coils, in some examples, as discussed above.

According to an eighth aspect of the present disclosure, there is provided a playback device comprising the transducer of the seventh aspect.

According to a ninth aspect of the present disclosure, there is provided a media playback system comprising the playback device of the eighth aspect, and at least one further playback device. The system may further comprise a controller configured to send an instruction to the playback device to cause the playback device to play back audio.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

### II. Suitable Operating Environment

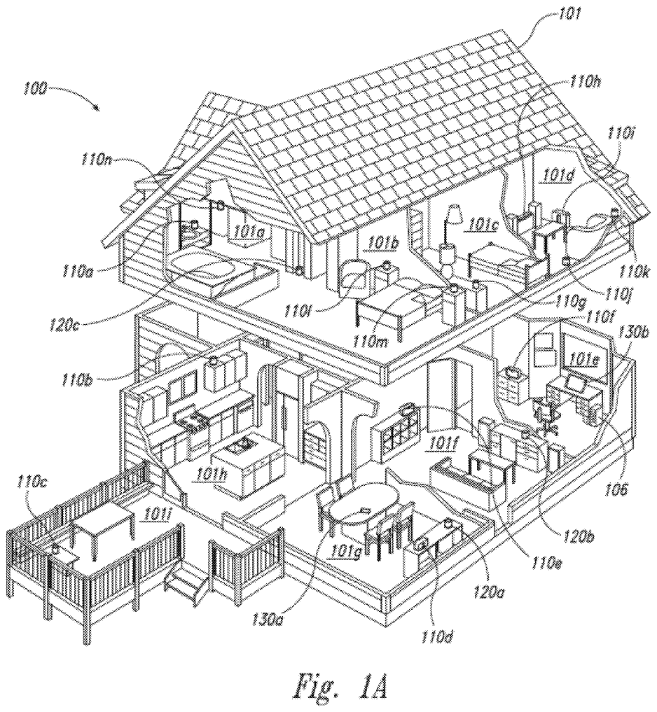

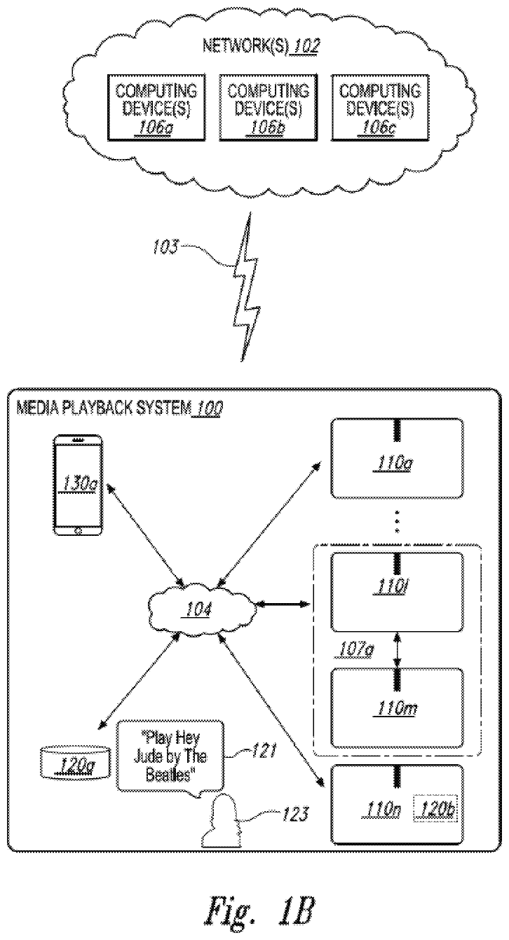

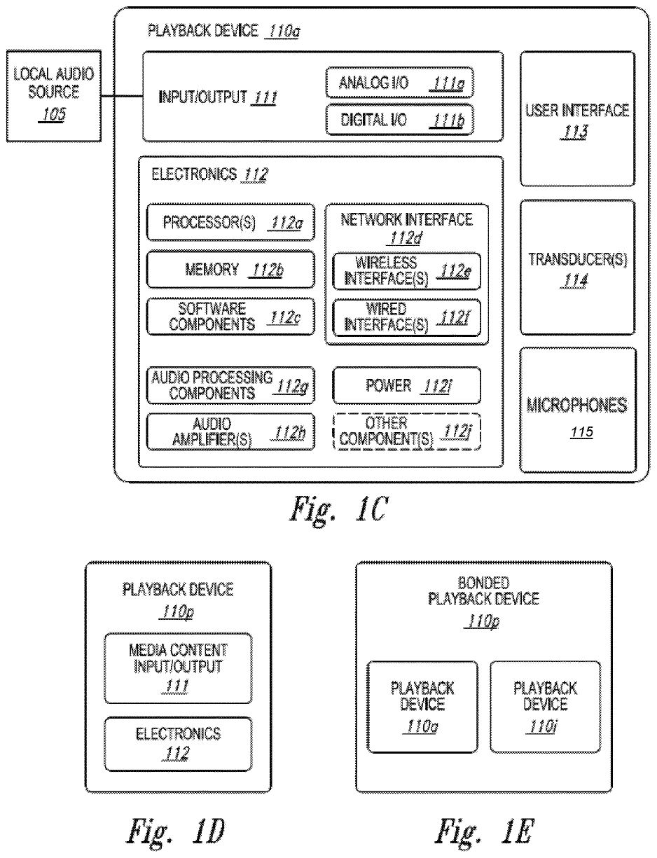

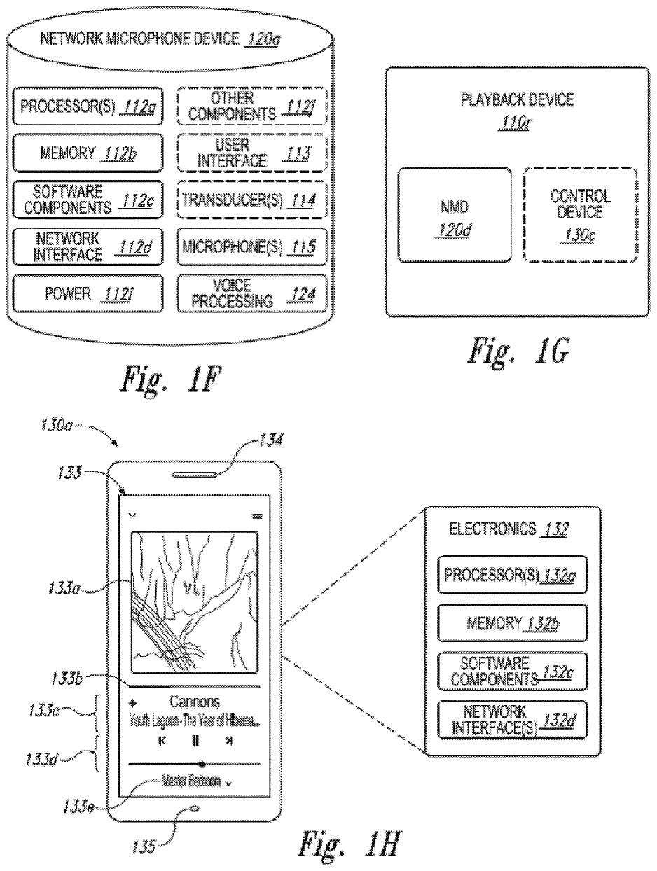

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”) 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some examples, a playback device includes one or more transducers or speakers powered by one or more amplifiers. In other examples, however, a playback device includes one of (or neither of) the speaker and the amplifier. For instance, a playback device can comprise one or more amplifiers configured to drive one or more speakers external to the playback device via a corresponding wire or cable.

A transducer may comprise at least: a magnetic element, at least one voice coil, and at least one diaphragm or membrane.

Moreover, as used herein the term NMD (i.e., a “network microphone device”) can generally refer to a network device that is configured for audio detection. In some examples, an NMD is a stand-alone device configured primarily for audio detection. In other examples, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain examples, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some examples, for instance, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various examples of the disclosure are described in greater detail below.

In the illustrated example of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain examples and examples are described below in the context of a home environment, the technologies described herein may be implemented in other types of environments. In some examples, for instance, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. Each of the playback zones and/or the individual rooms may be referred to as a listening environment. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some examples, a single playback zone may include multiple rooms or spaces. In certain examples, a single room or space may include multiple playback zones.

In the illustrated example of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some examples, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some examples, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated by reference for all purposes.

### A. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some examples, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some examples, one or more of the computing devices 106 comprise modules of a single computer or server. In certain examples, one or more of the computing devices 106 comprise one or more modules, computers, and/or servers. Moreover, while the cloud network 102 is described above in the context of a single cloud network, in some examples the cloud network 102 comprises a plurality of cloud networks comprising communicatively coupled computing devices. Furthermore, while the cloud network 102 is shown in FIG. 1B as having three of the computing devices 106, in some examples, the cloud network 102 comprises fewer (or more than) three computing devices 106.

The media playback system 100 may be configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some examples, the network 104 comprises a dedicated communication network that the media playback system 100 uses to transmit messages between individual devices and/or to transmit media content to and from media content sources (e.g., one or more of the computing devices 106). In certain examples, the network 104 is configured to be accessible only to devices in the media playback system 100, thereby reducing interference and competition with other household devices. In other examples, however, the network 104 comprises an existing household communication network (e.g., a household WiFi network). In some examples, the links 103 and the network 104 comprise one or more of the same networks. In some examples, for instance, the links 103 and the network 104 comprise a telecommunication network (e.g., an LTE network, a 5G network). Moreover, in some examples, the media playback system 100 is implemented without the network 104, and devices comprising the media playback system 100 can communicate with each other, for example, via one or more direct connections, PANs, telecommunication networks, and/or other suitable communication links.

In some examples, audio content sources may be regularly added or removed from the media playback system 100. In some examples, for instance, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some examples, for instance, the media content database is stored on one or more of the playback devices 110, network microphone devices 120, and/or control devices 130.

In the illustrated example of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain examples, for instance, the group 107a comprises a bonded zone in which the playback devices 110l and 110m comprise left audio and right audio channels, respectively, of multi-channel audio content, thereby producing or enhancing a stereo effect of the audio content. In some examples, the group 107a includes additional playback devices 110. In other examples, however, the media playback system 100 omits the group 107a and/or other grouped arrangements of the playback devices 110.

The media playback system 100 of FIG. 1B includes the NMDs 120a and 120d, each comprising one or more microphones configured to receive voice utterances from a user. In the illustrated example of FIG. 1B, the NMD 120a is a standalone device and the NMD 120d is integrated into the playback device 110n. The NMD 120a, for example, is configured to receive voice input 121 from a user 123. In some examples, the NMD 120a transmits data associated with the received voice input 121 to a voice assistant service (VAS) configured to (i) process the received voice input data and (ii) transmit a corresponding command to the media playback system 100. In some examples, for instance, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110. Although the media playback system 100 is shown as including a plurality of playback devices 110a-110n, an NMD 120a, a control device 130a, and a network 104, in other examples the media playback system 100 may include one playback device incorporating an upward-firing transducer and one or more microphones, as well as a processor and memory stored at, for example, the playback device, a network microphone device, or a control device.

### b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some examples, the analog I/O 111a is an audio line-in input connection comprising, for example, an auto-detecting 3.5 mm audio line-in connection. In some examples, the digital I/O 111b comprises a Sony/Philips Digital Interface Format (S/PDIF) communication interface and/or cable and/or a Toshiba Link (TOSLINK) cable. In some examples, the digital I/O 111b comprises a High-Definition Multimedia Interface (HDMI) interface and/or cable. In some examples, the digital I/O 111b includes one or more wireless communication links comprising, for example, a radio frequency (RF), infrared, WiFi, Bluetooth, or another suitable communication protocol. In certain examples, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some examples, the local audio source 105 includes local music libraries on a smartphone, a computer, a networked-attached storage (NAS), and/or another suitable device configured to store media files. In certain examples, one or more of the playback devices 110, NMDs 120, and/or control devices 130 comprise the local audio source 105. In other examples, however, the media playback system omits the local audio source 105 altogether. In some examples, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The one or more transducers may include further upward-firing transducers and/or a horizontal-firing transducer. The electronics 112 is configured to receive audio from an audio source (e.g., the local audio source 105) via the input/output 111, one or more of the computing devices 106a-c via the network 104 (FIG. 1B)), amplify the received audio, and output the amplified audio for playback via one or more of the transducers 114. The playback device 110a includes one or more microphones 115 (hereinafter referred to as “the microphones 115”). The microphones 115 may comprise a plurality of microphones, and may be arranged as a microphone array. The microphone array may be an asymmetrical microphone array. In certain examples, for instance, the playback device 110a having the microphones 115 can operate as an NMD configured to receive voice input from a user and correspondingly perform one or more operations based on the received voice input.

In the illustrated example of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some examples, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some examples, the operations further include causing the playback device 110a to send audio data to another one of the playback devices 110a and/or another device (e.g., one of the NMDs 120). Certain examples include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some examples, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some examples, for instance, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated example of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some examples, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain examples, the network interface 112d includes the wired interface 112f and excludes the wireless interface 112e. In some examples, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some examples, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain examples, one or more of the audio processing components 112g can comprise one or more subcomponents of the processors 112a. In some examples, the electronics 112 omits the audio processing components 112g. In some examples, for instance, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some examples, for instance, the amplifiers 112h include one or more switching or class-D power amplifiers. In other examples, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain examples, the amplifiers 112h comprise a suitable combination of two or more of the foregoing types of power amplifiers. Moreover, in some examples, individual ones of the amplifiers 112h correspond to individual ones of the transducers 114. In other examples, however, the electronics 112 includes a single one of the amplifiers 112h configured to output amplified audio signals to a plurality of the transducers 114. In some other examples, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some examples, the transducers 114 can comprise a single transducer. In other examples, however, the transducers 114 comprise a plurality of audio transducers. In some examples, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain examples, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “MOVE,” “PLAY: 5,” “BEAM,” “PLAYBAR,” “PLAYBASE,” “PORT,” “BOOST,” “AMP,” and “SUB.” Other suitable playback devices may additionally or alternatively be used to implement the playback devices of example examples disclosed herein. Additionally, one of ordinary skilled in the art will appreciate that a playback device is not limited to the examples described herein or to SONOS product offerings. In some examples, for instance, one or more playback devices 110 comprises wired or wireless headphones (e.g., over-the-ear headphones, on-ear headphones, in-ear earphones). In other examples, one or more of the playback devices 110 comprise a docking station and/or an interface configured to interact with a docking station for personal mobile media playback devices. In certain examples, a playback device may be integral to another device or component such as a television, a lighting fixture, or some other device for indoor or outdoor use. In some examples, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated example, the playback devices 110a and 110i are separate ones of the playback devices 110 housed in separate enclosures. In some examples, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some examples, for instance, the playback device 110a is full-range playback device configured to render low frequency, mid-range frequency, and high frequency audio content, and the playback device 110i is a subwoofer configured to render low frequency audio content. In some examples, the playback device 110a, when bonded with the first playback device, is configured to render only the mid-range and high frequency components of a particular audio content, while the playback device 110i renders the low frequency component of the particular audio content. In some examples, the bonded playback device 110q includes additional playback devices and/or another bonded playback device.

### c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115, the software components 112c, the network interface 112d, and power 112i. The NMD 120a optionally comprises other components also included in the playback device 110a (FIG. 1C), such as the user interface 113 and/or the transducers 114, as well as other components 112j. In some examples, the NMD 120a is configured as a media playback device (e.g., one or more of the playback devices 110), and further includes, for example, one or more of the audio components 112g (FIG. 1C), the amplifiers 114, and/or other playback device components. In certain examples, the NMD 120a comprises an Internet of Things (IoT) device such as, for example, a thermostat, alarm panel, fire and/or smoke detector, etc. In some examples, the NMD 120a comprises the microphones 115, the voice processing components 124, and only a portion of the components of the electronics 112 described above with respect to FIG. 1B. In some examples, for instance, the NMD 120a includes the processor 112a and the memory 112b (FIG. 1B), while omitting one or more other components of the electronics 112. In some examples, the NMD 120a includes additional components (e.g., one or more sensors, cameras, thermometers, barometers, hygrometers).

In some examples, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other examples, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE ® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

### d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated example, the control device 130a comprises a smartphone (e.g., an iPhone™, an Android phone) on which media playback system controller application software is installed. In some examples, the control device 130a comprises, for example, a tablet (e.g., an iPad™), a computer (e.g., a laptop computer, a desktop computer), and/or another suitable device (e.g., a television, an automobile audio head unit, an IoT device). In certain examples, the control device 130a comprises a dedicated controller for the media playback system 100. In other examples, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some examples, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132 d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130 to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated example, the user interface 133 comprises a display presented on a touch screen interface of a smartphone (e.g., an iPhone™, an Android phone). In some examples, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some examples, the one or more speakers comprise individual transducers configured to correspondingly output low frequencies, mid-range frequencies, and/or high frequencies. In some examples, for instance, the control device 130a is configured as a playback device (e.g., one of the playback devices 110). Similarly, in some examples the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some examples, two or more of the microphones 135 are arranged to capture location information of an audio source (e.g., voice, audible sound) and/or configured to facilitate filtering of background noise. Moreover, in certain examples, the control device 130a is configured to operate as playback device and an NMD. In other examples, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

It will be appreciated that one or more components illustrated in at least FIG. 1C are optional, and may be omitted from a playback device. A playback device may comprise one or more transducer assemblies. In examples, the playback device further comprises one or more processors and memory storing instructions.

### III. Motor Assembly

### A. Motor Covers

As previously discussed, the present disclosure relates to a motor assembly for a transducer. One or more transducers may be incorporated into a playback device, a network microphone device or a control device, such as one of those devices discussed above in relation to FIGS. 1A-H.

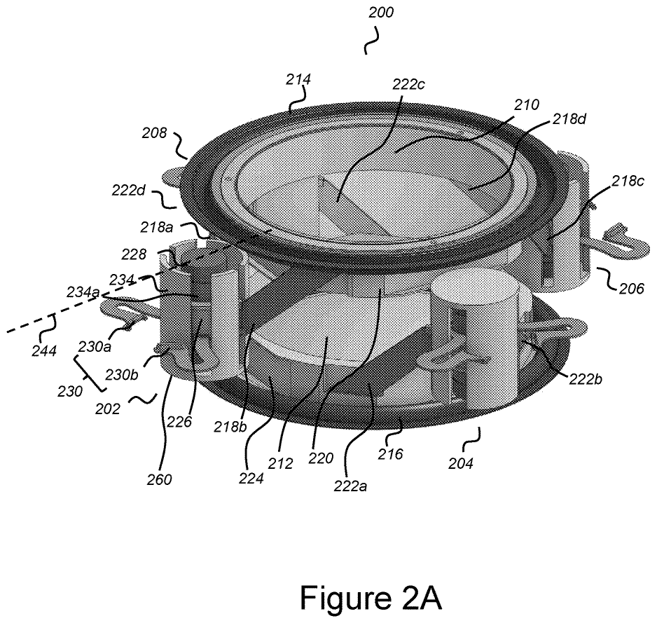

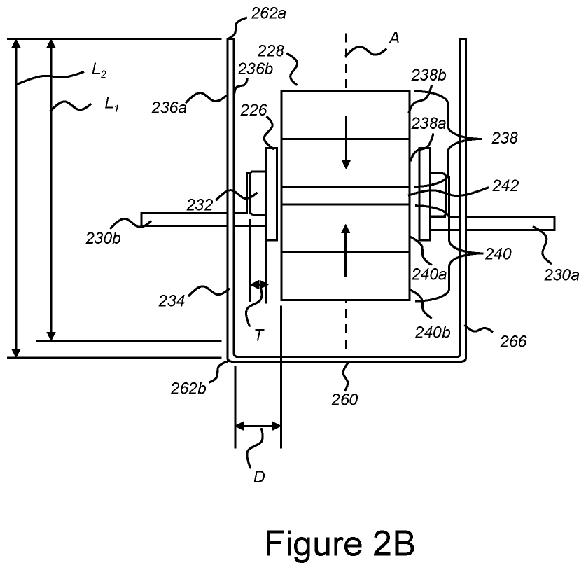

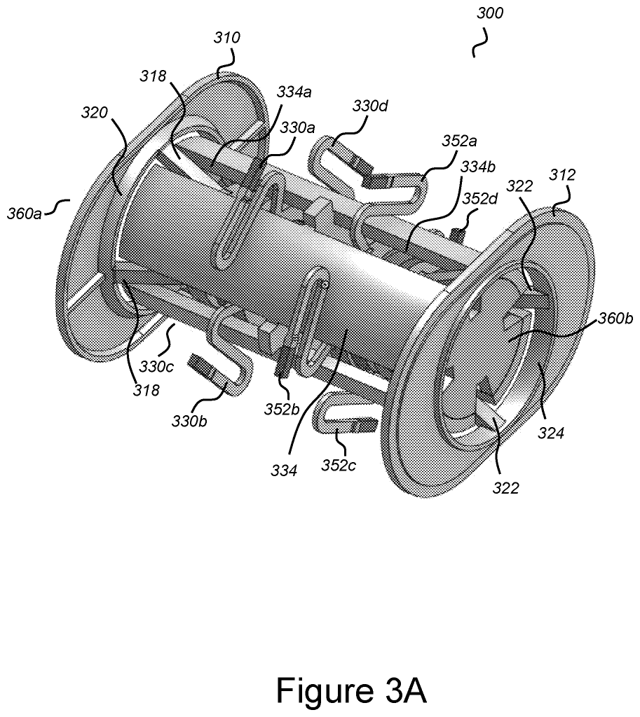

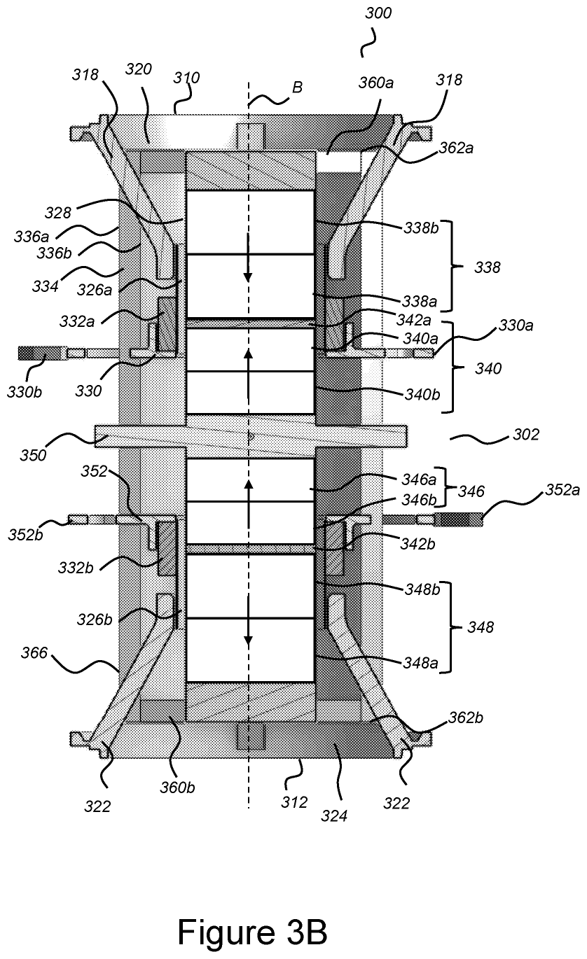

A first type of motor assembly is depicted in FIGS. 2A and 2B. A second type of motor assembly is depicted in FIGS. 3A and 3B. Both types of motor assembly share common features, including a magnetic element, a voice coil, a cover and a member extending through an opening formed in the cover.

FIG. 2A depicts a transducer 200 comprising a motor assembly, where the motor assembly comprises a motor 202. Such a transducer may be housed within a playback device. The motor assembly of this example comprises three further motors 204, 206, 208 (with motor 208 being hidden from view behind a membrane), with each motor being substantially the same as motor 202. In general, a motor assembly may comprise one or more motors.

In this particular example, motors 202 and 206 are arranged and configured to drive a first membrane 210, and motors 204 and 208 are arranged and configured to drive a second membrane 212. For example, motors 202 and 206 are arranged on opposite sides of the first membrane 210 and motors 204 and 208 are arranged on opposite sides of the second membrane 212. The first and second membranes 210, 212 are arranged back-to-back such that acoustic/sound waves, generated by movement of the membranes 210, 212, are directed in opposite directions.

In other examples, the second membrane 212 and associated components, such as motors 204, 208, are omitted. In some examples, a single motor, such as motor 202, drives the first membrane 210. In other examples, two or more motors may drive the first membrane 210. The principles of this disclosure may therefore be applied to single membrane transducers, not just back-to-back membrane arrangements.

Further depicted in FIG. 2A is a first suspension ring 214 coupled to the first membrane 210 and a second suspension ring 216 coupled to the second membrane 212. The suspension rings 214, 216 extend around an outer perimeter of the respective membranes 210, 212 and couple the membranes 210, 212 to a basket or frame of the playback device (not shown in FIG. 2A).

Further depicted in FIG. 2A is a first actuating element, where the first actuating element comprises one or more ribs 218a-d and a first hub 220. The ribs 218a-d are coupled to the first hub 220. The first hub 220 is coupled to and extends around an underside of the first membrane 210. In this example, each motor 202, 206 is associated with two ribs. For example, the first motor 202 is associated with ribs 218a and 218b, and the third motor 206 is associated with ribs 218c and 218d. Movement of the first actuating element (such as movement of the ribs 218a-d and the first hub 220) transfers movement to the first membrane 210 to generate acoustic waves.

Similarly, FIG. 2A further depicts a second actuating element, where the second actuating element comprises one or more ribs 222a-d (with rib 222d being hidden from view) and a second hub 224. The ribs 222a-d are coupled to the second hub 224. The second hub 224 is coupled to and extends around an underside of the second membrane 212. In this example, each motor 204, 208 is associated with two ribs. For example, the second motor 204 is associated with ribs 222a and 222b, and the fourth motor 208 is associated with ribs 222c and 222d. Movement of the second actuating element (such as movement of the ribs 222a-d and the second hub 224) transfers movement to the second membrane 212 to generate acoustic waves.

Each motor 202, 204, 206, 206 comprises a magnetic element and a voice coil extending around the magnetic element. Example magnetic elements are described in U.S. Patent Application No. 63/587,343 and 63/587,353 both entitled, “Transducer Assembly”, filed on Oct. 2, 2023 and incorporated by reference for all purposes. In FIG. 2A, the voice coils are contained within respective voice coil supports, such as voice coil support 226, which extend around respective magnetic elements, such as the magnetic element 228 of the first motor 202. In this example, the voice coils are coupled to the respective actuating elements via respective voice coil supports. For example, voice coil support 226 is coupled to the first actuating element (i.e., the ribs 218a, 218b).

Each motor 202, 204, 206, 208 is further associated with a suspension element (also referred to as a spider) for coupling the respective voice coils to a support structure, such as a basket or frame of the playback device. As is well known, a spider helps keep a voice coil centered within a motor as the voice coil moves. Example suspension elements are described in PCT Patent Application No. PCT/US2023/074844, entitled “Suspension System for Loudspeaker”, and PCT Patent Application No. PCT/US2023/075366, entitled “Conductive Spider”, both of which are incorporated by reference for all purposes. FIG. 2A for example, depicts a suspension element 230 coupled to the voice coil of the first motor 202 via the voice coil support 226. In this example, the suspension element 230 comprises a first arm 230a and a second arm 230b, where both arms are coupled to a support structure of the playback device and the voice coil support 226. Both arms 230a, 230b can flex as the voice coil of the motor 202 moves. In other examples, there may be fewer or a greater number of arms on each suspension element. In some cases, the voice coil support 226 may form part of the suspension element 230.

Each motor 202, 204, 206, 208 further comprises a cover extending around the magnetic element and voice coil of the respective motor. FIG. 2A for example, depicts a cover 234 extending around the magnetic element 228, the voice coil support 226 and the voice coil of the motor 202. As shown in FIG. 2A, the cover 234 delimits a first opening 234a through which the arm 230b of the suspension element extends. The cover 234 of this example delimits three further openings. For example, the other arm 230a extends through a second opening, rib 218b extends through a third opening, and rib 218a extends through a fourth opening. The openings are aligned with the direction of movement of the voice coil so that the members extending through the openings (in this case the arms and ribs) can move along the openings as the voice coil moves.

In this example, the openings through which the arms 230a, 230b of the suspension element 230 extend have wider widths than the openings through which the ribs 218a, 218b extend. The widths of two of the four openings are different to the other two openings. The four openings are distributed around the cover 234 in a manner such that the cover 234 has mirror symmetry about a line of symmetry 244.

It will be appreciated that in other examples, the cover 234 may comprise fewer openings or a greater number of openings. In general, each cover associated with a motor may comprise at least one opening through which a member (such as part of a suspension element or part of an actuating element) may extend. As discussed above, in alternate examples, the cover does not include an opening. Instead, the member(s) may extend out of the cover at ends of cover.

FIG. 2B depicts a cross section of part of a motor assembly, including a motor, such as the motor 202 of FIG. 2A. It will be understood that components of a motor are components of a motor assembly. The other motors depicted in FIG. 2A may have the same or similar structure to the motor depicted in FIG. 2B.

In particular, in FIG. 2B, the motor assembly comprises a magnetic element 228 and a voice coil 232 at least partially surrounding the magnetic element 228. As shown, the voice coil 232 is affixed to the voice coil support 226.

In this example, the magnetic element 228 comprises two magnets, including a first magnet 238 and a second magnet 240. In some examples, the two magnets 238, 240 are coupled together to form the magnetic element 228 during manufacture, but in other examples the magnetic element 228 is a monolithic magnetic element, and the two magnets 238, 240 are part of the same monolithic magnetic element.

The magnetic element 228 of this example further comprises a spacer element 242 (also referred to as a pole piece 242) arranged between the first and second magnets 238, 240. A pole piece can help focus or concentrate the magnetic flux from the magnets 238, 240 (and therefore from the magnetic element 228) onto the voice coil 232. In some examples, the spacer element 242 is omitted.

As shown in FIG. 2B, the first magnet 238 and the second magnet 240 are magnetized having an inverted polarity. For example, a north pole 238a of the first magnet 238 is arranged facing a north pole 240a of the second magnet 240. A south pole 238b of the first magnet 238 is arranged facing away from the second magnet 240, and a south pole 240b of the second magnet 240 is arranged facing away from the first magnet 238. Accordingly, the first and second magnets 238, 240 are generally axially magnetized in the opposite direction (as shown by the arrows). Opposite ends of the magnetic element 228 therefore have the same polarity. In some examples, rather than being axially magnetized along a certain direction, the magnetization direction may bend through the magnetic element.

In this particular configuration, the magnetic element 228 defines a longitudinal axis A.

As illustrated, the voice coil 232 is arranged relative to the first and second magnets 238, 240 (such as arranged at a midpoint between the first and second magnets 238, 240), such that a magnetic field generated by the voice coil 232 interacts with magnetic fields of the first and second magnets 238, 240. This causes the voice coil 232 (and therefore any components coupled to the voice coil 232) to move in a direction along the axis A. The voice coil therefore moves in opposite directions along the axis A.

The voice coil 232 is shown extending around the magnetic element 228 in the region where the first and second magnets 238, 240 have opposing polarity. FIG. 2B shows the voice coil 232 in a rest position (having no displacement or excursion along the axis A).

Because the first actuating element is coupled to the voice coil 232 via the voice coil support 226, movement of the voice coil 232 causes the first actuating element to move. In particular, by reference to FIG. 2A, movement of the voice coil 232 causes the voice coil support 226 to move, which in turn causes the ribs 218a, 218b to move, which in turn causes the first hub 220 to move, which then causes the first membrane 210 move. In this way, movement can be transferred to the first membrane 210.

As discussed, the motor assembly further comprises a cover 234 at least partially enclosing the voice coil 232 and the magnetic element 228. The motor assembly further comprises a first member (in the form of the first arm 230a of the suspension element 230) coupled to the voice coil 232, and a second member (in the form of the second arm 230b of the suspension element 230) coupled to the voice coil 232. In this example, the first and second arms 230a, 230b are both indirectly coupled to the voice coil 232 via the voice coil support 226.

Although not visible in FIG. 2B, the motor assembly further comprises a third member (in the form of rib 218b of the first actuating element) coupled to the voice coil 232, and a fourth member (in the form of rib 218a of the first actuating element) coupled to the voice coil 232. In this example, the ribs 218a, 218b are both indirectly coupled to the voice coil 232 via the voice coil support 226.

Each member 230a, 230b, 218a, 218b extends through a separate opening formed through the cover 234 (as most clearly shown in FIG. 2A). As shown in FIG. 2B, each opening extends from an outer surface 236a of the cover 234 to an inner surface 236b of the cover 234, and at least partially along the cover 234, thereby allowing the members to move along the opening as they move due to movement of the voice coil 232. The cover 234 has a thickness measured between the outer and inner surfaces 236a, 236b.

In the example of FIG. 2B, an opening has a length L₁, and the cover 234 has a length L₂, where both lengths are measured in the direction of movement of the voice coil 232. The opening, in this example, therefore extends partially along the length of the cover 234.

In examples, the magnetic element 228 and the cover 234 are separated by a distance D that is less than 1.3×, less than 1.5×, less than 1.67×, less than 2×, less than 3×, or less than 4× a thickness T of the voice coil 232. The distance D and thickness T are measured in a direction perpendicular to the direction of movement of the voice coil 232 (in this case, perpendicular to the axis A). In examples, this perpendicular direction may be known as a radial direction. The distance D may be known as a gap width. The thickness T of the voice coil 232 may be known as a dimension of the voice coil. The voice coil 232 moves along an excursion path in a direction parallel to axis A.

As further shown in FIG. 2B, the cover 234 comprises a first end 262a and a second end 262b, where the length L₂ of the cover 234 is measured between the first and second ends 262a, 262b. In this example, the cover 234 is closed at one end, in this case the second end 262b, by an endpiece 260. The cover 234 therefore has a body portion 266 and an endpiece 260, where the body portion 266 extends between the first and second ends 262a, 262b. The opening(s) extend along and through the body portion 266 of the cover 234. In this particular example, as is most clearly shown in FIG. 2A, the endpiece 260 and the body portion 266 are integrally formed. The cover 234 therefore has a U-shaped cross section. In some examples, the first end 262a is additionally or alternatively closed. In some examples, the first end 262a of the cover 234 is closed by another endpiece, such as a non-integrally formed endpiece.

The cover 234 is made from magnetic material, such as a ferromagnetic material, a ferrimagnetic material or a paramagnetic material. In this particular example, the cover 234 is made from soft iron. As will be discussed, this causes at least part of the magnetic field of the magnetic element 228 to be concentrated within the cover 234.

In this particular example, the endpiece 260 and cover 234 are made from the same material. Accordingly, at least part of the magnetic field of the magnetic element 228 is also concentrated within the endpiece 260.

FIGS. 3A and 3B depict a second type of motor assembly. For example, FIGS. 3A and 3B depict a transducer 300, comprising a motor assembly, where the motor assembly comprises a motor 302. Such a transducer may be housed within a playback device. In general, a motor assembly may comprise one or more motors.

In this particular example, the motor 302 is arranged and configured to drive a first membrane 310 and a second membrane 312. The first and second membranes 310, 312 are arranged back-to-back such that acoustic/sound waves, generated by movement of the membranes 310, 312, are directed in opposite directions. For visibility purposes, at least part of the membranes 310, 312 are depicted as being transparent in FIGS. 3A and 3B.

Although not depicted in FIGS. 3A and 3B, the transducer 300 may further comprise a first suspension ring coupled to the first membrane 310 and a second suspension ring coupled to the second membrane 312. The suspension rings may extend around an outer perimeter of the respective membranes 310, 312 and couple the membranes 310, 312 to a basket or frame of the playback device (not shown).

Further depicted in FIGS. 3A and 3B is a first actuating element, where the first actuating element comprises one or more ribs 318 and a first hub 320. The ribs 318 are coupled to the first hub 320. In this example, there are four ribs 318 coupled to the first hub 320, although some are hidden from view. The first hub 320 is coupled to and extends around an underside of the first membrane 310. Movement of the first actuating element (such as movement of the ribs 318 and the first hub 320) transfers movement to the first membrane 310 to generate acoustic waves.

Similarly, FIGS. 3A and 3B further depict a second actuating element, where the second actuating element comprises one or more ribs 322 and a second hub 324. The ribs 322 are coupled to the second hub 324. In this example, there are four ribs 322 coupled to the second hub 324, although some are hidden from view. The second hub 324 is coupled to and extends around an underside of the second membrane 312. Movement of the second actuating element (such as movement of the ribs 322 and the second hub 324) transfers movement to the second membrane 312 to generate acoustic waves.

FIG. 3B depicts a cross section of the transducer 300 and in particular, the motor 302. It will be understood that components of a motor are components of a motor assembly.

In particular, in FIG. 3B, the motor assembly comprises a magnetic element 328, a first voice coil 332a at least partially surrounding the magnetic element 328 and a second voice coil 332b at least partially surrounding the magnetic element 328. The first and second voice coils 332a, 332b are offset and spaced apart from each other along the magnetic element 328.

As shown, the first voice coil 332a is affixed to a first voice coil support 326a, and the second voice coil 332b is affixed to a second voice coil support 326b. The voice coil supports 326a, 326b, extend around the magnetic element 328. The ribs 318 of the first actuating element are coupled to the first voice coil 332a via the first voice coil support 326a and the ribs 322 of the second actuating element are coupled to the second voice coil 332b via the second voice coil support 326b.

In this example, the magnetic element 328 comprises four magnets, including a first magnet 338, a second magnet 340, a third magnet 346 and a fourth magnet 348. In some examples, the magnets 338, 340, 346, 348 are coupled together to form the magnetic element 328 during manufacture, but in other examples the magnetic element 328 is a monolithic magnetic element, and the magnets 338, 340, 346, 348 are part of the same monolithic magnetic element. In this particular configuration, the magnetic element 328 defines a longitudinal axis B. In other examples, the magnetic element comprises three magnets. For example, the second and third magnets 340, 346 may be combined into a single magnet.

The magnetic element 328 of this example further comprises a first spacer element 342a (also referred to as a first pole piece 342a) arranged between the first and second magnets 338, 340. The first spacer element 342a can help focus or concentrate the magnetic flux from the magnets 338, 340 (and therefore from the magnetic element 328) onto the first voice coil 332a. In some examples, the first spacer element 342a is omitted. Similarly, the magnetic element 328 of this example further comprises a second spacer element 342b (also referred to as a second pole piece 342b) arranged between the third and fourth magnets 346, 348. The second spacer element 342b can help focus or concentrate the magnetic flux from the magnets 346, 348 (and therefore from the magnetic element 328) onto the second voice coil 332b. In some examples, the second spacer element 342b is omitted.

FIG. 3B also depicts a midpiece 350 (explained in more detail below) arranged between the second and third magnets 340, 346. The first and second magnets 338, 340 form a first magnetic portion of the magnetic element 328 and the third and fourth magnets 346, 348 form a second magnetic portion of the magnetic element 328. The midpiece therefore extends between the first and second magnetic portions. As shown, the midpiece 350 extends beyond the magnetic element 328 and between the first and second voice coils 332a, 332b. The midpiece 350 can reduce magnetic field interference between the two voice coils 332a, 332b.

As shown in FIG. 3B, the first magnet 338 and the second magnet 340 are magnetized having an inverted polarity. For example, a north pole 338a of the first magnet 338 is arranged facing a north pole 340a of the second magnet 340. A south pole 338b of the first magnet 338 is arranged facing away from the second magnet 340, and a south pole 340b of the second magnet 340 is arranged facing away from the first magnet 338. Accordingly, the first and second magnets 338, 340 are generally axially magnetized in the opposite direction (as shown by the arrows).

Similarly, the third magnet 346 and the fourth magnet 348 are magnetized having an inverted polarity. For example, a south pole 346b of the third magnet 346 is arranged facing a south pole 348b of the fourth magnet 348. A north pole 346a of the third magnet 346 is arranged facing away from the fourth magnet 348, and a north pole 348a of the fourth magnet 348 is arranged facing away from the third magnet 346. Accordingly, the third and fourth magnets 346, 348 are generally axially magnetized in the opposite direction (as shown by the arrows). Furthermore, the first and fourth magnets 338, 348 are generally axially magnetized in the same direction as each other, and the second and third magnets 340, 346 are generally axially magnetized in the same direction as each other. Opposite ends of the magnetic element 328 therefore have opposite polarity.

In some examples, rather than being axially magnetized along a certain direction, the magnetization direction may bend through the magnetic element.

As shown, the second magnet 340 is arranged between the first and third magnets 338, 346, the third magnet 346 is arranged between the second and fourth magnets 340, 348 and the second and third magnets 340, 346 are arranged between the first and fourth magnets 338, 348.

As illustrated, the first voice coil 332a is arranged relative to the first and second magnets 338, 340 (such as arranged at a midpoint between the first and second magnets 338, 340), such that a magnetic field generated by the first voice coil 332a interacts with magnetic fields of the first and second magnets 338, 340. This causes the first voice coil 332a (and therefore any components coupled to the voice coil 332a) to move in a direction along the axis B. The first voice coil 332a therefore moves in opposite directions along the axis B. Similarly, the second voice coil 332b is arranged relative to the third and fourth magnets 346, 348 (such as arranged at a midpoint between the third and fourth magnets 346, 348), such that a magnetic field generated by the second voice coil 332b interacts with magnetic fields of the third and fourth magnets 346, 348. This causes the second voice coil 332b (and therefore any components coupled to the voice coil 332b) to move in a direction along the axis B. The second voice coil 332b therefore moves in opposite directions along the axis B.

The voice coils 332a, 332b are shown extending around the magnetic element 328 in the region where the magnets 338, 340, 346, 348 have opposing polarity. FIG. 3B shows the voice coils 332a, 332b in a rest position (having no displacement or excursion along the axis B).

Because the first actuating element is coupled to the first voice coil 332a via the first voice coil support 326a, movement of the first voice coil 332a causes the first actuating element to move. In particular, movement of the first voice coil 332a causes the first voice coil support 326a to move, which in turn causes the ribs 318 to move, which in turn causes the first hub 320 to move, which then causes the first membrane 310 move. In this way, movement can be transferred to the first membrane 310. Similarly, because the second actuating element is coupled to the second voice coil 332b via the second voice coil support 326b, movement of the second voice coil 332b causes the second actuating element to move. In particular, movement of the second voice coil 332b causes the second voice coil support 326b to move, which in turn causes the ribs 322 to move, which in turn causes the second hub 324 to move, which then causes the second membrane 312 move. In this way, movement can be transferred to the second membrane 312.

The motor 302 is further associated with a first suspension element 330 (also referred to as a first spider) for coupling the first voice coil 332a to a support structure, such as a basket or frame of the playback device. FIGS. 3A and 3B for example, show the first suspension element 330 coupled to the first voice coil 332a via the first voice coil support 326a. In this example, first the suspension element 330 comprises four arms, including a first arm 330a, a second arm 330b, a third arm 330c and a fourth arm 330d, where the arms 330a-d are coupled to the support structure of the playback device and the first voice coil support 326a. In other examples, there may be fewer or a greater number of arms on the first suspension element 330. In some cases, the first voice coil support 326a may form part of the first suspension element 330.

Similarly, the motor 302 is further associated with a second suspension element 352 (also referred to as a second spider) for coupling the second voice coil 332b to a support structure, such as a basket or frame of the playback device. FIGS. 3A and 3B for example, show the second suspension element 352 coupled to the second voice coil 332b via the second voice coil support 326b. In this example, the second suspension element 352 comprises four arms, including a first arm 352a, a second arm 352b, a third arm 352c and a fourth arm 352d, where the arms 352a-d are coupled to the support structure of the playback device and the second voice coil support 326b. In other examples, there may be fewer or a greater number of arms on the second suspension element 352. In some cases, the second voice coil support 326b may form part of the second suspension element 352.

The motor 302 further comprises a cover 334 extending around the magnetic element 328 and the first and second voice coils 332a, 332b. As shown most clearly in FIG. 3A, the cover 334 delimits a plurality of openings through which the arms 330a-d, 352a-d and ribs 318, 322 extend. As discussed, the openings are aligned with the direction of movement of the voice coils 332a, 332b, so that the members extending through the openings (in this case the arms and ribs) can move along the openings, as the voice coils move.

For example, the cover 334 delimits a first opening 334a through which the first arm 330a of the first suspension element 330 extends and a second opening 334b through which the first arm 352a of the second suspension element 352 extends. A rib 318 of the first actuating element also extends through the first opening 334a and a rib 322 of the second actuating element extends through the second opening 334b. As shown in FIG. 3A, the first and second openings 334a, 334b are aligned with each other along the cover 334 in the direction of movement of the voice coils 332a, 332b, such as above and below the midpiece 350.

In this example, there are eight openings formed through the cover 334. Through each opening extends a rib and an arm of a suspension element. In this case, there are four openings associated with the first voice coil 332a, and four openings associated with the second voice coil 332b. It will be appreciated that in other examples, the cover 334 may comprise fewer openings or greater number of openings. In general, the cover 334 may comprise at least one opening through which a member (such as part of a suspension element or part of an actuating element) may extend. As discussed above, in alternate examples, the cover does not include an opening. Instead, the member(s) may extend out of the cover at ends of cover.

In this example, the openings all have the same width and are equally spaced apart around the cover 334 in a manner such that the cover 334 has rotational symmetry about an axis that is parallel to the direction of movement of the voice coils 332a, 332b (such as the longitudinal axis B).

Each opening formed through the cover 334, extends from an outer surface 336a of the cover 334 to an inner surface 336b of the cover 334 (as shown in FIG. 3B), and at least partially along the cover 334, thereby allowing the members to move along the openings as they move due to movement of the voice coils 332a, 332b. The cover 334 has a thickness measured between the outer and inner surfaces 336a, 336b.

In examples, the magnetic element 328 and the cover 334 are separated by a distance that is less than 1.3×, less than 1.5×, less than 1.67×, less than 2×, less than 3×, less than 4× a thickness of the voice coils 332a, 332b.

As further shown in FIGS. 3A and 3B, the cover 334 comprises a first end 362a and a second end 362b, where a length of the cover 334 is measured between the first and second ends 362a, 362b. In this example, the cover 334 is closed at both ends by endpieces 360a, 360b. The cover 334 therefore has a body portion 366, a first endpiece 360a and a second endpiece 360b, where the body portion 366 extends between the first and second ends 362a, 362b. The opening(s) extend along and through the body portion 366 of the cover 334.

In this particular example, the midpiece 350 and body portion 366 are integrally formed, and the endpieces 360a, 306b and the body portion 366 are not-integrally formed. For example, the endpieces 360a, 360b may be affixed to the body portion 366 once the magnetic element 328 is assembled within the body portion 366. The cover 234 therefore has an H-shaped cross section when the end pieces 360a, 360b of the cover 334 are removed or not accounted for.

In some examples, neither or only one of the ends 362a, 362b are closed. In some examples, the midpiece 350 may not be integrally formed with the body portion 366 and one endpiece may be integrally formed with the body portion 366. In other examples, none of the endpieces or the midpiece 350 are integrally formed with the body portion 366.

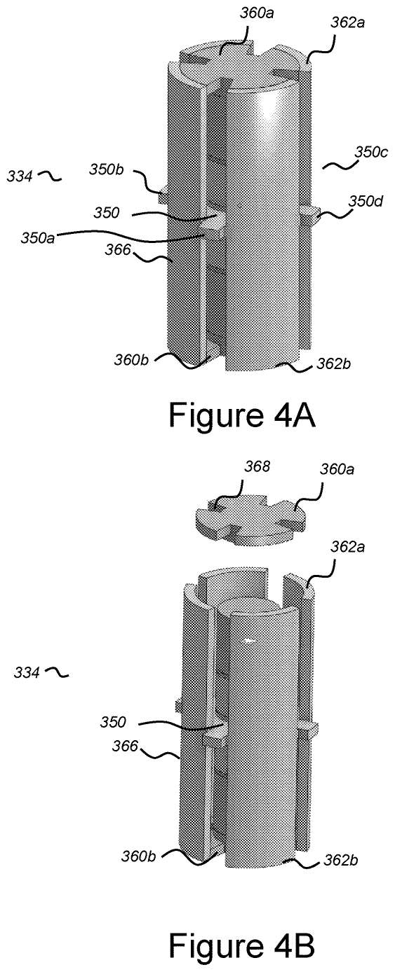

FIGS. 4A and 4B show an isolated view of the cover 334, where the endpieces are not-integrally formed with the body portion of the cover 366. FIG. 4B, for example, shows the first endpiece 360a separated from the body portion 366. The endpiece(s) also include one or more notches 368 aligned with the one or more openings formed along the body portion 366 of the cover 334. In some cases, the notches are not present. The notches 368 can allow the lengths of the openings to be maximized, allowing movement of the members (such as the arms or ribs) without having to increase the length of the overall cover 334. This results in a more compact and lower profile motor assembly.

FIGS. 4A and 4B further depict more clearly the midpiece 350 comprising protrusions 350a-d (with protrusion 350c being obscured from view). The protrusions 350a-d of the midpiece 350 each extend beyond the outer surface 336a of the cover 334, and can be received in one or more corresponding recesses (not shown). For example, the recesses may be formed within a basket or frame of a speaker or playback device within which the motor assembly and transducer are located. The midpiece 350 (and in some cases the cover 334) may therefore be held in place.

The cover 334 is made from magnetic material, such as a ferromagnetic material, a ferrimagnetic material or a paramagnetic material. In this particular example, the cover 334 is made from soft iron. As will be discussed, this causes at least part of the magnetic field of the magnetic element 328 to be concentrated within the cover 334.

In this particular example, the midpiece 350 and cover 334 are made from the same material. Accordingly, at least part of the magnetic field of the magnetic element 328 is also concentrated within the midpiece 350. Similarly, the endpiece(s) may be formed of the same material, and so least part of the magnetic field of the magnetic element 328 is also concentrated within the endpiece(s).

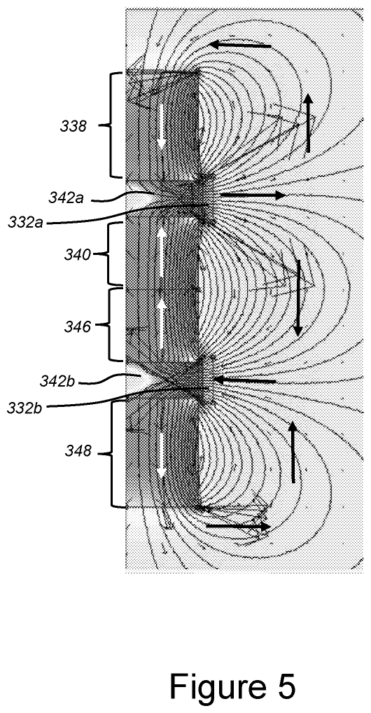

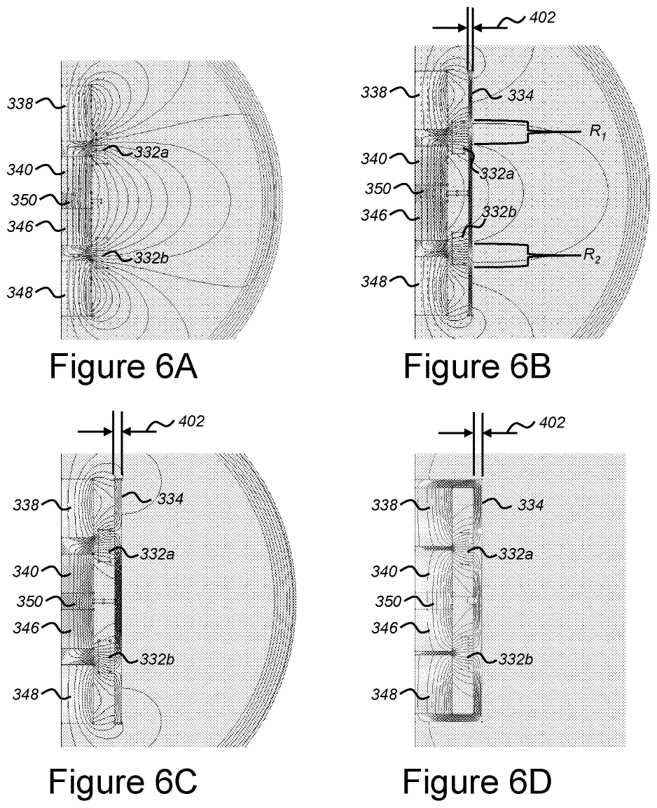

In both example motor assemblies discussed above in FIGS. 2A, 2B, 3A and 3B, the covers 234, 334 act as a magnetic field return path for the magnetic elements 228, 328. To demonstrate, FIGS. 5 and 6A-6D will be explained.

In particular, FIG. 5 depicts a plot of the magnetic field strength at various points around a magnetic element, in this case the magnetic element 328 of FIG. 3B. In this example, the cover 334 and midpiece 350 are omitted. The second and third magnets 346, 348 therefore essentially form a single magnet, given they are magnetized in the same direction. The arrows in FIG. 5 depict the directions of magnetic field of the magnetic element 328 at various points in space. As shown, the magnetic field of the magnetic element 328 permeates through the space around the magnetic element 328.

FIG. 6A depicts another plot of the magnetic field strength at various points around a magnetic element, in this case the magnetic element 328 of FIG. 3B. In this example, the cover 334 is omitted and a midpiece 350 is present. The midpiece 350 separates the second and third magnets 346, 348. In absence of the cover 334, the distribution of the magnetic field of the magnetic element 328 is similar to the example shown in FIG. 5. The magnetic field of the magnetic element 328 therefore permeates through the space around the magnetic element 328.

FIG. 6B depicts another plot of the magnetic field strength at various points around a magnetic element, in this case the magnetic element 328 of FIG. 3B. In this example, the cover 334 and midpiece 350 are both present. The cover 334 has a thickness 402, measured in a direction perpendicular to the direction of movement of the voice coils 332a, 332b (and perpendicular to the longitudinal axis B of the magnetic element 328). As shown, at least part of the magnetic field of the magnetic element 328 is concentrated within the cover 334. The magnetic field therefore flows through and along the cover, and acts as a magnetic field return path.

In this case, the thickness 402 of the cover 334 is 1 mm. As shown, some of the magnetic flux is not concentrated within the cover 334. For example, FIG. 6B shows some magnetic field lines extending beyond the cover 334. In this case, this is because the cover 334 is not thick enough, and the magnetic field has saturated the cover 334.

FIG. 6C depicts another example, where the thickness 402 of the cover 334 is increased to 2 mm. In this example, the cover 334 and midpiece 350 are both present. As shown, a greater proportion of the magnetic field of the magnetic element 328 is concentrated within the cover 334.

FIG. 6D depicts another example, where the thickness 402 of the cover 334 is also 2 mm. In this example, the cover 334 and midpiece 350 are both present and a first end of the cover 334 is closed by the first endpiece 360a, and a second end of the cover 334 is closed by the second endpiece 360b. As shown, a greater proportion of the magnetic field of the magnetic element 328 is concentrated within the cover 334 due to the ends of the cover 334 being closed. The endpieces 360a, 360b therefore close the magnetic return path.

In the examples of FIGS. 6B-6D, the cover 334 has a uniform thickness along its length. In some cases, however, the thickness of the cover 334 may vary along its length (i.e., it is non-uniform). For example, as seen in FIG. 6B, in the two regions R₁ and R₂ of the cover 334, the cover 334 is not saturated. This is because the magnetic field strength is lower in the cover 334 at these points. Accordingly, the cover 334 may be thinner in one or more regions along its length, compared to other regions along its length. For example, the cover 334 in FIG. 6D may be modified to have a thickness of 1 mm in the regions of R₁ and R₂ and 2 mm elsewhere. In general terms, the cover may have a smaller thickness in regions adjacent the voice coil(s) and a greater thickness in other regions.

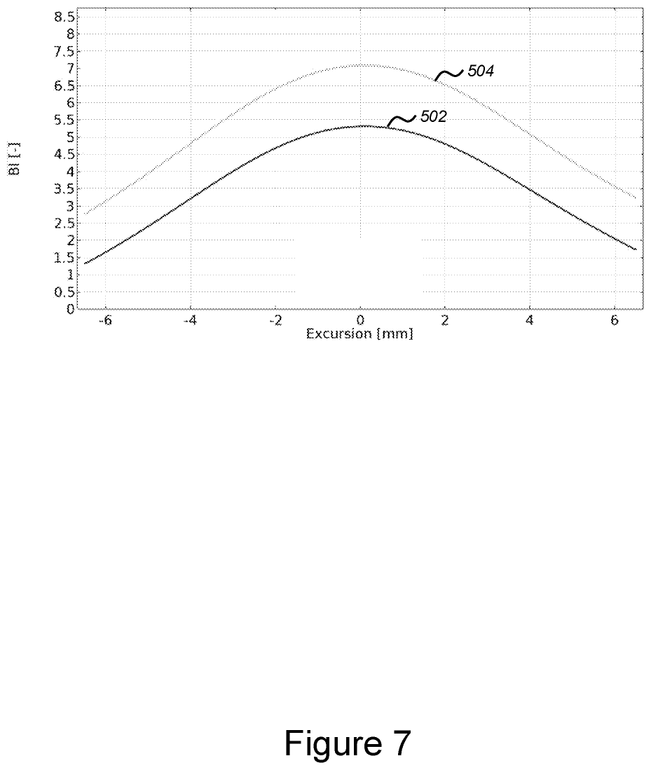

As mentioned, the use of a cover, and in particular a cover with closed ends, reduces the reluctance of the motor, resulting in a more efficient motor. The use of a cover can therefore increase the BL value of a transducer for the same volume of magnetic material in the magnetic element. FIG. 7 depicts a first BL curve 502 for a transducer without a cover and a second BL curve 504 for a transducer with a cover. The first BL curve 502 may be representative of the motor assembly discussed in FIG. 6A and the second BL curve 504 may be representative of the motor assembly discussed in FIG. 6D, for example.

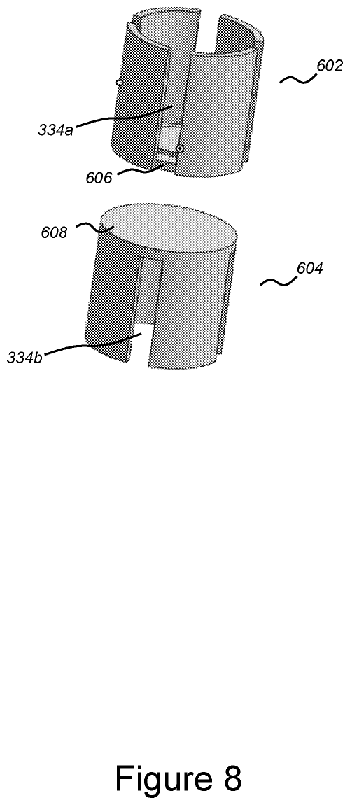

In some examples, the cover 334 of FIGS. 3A, 3B, 4A and 4B may be constructed in two parts. To illustrate, FIG. 8 depicts a first cover part 602 and a second cover part 604. The first and second cover parts 602, 604 may have a U-shaped cross-sections, for example.

The first cover part 602 delimits the first opening 334a and the second cover part 604 delimits the second opening 334b. In this example, both cover parts 602, 604 delimit 3 further openings.

The first cover part 602 comprises a first base 606 and the second cover part 604 comprises a second base 608. When the first and second bases 606, 608 are brought together, such as they are arranged to abut each other, they can form the midpiece 350.

It will be appreciated that features and components discussed in the examples of FIGS. 2A and 2B may apply equally to the examples discussed in FIGS. 3A-8 (and vice versa). In an example, two or more of the motors 302 of FIGS. 3A and 3B may operate together in the same way as discussed in FIG. 2A. For example, rather than being driven by a single motor 302, the membrane 310 may be driven by two or more motors 302 and membrane 312 may be driven by the same two or more motors 302.

### b. Auxiliary Magnetic Elements

In any of the above-d escribed motor assemblies, the motor assembly may further comprise one or more auxiliary magnetic elements arranged between the magnetic element 228, 328 and the cover 234, 334. The, or each, auxiliary magnetic element can be coupled to a voice coil, such as coupled to a voice coil support or an actuating element. The, or each auxiliary magnetic element generates a second magnetic field that causes a magnetic flux density through the voice coil and cover to be increased. In the example of FIGS. 2A and 2B, there may be one or more auxiliary magnetic elements associated with the voice coil 232, and in the example of FIGS. 3A and 3B, there may be one or more auxiliary magnetic elements associated with the first voice coil 332a and/or one or more auxiliary magnetic elements associated with the second voice coil 332b.

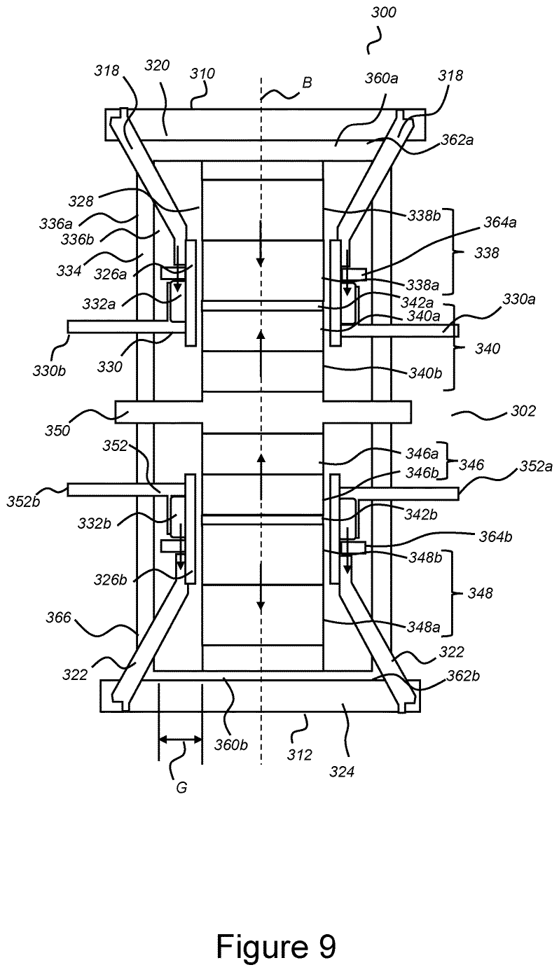

To illustrate, FIG. 9 depicts a cross-section of the transducer 300 shown in FIGS. 3A and 3B, where the motor assembly further includes at least one auxiliary magnetic element arranged between the magnetic element 328 and the cover 334. All of the other components of the transducer 300 remain the same as described above in relation to FIGS. 3A and 3B (although in some examples, spacings between components and/or dimensions components may be different to enable the one or more auxiliary magnetic elements to be incorporated in the motor assembly). For example, a gap width G between the inner surface 336b of the cover 334 and the magnetic element 328 may be wider than in the examples shown in FIGS. 3A and 3B or a length of the transducer may be longer than in the examples shown in FIGS. 3A and 3B.

As shown in FIG. 9, the motor assembly further comprises a first auxiliary magnetic element 364a arranged between the magnetic element 328 and the cover 334. The first auxiliary magnetic element 364a is coupled to the first voice coil 332a such that movement of the first voice coil 332a causes the first auxiliary magnetic element 364a to move. In particular, in this example, the first auxiliary magnetic element 364a is affixed to the first voice coil support 326a. In other examples, the first auxiliary magnetic element 364a is affixed to the first actuating element, such as the rib(s) 318. The first auxiliary magnetic element 364a generates a second magnetic field arranged relative to the magnetic field of the magnetic element 32, such that a magnetic flux density through the first voice coil 332a and cover 334 is increased.

To increase the magnetic flux density within the first voice coil 332a, the first auxiliary magnetic element 364a is arranged either above or below the first voice coil 332a in a direction along the longitudinal axis B. As such, the first auxiliary magnetic element 364a is offset from the first voice coil 332a along the direction of movement of the voice coil (in a direction along the longitudinal axis B). Furthermore, the first auxiliary magnetic element 364a is magnetized in a particular manner to focus or push magnetic flux of the magnetic element 328 onto the first voice coil 332a. This may be achieved by arranging the first auxiliary magnetic element 364a such that a magnetic axis of the first auxiliary magnetic element 364a is aligned in the direction of movement of the first voice coil 332a. For example, in FIG. 9 the arrow above the first auxiliary magnetic element 364a shows the first auxiliary magnetic element 364a being axially magnetized in a direction parallel to the direction of movement of the first voice coil 332a. The direction of the arrow, pointing from north to south, further shows that magnetic poles of the first auxiliary magnetic element 364a point in substantially the same direction as the magnetic poles of the first magnet 338, which is arranged adjacent the first auxiliary magnetic element 364a.

In examples where the first auxiliary magnetic element 364a is arranged on the other side of the first voice coil 332a (or there is a further auxiliary magnetic element arranged on the other side of the first voice coil 332a), the magnetic poles of the first auxiliary magnetic element 364a would point in substantially the same direction as the magnetic poles of the second magnet 340. The auxiliary magnetic element would therefore be axially aligned in the opposite direction to that shown in FIG. 9. It will be appreciated that if the magnetic poles of the magnetic element 328 were reversed to those shown in FIG. 9, the magnetic poles of the auxiliary magnetic element(s) would also be reversed.

As will become apparent, this alignment of magnetic fields focuses a greater proportion of the magnetic field of the magnetic element 328 onto the first voice coil 332a, and because the first auxiliary magnetic element 364a moves with the first voice coil 332a, this amplifies and/or assists the movement of the first voice coil 332a as the first voice coil 332a moves. The presence of the first auxiliary magnetic element 364a also means that a greater proportion of the magnetic field of the magnetic element 328 is concentrated within the cover 334.

In this example, another auxiliary magnetic element 364b is additionally coupled to the second voice coil 332b. As such, the motor assembly further comprises a second auxiliary magnetic element 364b arranged between the magnetic element 328 and the cover 334. The second auxiliary magnetic element 364b is coupled to the second voice coil 332b such that movement of the second voice coil 332b causes the second auxiliary magnetic element 364b to move. In particular, in this example, the second auxiliary magnetic element 364b is affixed to the second voice coil support 326b. In other examples, the second auxiliary magnetic element 364b is affixed to the second actuating element, such as the rib(s) 322. The second auxiliary magnetic element 364b generates a third magnetic field arranged relative to the magnetic field of the magnetic element 32, such that a magnetic flux density through the second voice coil 332b and cover 334 is increased.

In the same way as discussed above for the first auxiliary magnetic element 364a, the second auxiliary magnetic element 364b is offset from the second voice coil 332b along the direction of movement of the second voice coil (in a direction along the longitudinal axis B). Furthermore, the second auxiliary magnetic element 364b is magnetized in a particular manner to focus or push magnetic flux of the magnetic element 328 onto the second voice coil 332b. As discussed above, this may be achieved by arranging the second auxiliary magnetic element 364b such that a magnetic axis of the second auxiliary magnetic element 364b is aligned in the direction of movement of the second voice coil 332b. For example, in FIG. 9 the arrow above the second auxiliary magnetic element 364b shows the second auxiliary magnetic element 364b being axially magnetized in a direction parallel to the direction of movement of the second voice coil 332b. The direction of the arrow, pointing from north to south, further shows that magnetic poles of the second auxiliary magnetic element 364b point in substantially the same direction as the magnetic poles of the fourth magnet 348, which is arranged adjacent the second auxiliary magnetic element 364b.

In examples where the second auxiliary magnetic element 364b is arranged on the other side of the second voice coil 332b (or there is a further auxiliary magnetic element arranged on the other side of the second voice coil 332b), the magnetic poles of the second auxiliary magnetic element 364b would point in substantially the same direction as the magnetic poles of the third magnet 346. The auxiliary magnetic element would therefore be axially aligned in the opposite direction to that shown in FIG. 9.

In the same way as discussed earlier, this alignment of magnetic fields focuses a greater proportion of the magnetic field of the magnetic element 328 onto the second voice coil 332b.

In the example of FIG. 9, the first and second auxiliary magnetic elements 364a, 364b are ring shaped and extend around the magnetic element 328. In other examples, either or both auxiliary magnetic elements 364a, 364b are formed from a plurality of separate/discrete magnetic bodies that are distributed at least partially around the magnetic element 328. The plurality of separate magnetic bodies making up each auxiliary magnetic element may all lie in the same plane (the plane being perpendicular to the longitudinal axis B) or may be positioned at different positions along the longitudinal axis B.

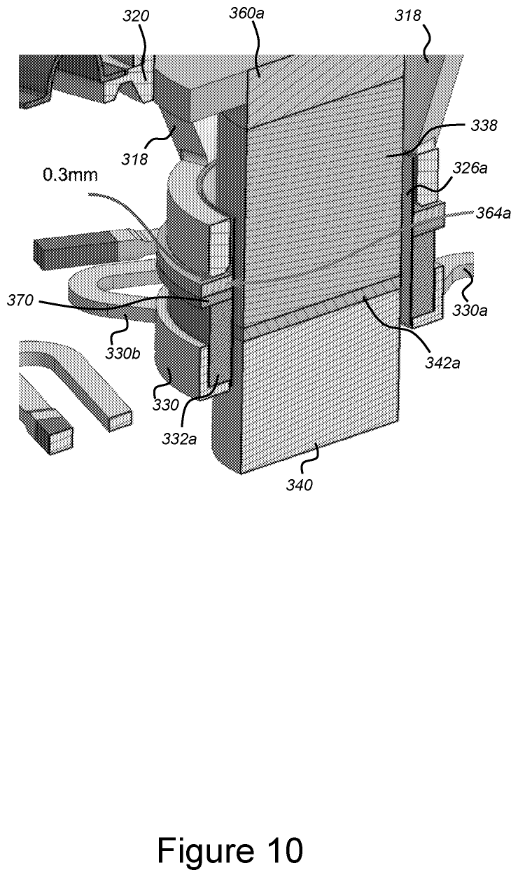

FIG. 10 depicts a cross-section perspective view of a part of a transducer identical to that shown in FIG. 9, but with a magnet support 370 and without showing the cover. The first auxiliary magnetic element 364a may be mounted onto the magnet support 370. The magnet support 370 may provide a spacer between the first voice coil 332a and the first auxiliary magnetic element 364a. As shown, the magnet support 370 and the first auxiliary magnetic element 364a are affixed to the first voice coil support 326a. The magnet support 370 may provide thermal insulation between the auxiliary magnetic element and the voice coil. For example, without the magnet support 370, the auxiliary magnetic element may be directly attached to the voice coil and the voice coil may be the element in a transducer with a highest temperature when in operation. This can lead to a demagnetization of the auxiliary magnetic element. The magnet support 370 can also be used to place the auxiliary magnetic element at right position relative to the magnetic element.

The magnet support 370 may be ceramic or plastic. In examples, the magnet support 370 is non-magnetic. A second magnet support (now shown) may support the second auxiliary magnetic element 364b in the same way. In examples, the magnet support(s) may be omitted.

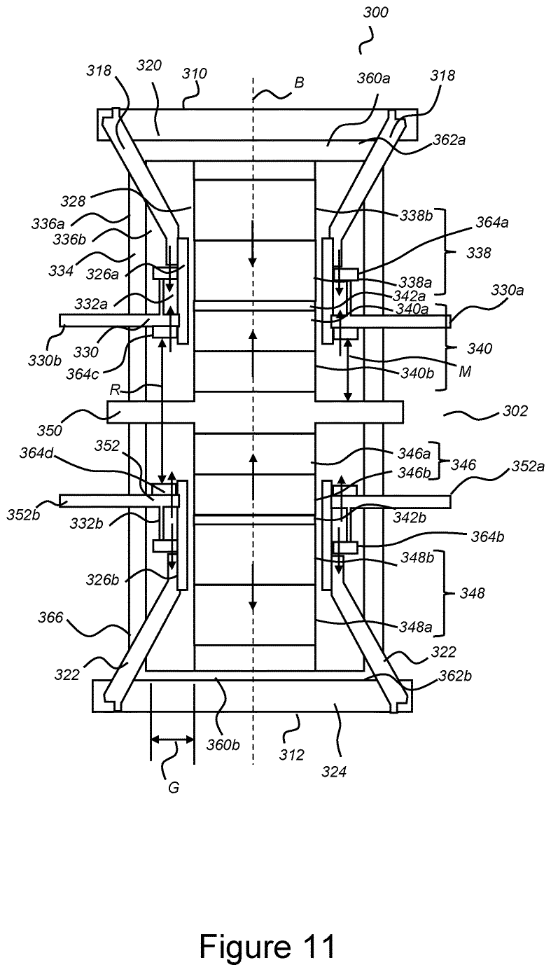

FIG. 11 depicts a modification of the transducer 300 shown in FIG. 9 and includes two auxiliary magnetic elements associated with and coupled to each of the voice coils. The use of two auxiliary magnetic elements further increases the magnetic flux density within the voice coil. In particular, FIG. 11 depicts a first auxiliary magnetic element 364a coupled to the first voice coil 332a, a second auxiliary magnetic element 364b coupled to the second voice coil 332b, a third auxiliary magnetic element 364c coupled to the first voice coil 332a, and a fourth auxiliary magnetic element 364d coupled to the second voice coil 332b.

As shown in FIG. 11, the first auxiliary magnetic element 364a is offset from the first voice coil 332a along the direction of movement of the first voice coil 332a in a first direction (such as towards the first membrane 310) and the third auxiliary magnetic element 364c is offset from the first voice coil 332a along the direction of movement of the first voice coil 332a in a second direction, opposite to the first direction (such as away from the first membrane 310). The first and third auxiliary magnetic elements 364a, 364c are therefore axially offset from each other along the longitudinal axis B, and are arranged on opposite sides of the first voice coil 332a.

Similarly, the second auxiliary magnetic element 364b is offset from the second voice coil 332b along the direction of movement of the second voice coil 332b in the second direction (such as towards the second membrane 312) and the fourth auxiliary magnetic element 364d is offset from the second voice coil 332b along the direction of movement of the second voice coil 332b in the first direction (such as away from the second membrane 312). The second and fourth auxiliary magnetic elements 364b, 364d are therefore axially offset from each other along the longitudinal axis B, and are arranged on opposite sides of the second voice coil 332b.

As is also apparent from FIG. 11, the third auxiliary magnetic element 364c is positioned between the first voice coil 332a and the midpiece 350 along the direction of movement of the first voice coil 332a (and along the longitudinal axis B). Similarly, the fourth auxiliary magnetic element 364d is positioned between the second voice coil 332b and the midpiece 350 along the direction of movement of the second voice coil 332b (and along the longitudinal axis B).

In the rest position shown in FIG. 11, the third and fourth auxiliary magnetic elements 364c, 364d are separated by a distance R. When the first and second voice coils 332a, 332b are both at their maximum excursion positions (and therefore move in a direction towards each other), the third and fourth auxiliary magnetic elements 364c, 364d are separated by a distance less than R, the distance being great enough to avoid magnetic interference between the third and fourth auxiliary magnetic elements 364c, 364d.

In this example, when the first and second voice coils 332a, 332b are arranged in their rest positions, as shown in FIG. 11, the third and fourth auxiliary magnetic elements 364c, 364d are both spaced apart from the midpiece 150 by a distance M of about 6 mm, where M is greater than a maximum excursion distance of the first and second voice coils 332a, 332b.

In this example, the magnetic poles of the first and second auxiliary magnetic elements 364a, 364b are the same as described in relation to FIG. 9. Furthermore, the third auxiliary magnetic element 364c is also magnetized in a particular manner to focus or push magnetic flux of the magnetic element 328 onto the first voice coil 332a. This may be achieved by arranging the third auxiliary magnetic element 364c such that a magnetic axis of the third auxiliary magnetic element 364c is aligned in the direction of movement of the first voice coil 332a. For example, in FIG. 11 the arrow above the third auxiliary magnetic element 364c shows the third auxiliary magnetic element 364c being axially magnetized in a direction parallel to the direction of movement of the first voice coil 332a. The direction of the arrow, pointing from north to south, further shows that magnetic poles of the third auxiliary magnetic element 364c point in substantially the same direction as the magnetic poles of the second magnet 340, which is arranged adjacent the third auxiliary magnetic element 364c. The first and third auxiliary magnetic elements 364a, 364c are axially magnetized in the opposite direction to each other.

The fourth auxiliary magnetic element 364d is also magnetized in a particular manner to focus or push magnetic flux of the magnetic element 328 onto the second voice coil 332b. This may be achieved by arranging the fourth auxiliary magnetic element 364d such that a magnetic axis of the fourth auxiliary magnetic element 364d is aligned in the direction of movement of the second voice coil 332b. For example, in FIG. 11 the arrow above the fourth auxiliary magnetic element 364d shows the fourth auxiliary magnetic element 364d being axially magnetized in a direction parallel to the direction of movement of the second voice coil 332b. The direction of the arrow, pointing from north to south, further shows that magnetic poles of the fourth auxiliary magnetic element 364d point in substantially the same direction as the magnetic poles of the third magnet 346, which is arranged adjacent the fourth auxiliary magnetic element 364d. The second and fourth auxiliary magnetic elements 364b, 364d are axially magnetized in the opposite direction to each other.

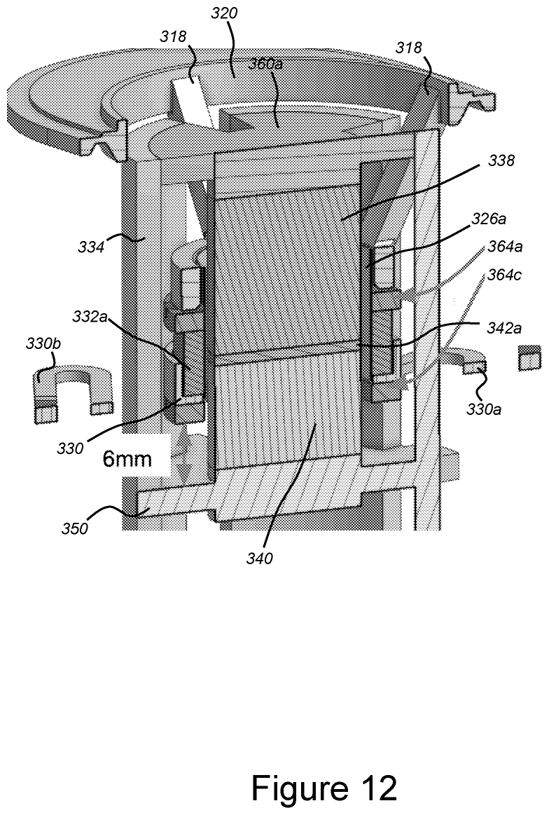

FIG. 12 depicts a cross-section perspective view of a part of the transducer shown in FIG. 11.

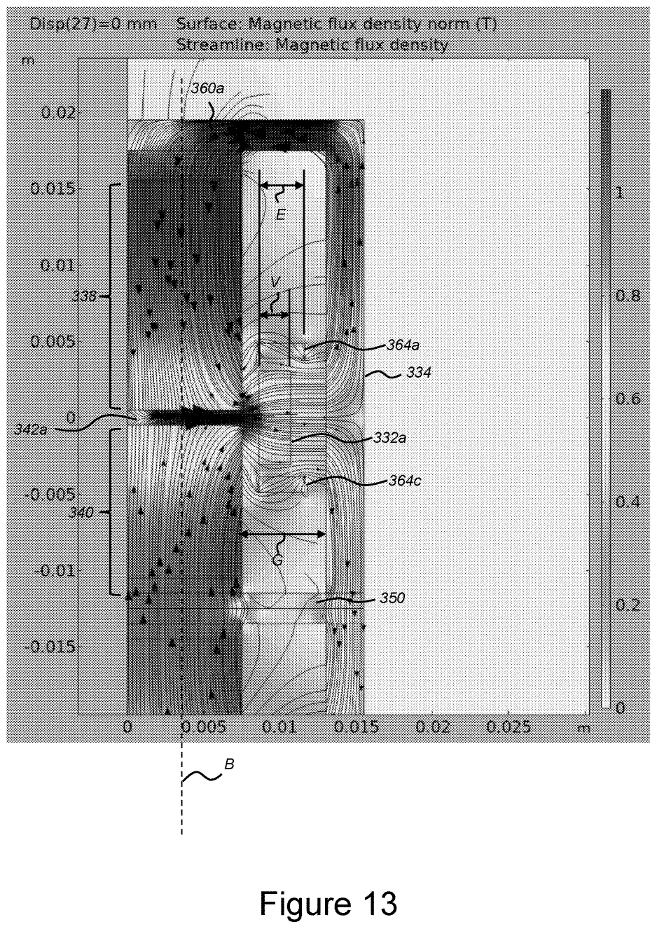

In the examples discussed above where the motor assembly additionally comprises one or more auxiliary magnetic elements, each auxiliary magnetic element acts to “push” stray magnetic flux from the magnetic element through the voice coil and into the cover. To demonstrate, FIG. 13 will be explained.

FIG. 13 depicts a plot of the magnetic flux density at various points around part of a magnetic element, in this case the magnetic element 328 of FIG. 11 where there are two auxiliary magnetic elements 364a, 364c positioned either side of the first voice coil 332a. Magnetic fields of each auxiliary magnetic element are arranged relative to the magnetic field of the magnetic element 328 to increase the magnetic flux density in the first voice coil 332a and cover 334 by focusing the magnetic field of the magnetic element 328 (in particular the magnetic fields of the first and second magnets 338, 340) onto the first voice coil 332a and into the cover 334.

As further shown in FIG. 13, the first voice coil 332 a has a first dimension/thickness V in a radial direction perpendicular to the longitudinal axis B, and the first and second auxiliary magnetic elements 364a, 364c both have a second dimension/thickness E in the radial direction. As shown, the second dimension E is greater than the first dimension V. In examples, the first and second auxiliary magnetic elements 364a, 364c both have a second dimension E in the radial direction which is between about 50% and 95% of the gap width G. In this example, the second dimension E is about 60% of the gap width G, the gap width G is about 5 mm, and the second dimension E is about 3 mm.

In the example motor assemblies discussed in relation to FIGS. 9 to 13, the one or more auxiliary magnetic elements are arranged either above or below the voice coil in a direction along the longitudinal axis of the magnetic element 328.

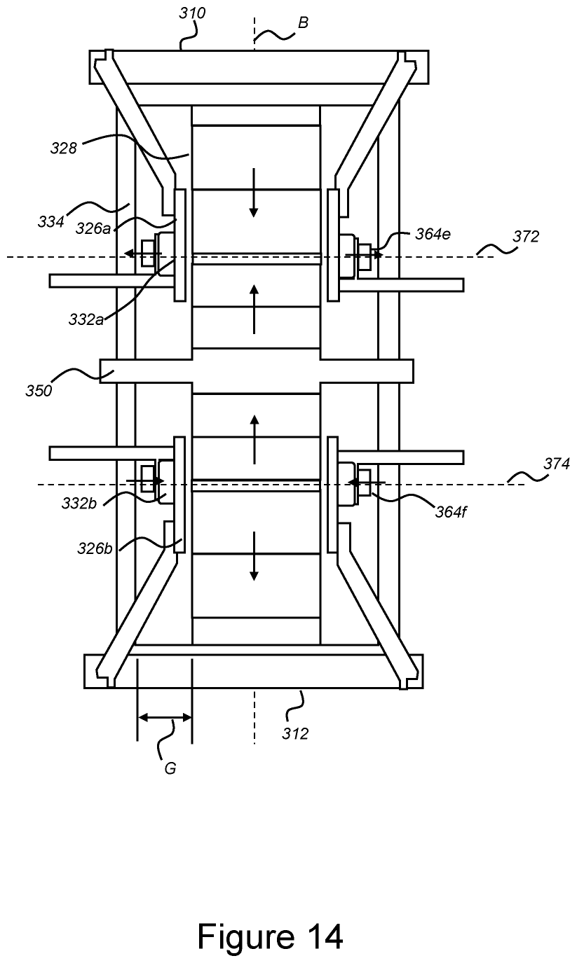

FIG. 14 depicts an alternative arrangement for an auxiliary magnetic element relative to a voice coil, where the auxiliary magnetic element is instead offset from the voice coil in a direction perpendicular to the direction of movement of the voice coil. To increase the magnetic flux density within the voice coil and cover, the magnetic element has a magnetic axis that is arranged perpendicular to the direction of movement of the voice coil, thereby adding to the magnetic flux passing through the voice coil in the perpendicular direction.

To illustrate, FIG. 14 depicts a cross-section of the transducer 300 shown in FIGS. 3A and 3B, where the motor assembly further includes at least one auxiliary magnetic element arranged between the magnetic element 328 and the cover 334. All of the other components of the transducer 300 remain the same as described above in relation to FIGS. 3A and 3B (although in some examples, spacings between components and/or dimensions components may be different to enable the one or more auxiliary magnetic elements to be incorporated in the motor assembly. For example, a gap width G between the inner surface of the cover 334 and the magnetic element 328 may be wider than in the examples shown in FIG. 3A, 3B or 9 to 13.

As shown in FIG. 14, the motor assembly further comprises an auxiliary magnetic element 364e arranged between the magnetic element 328 and the cover 334. The auxiliary magnetic element 364e is coupled to the first voice coil 332a such that movement of the first voice coil 332a causes the auxiliary magnetic element 364a to move. In particular, in this example, the auxiliary magnetic element 364e is affixed to the first voice coil support 326a. As mentioned, the voice coil support may form part of the suspension element. In other examples, the auxiliary magnetic element 364e is affixed to the first actuating element, such as the rib(s) 318. The auxiliary magnetic element 364e generates a magnetic field arranged relative to the magnetic field of the magnetic element 328, such that a magnetic flux density through the first voice coil 332a and cover 334 is increased.

To increase the magnetic flux density within the first voice coil 332a, the auxiliary magnetic element 364e is arranged either outside or inside the first voice coil 332a along a radial direction, the radial direction being perpendicular the longitudinal axis B and the direction of movement of the first voice coil 332a. Furthermore, the auxiliary magnetic element 364e is magnetized in a particular manner to add to the magnetic flux of the magnetic element 328 that is already passing through the first voice coil 332a in the radial direction. This may be achieved by arranging the auxiliary magnetic element 364e such that a magnetic axis 372 of the auxiliary magnetic element 364e is perpendicular to the direction of movement of the first voice coil 332a, and positioned such that a plane that is perpendicular to the longitudinal axis B intersects both the first voice coil 332a and the auxiliary magnetic element 364e. The magnetic axis 372 therefore passes through the first voice coil 332a.

For example, in FIG. 14 the arrow above the auxiliary magnetic element 364e shows the auxiliary magnetic element 364e being axially magnetized in a direction perpendicular to the direction of movement of the first voice coil 332a. The direction of the arrow, pointing from north to south, further shows that magnetic poles of the auxiliary magnetic element 364e point in substantially the same direction as the magnetic field lines of the magnetic element 328 that pass out of the magnetic element 328 and through the first voice coil 332a. It will be appreciated that if the magnetic poles of the magnetic element 328 were reversed to those shown in FIG. 14, the magnetic poles of the auxiliary magnetic element(s) would also be reversed.

This alignment of magnetic fields increases the magnetic flux density within the first voice coil 332a, and because the auxiliary magnetic element 364e moves with the first voice coil 332a, this amplifies the movement of the first voice coil 332a as the first voice coil 332a moves.

In this example, another auxiliary magnetic element is additionally coupled to the second voice coil 332b. As such, the motor assembly further comprises an additional auxiliary magnetic element 364f arranged between the magnetic element 328 and the cover 334. The additional auxiliary magnetic element 364f is coupled to the second voice coil 332b such that movement of the second voice coil 332b causes the additional auxiliary magnetic element 364b to move. In particular, in this example, the additional auxiliary magnetic element 364f is affixed to the second voice coil support 326b. In other examples, the additional auxiliary magnetic element 364f is affixed to the second actuating element, such as the rib(s) 322. The additional auxiliary magnetic element 364f generates a magnetic field arranged relative to the magnetic field of the magnetic element 328, such that a magnetic flux density through the second voice coil 332b and cover 334 is increased.

In the same way as discussed above for the auxiliary magnetic element 364e, the additional auxiliary magnetic element 364f is offset from the second voice coil 332b along the radial direction, perpendicular to the direction of movement of the second voice coil 332b. Furthermore, the additional auxiliary magnetic element 364f is magnetized in a particular manner to add to the magnetic flux of the magnetic element 328 that is already passing through the second voice coil 332b in the radial direction. This may be achieved by arranging the additional auxiliary magnetic element 364f such that a magnetic axis 374 of the additional auxiliary magnetic element 364f is perpendicular to the direction of movement of the second voice coil 332b, and positioned such that a plane that is perpendicular to the longitudinal axis B intersects both the second voice coil 332b and the additional auxiliary magnetic element 364f. The magnetic axis 374 therefore passes through the second voice coil 332b.

For example, in FIG. 14 the arrow above the additional auxiliary magnetic element 364f shows the additional auxiliary magnetic element 364f being axially magnetized in a direction perpendicular to the direction of movement of the second voice coil 332b. The direction of the arrow, pointing from north to south, further shows that magnetic poles of the additional auxiliary magnetic element 364f point in substantially the same direction as the magnetic field lines of the magnetic element 328 that pass through the second voice coil 332b and into the magnetic element 328.

As discussed, this alignment of magnetic fields increases the magnetic flux density within the second voice coil 332b, and because the additional auxiliary magnetic element 364f moves with the second voice coil 332b, this amplifies the movement of the second voice coil 332b as the second voice coil 332b moves.

In the example of FIG. 14, the auxiliary magnetic elements 364e, 364f are ring shaped and extend around the magnetic element 328 and the voice coils 332a, 332b. In other examples, either or both auxiliary magnetic elements 364e, 364f are formed from a plurality of separate/discrete magnetic bodies. The plurality of separate magnetic bodies making up each auxiliary magnetic element may all lie in the same plane (the plane being perpendicular to the longitudinal axis B) or may be positioned at different positions along the longitudinal axis B.

In examples, one or more auxiliary magnetic elements of the type shown in FIG. 14 may be additionally included in the example motor arrangements of FIGS. 9 to 13.

Although the example covers depicted in FIGS. 9 to 11 include one or more openings formed along the cover to permit one or more members to extend therethrough, it will be appreciated that in alternative examples, the covers may not include such openings, or the covers may include such openings, but members do not extend through the openings.

### c. Motor Assemblies With at Least Two Magnetic Portions

As previously discussed, the present disclosure relates to a motor assembly for a transducer. One or more transducers may be incorporated into a playback device, a network microphone device or a control device, such as one of those devices discussed above in relation to FIGS. 1A-H.

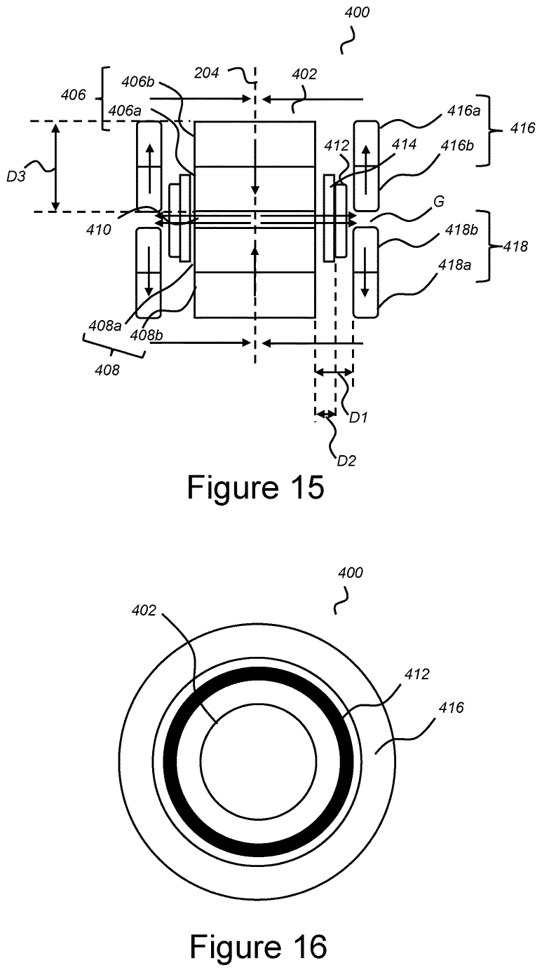

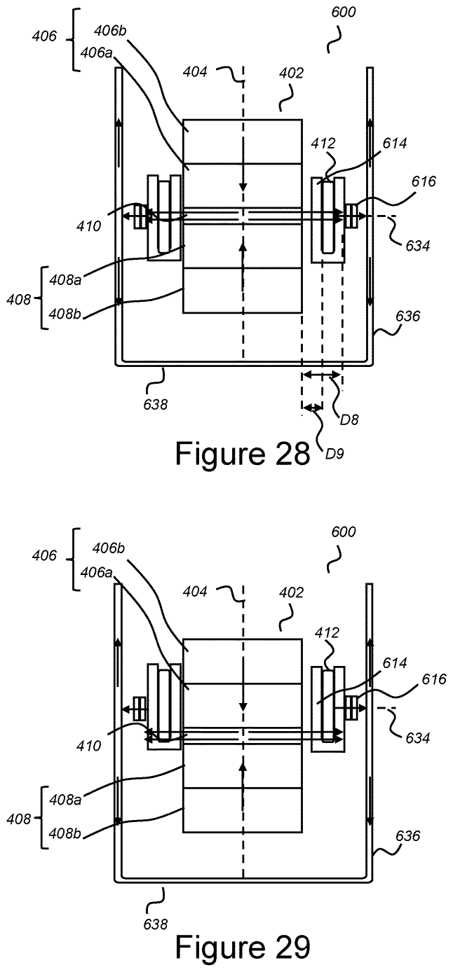

A first type of motor assembly is depicted in FIGS. 15 to 27. A second type of motor assembly is depicted in FIGS. 28 to 30. Both types of motor assembly share common features, including a magnetic element, at least one voice coil and at least one magnetic portion arranged relative to the, or each, voice coil. In particular, the first type of motor assembly comprises two magnetic portions extending at least partially around the magnetic element and the second type of motor assembly comprises one magnetic portion extending at least partially around the magnetic element (and voice coil). It will be appreciated that in some cases, further magnetic portions may be included where necessary. For example, the magnetic element of FIGS. 28 to 30 may be incorporated in the motor assembly of FIGS. 15 to 27.

FIG. 15 depicts a cross section of a motor assembly 400 of a transducer. FIG. 16 depicts a top-down view of the motor assembly 400 of FIG. 15. The motor assembly 400 may drive a membrane (not shown). The motor assembly 400 comprises a magnetic element 402 having a longitudinal axis 404. The magnetic element 402 of this example comprises a first magnetic portion 406 and a second magnetic portion 408 and a spacer element (pole piece) 410 arranged between the first and second magnetic portions 406, 408. Also depicted is a voice coil 412 that extends around the magnetic element 402. The spacer element 410 can help focus or concentrate the magnetic flux from the first and second magnetic portions 406, 408 (and therefore from the magnetic element 402) onto the voice coil 412. In some examples, the spacer element 410 is omitted.

In this example, the voice coil 412 is coupled to a voice coil support 414, which extends around the magnetic element 402. The voice coil support 414 (or the voice coil 412) may be coupled to an actuating element (not shown), which is in turn coupled to a membrane. The membrane, for example, may be arranged at one end of the magnetic element 402. Because the actuating element is coupled to the voice coil 412 via the voice coil support 414, movement of the voice coil 412 causes the actuating element to move, which then causes the membrane to move. In this way, movement can be transferred to the membrane to generate sound. In one example, the actuating element comprises one or more ribs or connector portions which are coupled to the membrane either directly or indirectly.

In further examples, a suspension element (also referred to as a spider, not shown) may couple the voice coil 412 to a support structure, such as a basket or frame of a playback device. For example, the suspension element may be connected to the voice coil support 414. As is well known, a spider helps keep a voice coil centered within a motor as the voice coil moves. Example suspension elements are described in WO 2024/073298 (PCT Patent Application No. PCT/US2023/074844), entitled “Suspension System for Loudspeaker”, and WO 2024/073566 (PCT Patent Application No. PCT/US2023/075366), entitled “Suspension System for Loudspeaker”, both of which are incorporated by reference for all purposes.

As shown in FIG. 15, the first magnetic portion 406 and the second magnetic portion 408 are magnetized having an inverted polarity (i.e., are magnetized in generally opposite directions to each other). Polarity is indicated diagrammatically by a hatched region for a south pole and a dotted region for a north pole. For example, a north pole 406a of the first magnetic portion 406 is arranged facing a north pole 408a of the second magnetic portion 408. A south pole 406b of the first magnetic portion 406 is arranged facing away from the second magnetic portion 408, and a south pole 408b of the second magnetic portion 408 is arranged facing away from the first magnetic portion 406. Accordingly, the first and second magnetic portions 406, 408 are generally axially magnetized in the opposite direction (as shown by the arrows). Opposite ends of the magnetic element 402 therefore have the same polarity. In some examples, rather than being axially magnetized along the longitudinal axis 414, the magnetization direction may bend through the magnetic element 402.

As illustrated, the voice coil 412 is arranged relative to the first and second magnetic portions 406, 408 (such as arranged at a midpoint between the first and second magnetic portions 406, 408), such that a magnetic field generated by the voice coil 412 interacts with magnetic fields of the first and second magnetic portions 406, 408. This causes the voice coil 412 (and therefore any components coupled to the voice coil 412) to move along the axis 404.

The voice coil 412 is shown extending around the magnetic element 428 in the region where the first and second magnetic portions 406, 408 have opposing polarity. FIG. 15 shows the voice coil 412 in a rest position (having no displacement or excursion along the axis 404).

As a result of the opposing magnetic fields of the first and second magnetic portions 406, 408, the magnetic field lines bend away from being parallel to the longitudinal axis 404 and become perpendicular to the longitudinal axis 404 as the magnetic field passes through the spacer element 410 and voice coil 412 (again shown by the arrows). The magnetic fields of the first and second magnetic portions 406, 408 therefore point in the same direction as they pass through a particular part of the voice coil 412.

The example motor assembly 400 also includes a third magnetic portion 416 and a fourth magnetic portion 418. The third and fourth magnetic portions 416, 418 both extend at least partially around the magnetic element 402. The third and fourth magnetic portions 416, 418 remain stationary relative to the magnetic element 402 as the voice coil 412 moves. In this particular example, and as seen in FIG. 16, the third and fourth magnetic portions 416, 418 both extend fully around the magnetic element 402. In other cases, the “ring shape” of each of the third and fourth magnetic portions 416, 418 may be comprised of two or more separate elements that together make up the third and fourth magnetic portions 416, 418. For example, gaps may extend between each of the separate elements that are distributed around the magnetic element 402. In other words, the “ring shape” may be discontinuous.

As shown in FIG. 15, the third magnetic portion 416 and the fourth magnetic portion 418 are magnetized having an inverted polarity. For example, a south pole 416b of the third magnetic portion 416 is arranged facing a south pole 418b of the fourth magnetic portion 418. A north pole 416a of the third magnetic portion 416 is arranged facing away from the fourth magnetic portion 418, and a north pole 418a of the fourth magnetic portion 418 is arranged facing away from the third magnetic portion 416. Accordingly, the third and fourth magnetic portions 416, 418 are generally axially magnetized in the opposite direction to each other (as shown by the arrows). In some examples, rather than being axially magnetized along the longitudinal axis 404, the magnetization direction may bend through the third and fourth magnetic portions 416, 418 or may be angled with respect to the longitudinal axis 404. As a result of the opposing magnetic fields of the third and fourth magnetic portions 416, 418, the magnetic field lines bend away from being parallel to the longitudinal axis 404 and become perpendicular to the longitudinal axis 404 as the magnetic field passes through the voice coil 412 (again shown by the arrows).

As is further shown in FIG. 15, the third magnetic portion 416 is magnetized in the opposite direction to the first magnetic portion 406 and the fourth magnetic portion 418 is magnetized in the opposite direction to the second magnetic portion 08. Thus, the third and fourth magnetic portions 416, 418 are magnetically oriented in a particular way with respect to the magnetic fields of the first and second magnetic portions 406, 408. Given the magnetic orientation of the first, second, third and fourth magnetic portions 406, 408, 416, 418, the magnetic fields of the first, second, third and fourth magnetic portions 406, 408, 416, 418 therefore point in the same direction as they pass through the voice coil 412 (in particular, in a direction that is perpendicular to the longitudinal axis 404). A magnetic circuit is therefore formed through the magnetic element 402, voice coil 412 and third and fourth magnetic portions 416, 418. As mentioned above, the inclusion of the third and fourth magnetic portions 416, 418 increase the magnetic flux through the voice coil 412, thereby increasing the BL value for the same overall volume of magnetic material in the motor assembly 400. It will be understood that reversing the polarities of each of the first, second, third and fourth magnetic portions 406, 408, 416, 418 from that shown in FIG. 15 would reverse the direction of the arrows.

As is also shown in FIG. 15, the third and fourth magnetic portions 416, 418 are both spaced apart further from the longitudinal axis 404 than the voice coil 412. For example, the third and fourth magnetic portions 416, 418 are spaced from the longitudinal axis 404 by a distance D1, and the voice coil 412 is spaced from the longitudinal axis 404 by a distance D2, where D1 is greater than D2.

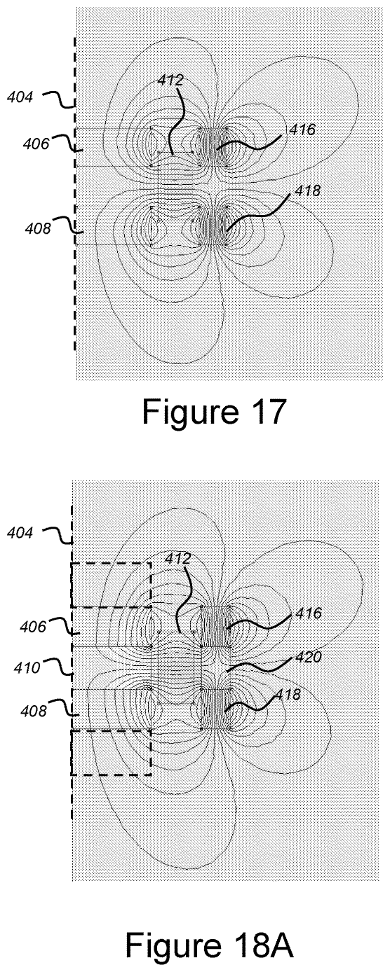

FIG. 17 depicts a plot of the magnetic flux at various points around part of the motor assembly 400 of FIG. 15 (although the spacer element 410 is omitted in this modelled example).

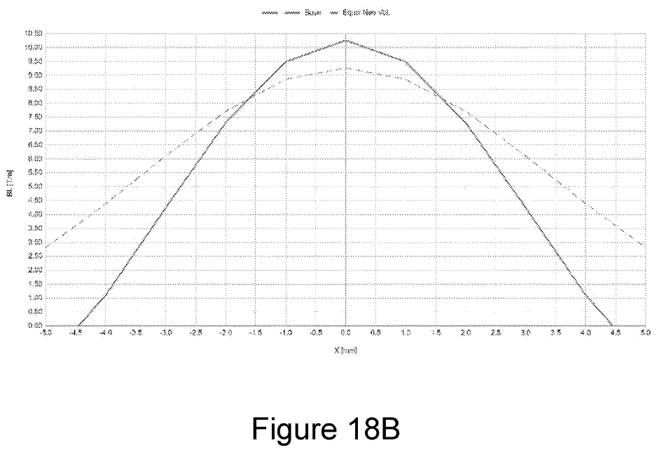

Plots of magnetic flux using other constructions are depicted in FIGS. 18A, 19, 20, 21A, 22, 23, 24, 25 and 26. Throughout FIGS. 17, 18A, 19, 20, 21A, 22, 23, 23, 25 and 26 the same reference number is used for the corresponding elements in each construction.

As a result of the magnetic fields of the third and fourth magnetic portions 416, 418, the magnetic flux passing through the voice coil 412 in a direction perpendicular to the longitudinal axis 404 is increased compared to a motor assembly without the third and fourth magnetic portions 416, 418 for the same overall volume of magnetized material (in this case neodymium) in the motor assembly. This has the effect of increasing the maximum BL value of the motor assembly compared to a motor assembly without the third and fourth magnetic portions 416, 418.

In some examples, such as those shown in FIGS. 15 and 17, the first, second, third and fourth magnetic portions may all have at least one of: (i) the same depth dimension, where the depth dimension is measured parallel to the longitudinal axis 404, or (ii) the same volume. For example, in FIG. 15, the first and third magnetic portions 406, 416 both have the same depth dimension D3. In the same way, the second and fourth magnetic portions 408, 418 also have the same depth dimension as each other, and the first and third magnetic portions 406, 416. Although more difficult to gauge given the cross-sectional view, in this example, the total volume of magnetized material in the first magnetic portion 406 is the same as the total volume of magnetized material in the third magnetic portion 416. Similarly, the total volume of magnetized material in the second magnetic portion 408 is the same as the total volume of magnetized material in the fourth magnetic portion 418, and also the same as the total volumes in each of the first and third magnetic portions. Furthermore, when the voice coil 412 is in a rest position (as in FIGS. 15 and 17), the first and third magnetic portions 406, 416 are at a same position along the longitudinal axis 404, and the second and fourth magnetic portions 408, 418 are at a same position along the longitudinal axis 404. As mentioned, this configuration provides a more balanced arrangement of magnetic fields.

FIG. 15 depicts a gap G between the third and fourth magnetic portions 416, 418. In other examples, however, a further spacer element (pole piece) may be arranged between the third and fourth magnetic portions 416, 418 to at least partially fill the gap. The presence of such a spacer element can help focus the magnetic fields of the third and fourth magnetic portions 416, 418 onto the voice coil 412.

To illustrate, FIG. 18A depicts another plot of the magnetic flux at various points around part of a motor assembly. As shown in FIG. 18A, the spacer element 410 is present between the first and second magnetic portions 406, 408, and a further spacer element 420 is arranged between the third and fourth magnetic portions 416, 418. In this example, the spacer element abuts both the third and fourth magnetic portions 416, 418. The further spacer element 420 comprises magnetic material, such as 1010 carbon steel.

As a result of the further spacer element 420, the magnetic flux passing through the voice coil 412 in a direction perpendicular to the longitudinal axis 404 is increased compared to the plot of FIG. 17. In this particular case, the integral of the magnetic field in a direction perpendicular to the longitudinal axis 404 over the voice coil 412 is increased by 20% compared to the plot of FIG. 17.

FIG. 18B depicts a plot of the BL value against excursion distance, X, for a voice coil. In particular, the solid line depicts the BL value of the motor assembly of FIG. 18A, and the dashed line depicts the BL value of a motor assembly without the third and fourth magnetic portions 416, 418 and without the spacer element 420 (referred to as the “base” motor assembly). As shown, the maximum BL value of the motor assembly of FIG. 18A is increased compared to that of the base motor assembly. Linearity is decreased compared to that of the base motor assembly. Linearity may be measured in terms of “xBL”, which is the distance over which the BL reduces from the maximum to a predetermined value. For example, xBL may be measured for 82% of the peak, for an acceptable approximately linear response. In the example of FIG. 18B, the 82% xBL for the base case is about 4 mm, while it is about 3 mm for the assembly of FIG. 18A. Considering typical excursion distances for loudspeakers, the xBL of 3 mm may be acceptable for the increase BL.

In both examples, the total volume of magnetized material (in this case neodymium) in the motor assembly is the same. In particular, the volume of magnetized material in the base motor assembly is the combined volume of magnetized material in the first and second magnetic portions and the volume of magnetized material in the motor assembly of FIG. 18A is the combined volume of magnetized material in the first, second, third and fourth magnetic portions. As such, in the base motor assembly, the first and second magnetic portions are larger than the first and second magnetic portions in the motor assembly of FIG. 18A. Dashed lines in FIG. 18A show how the volume of the first and second magnetic portions in a base motor assembly may be larger than in the example motor assembly of FIG. 18A. Accordingly, including the third and fourth magnetic portions 416, 418 can also allow the height extent of the motor assembly to be reduced, whilst also increasing the maximum BL value.

In some example motor assemblies, the magnetic fields may further be contained within one or more end pieces which encapsulate magnetic field lines that extend between the first and third magnetic portions 406, 416 and/or magnetic field lines that extend between the second and fourth magnetic portions 408, 418.

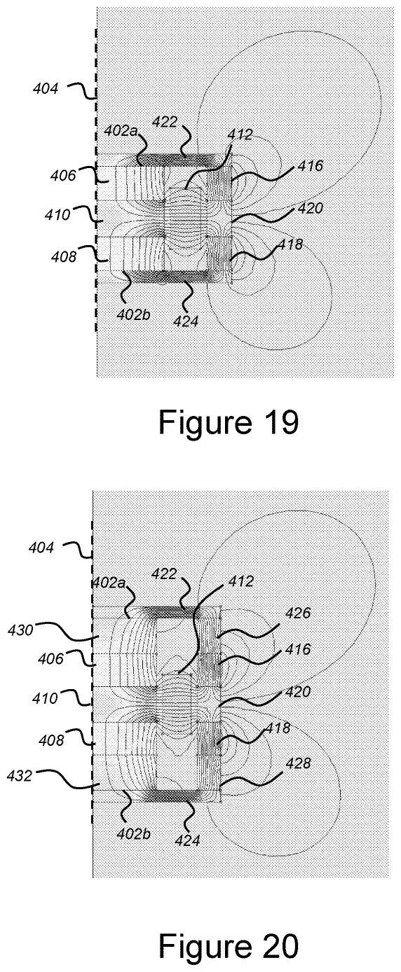

To illustrate, FIG. 19 depicts another plot of the magnetic flux at various points around part of a motor assembly. As shown in FIG. 19, the motor assembly further comprises a first end piece 422 arranged at a first end 402a (in this case the top end) of the magnetic element 402, and a second end piece 424 arranged at a second end 402b (in this case the bottom end) of the magnetic element 402. As shown, the first end piece 422 extends at least partially between the first magnetic portion 406 and the third magnetic portion 416. Similarly, the second end piece 424 extends at least partially between the second magnetic portion 408 and the fourth magnetic portion 418. The first and second end pieces 422, 424 may be disk or plate shaped, for example, to fully or partially cover the ends of the magnetic element 402.

The first and second end pieces 422, 424 each comprise magnetic material (such as 1010 carbon steel). FIG. 19 shows the magnetic fields of the first and third magnetic portions concentrated within the first end piece 422 and the magnetic fields of the second and fourth magnetic portions concentrated within the second end piece 424. The first and second end pieces 422, 424 and the central spacer element 420 may be said to form a cover that at least partially encloses the magnetic element 402. The third and fourth magnetic portions 416, 418 may also form part of that cover.

As a result of the end pieces 422, 424, the magnetic flux passing through the voice coil 412 in a direction perpendicular to the longitudinal axis 404 is increased compared to the plot of FIG. 17. In this particular case, the integral of the magnetic field in a direction perpendicular to the longitudinal axis 404 over the voice coil 412 is increased by 74% compared to the plot of FIG. 17.

In some examples, the motor assembly further comprises a further spacer element positioned between the third magnetic portion 416 and the first end piece 422. The further spacer element provides a greater separation between the third magnetic portion 416 and the first end piece 422.

To illustrate, FIG. 20 depicts another plot of the magnetic flux at various points around part of a motor assembly. As shown in FIG. 20, the motor assembly further comprises a first spacer element 426 positioned between the third magnetic portion 416 and the first end piece 422. In this example, a second spacer element 428 is also positioned between the fourth magnetic portion 418 and the second end piece 424. The first and second spacer elements 426, 428 are arranged at or towards outer edges of the first and second end pieces 422, 424.

In some cases, another spacer element 430 is positioned adjacent the first magnetic portion 406 (and therefore forms part of the magnetic element 402), between the first magnetic portion 406 and the first end piece 422. Similarly, another further spacer element 432 is positioned adjacent the second magnetic portion 408 (and therefore forms part of the magnetic element 402), between the second magnetic portion 408 and the second end piece 424.

One, or both, spacer elements 426, 430 may form part of the first end piece 422, and one, or both, spacer elements 428, 432 may form part of the second end piece 424, or they may be separate to the end pieces 422, 424. The first and second end pieces 422, 424 and the spacer elements 420, 426, 428 may be said to form a cover that at least partially encloses the magnetic element 402. The third and fourth magnetic portions 416, 418 may also form part of that cover. The spacer elements 430, 432 may also form part of the cover.

In this example, the spacer elements 426, 428, 430, 432 all comprise magnetic material, such as 1010 carbon steel.

FIG. 20 shows the magnetic fields of the first and third magnetic portions concentrated within the spacer elements 430, 426 and the magnetic fields of the second and fourth magnetic portions concentrated within the spacer elements 432, 428.

As a result of the end pieces 422, 424 and spacer elements 420, 426, 428, 430, 432, the magnetic flux passing through the voice coil 412 in a direction perpendicular to the longitudinal axis 404 is increased compared to the plot of FIG. 17. In this particular case, the integral of the magnetic field in a direction perpendicular to the longitudinal axis 404 over the voice coil 412 is increased by 76% compared to the plot of FIG. 17.

The depth dimensions of the end pieces 422, 424 may be chosen to avoid saturation of the magnetic fields within the end pieces 422, 424. This again may increase the integral of the magnetic field in a direction perpendicular to the longitudinal axis 404 over the voice coil 412. In some cases, the end pieces 422, 424 have a greater depth dimension closer to the longitudinal axis 404 than at an outer edge of the end pieces, the outer edge being spaced apart from the longitudinal axis 404.

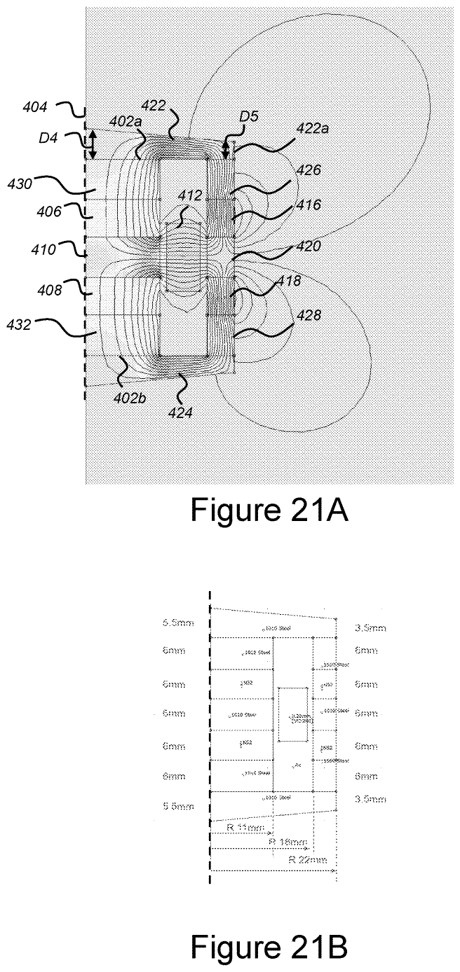

To illustrate, FIG. 21A depicts another plot of the magnetic flux at various points around part of a motor assembly. As shown in FIG. 21A, the first end piece 422 has a first depth dimension D4, measured parallel to the longitudinal axis, at or close to the longitudinal axis 404 and a second depth dimension D5 at or close to the outer edge 422a of the first end piece 422, where the first depth dimension D4 is greater than the second depth dimension D5. The second end piece 424 may have a similar form. FIG. 21B depicts example dimensions and materials of each of the components shown in FIG. 21A. For example, the depth dimension D4 is 5.5 mm and the depth dimension D5 is 3.5 mm in this example. As shown, the magnetic element 202 of this example has a diameter of 22 mm. Corresponding components depicted in the other Figures may have the same dimensions as those shown in FIG. 21A.

As a result of the end pieces 422, 424 being thicker towards the longitudinal axis 404, the magnetic flux passing through the voice coil 412 in a direction perpendicular to the longitudinal axis 404 is increased compared to the plot of FIG. 17. In this particular case, the integral of the magnetic field in a direction perpendicular to the longitudinal axis 404 over the voice coil 412 is increased by 80% compared to the plot of FIG. 17.

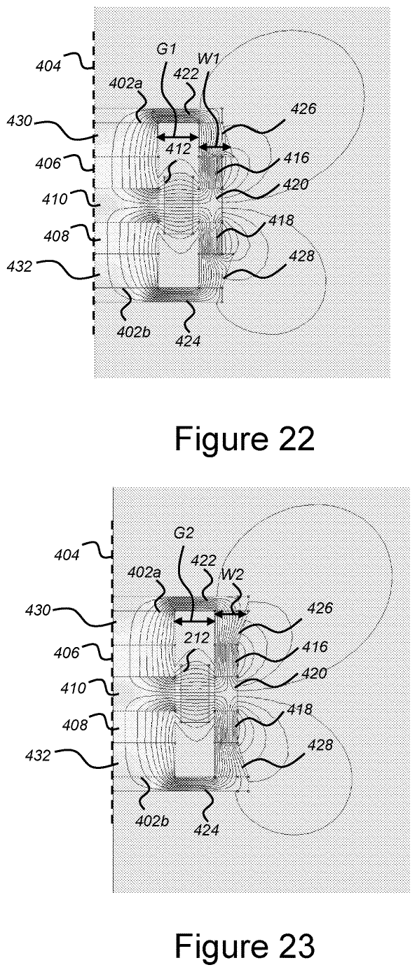

FIGS. 22, 23 and 24 depict example motor assemblies where the spacer elements 426, 428 have cross-sectional widths that vary along a direction parallel to the longitudinal axis 404.

The example motor assembly depicted in FIG. 22 is a modification of the motor assembly of FIG. 20, where the end pieces 422, 424 have a uniform thickness. As shown in FIG. 22, the spacer elements 426, 428 arranged at the outer edges of the end pieces 422, 424 have a cross-sectional width W1 that is narrower towards the end pieces 422, 424 and wider towards the third and fourth magnetic portions 416, 418, while leaving a uniform gap spacing G1 between the magnetic element 402 and the spacer elements 426, 428. In this particular example, at their widest point, the spacer elements 426, 428 are wider than the greatest cross-sectional widths of the third and fourth magnetic portions 416, 418 and at their thinnest point, the spacer elements 426, 428 have the same cross-sectional width as the third and fourth magnetic portions 426, 428. As a result of this construction, the magnetic flux passing through the voice coil 412 in a direction perpendicular to the longitudinal axis 404 is slightly decreased compared to the example of FIG. 20. In this particular case, the integral of the magnetic field in a direction perpendicular to the longitudinal axis 404 over the voice coil 412 is increased by 74% compared to the plot of FIG. 17.

However, as shown in FIG. 22, the magnetic flux may be more concentrated in a region outside of the motor assembly.

The example motor assembly depicted in FIG. 23 is another modification of the motor assembly of FIG. 20, where the end pieces 422, 424 have a uniform thickness. As shown in FIG. 23, the spacer elements 426, 428 arranged at the outer edges of the end pieces 422, 424 have a cross-sectional width W2 that is wider towards the end pieces 422, 424 and narrower towards the third and fourth magnetic portions 416, 418, while leaving a uniform gap spacing G2 between the magnetic element 402 and the spacer elements 426, 428. In this particular example, at their widest point, the spacer elements 426, 428 are wider than the greatest cross-sectional widths of the third and fourth magnetic portions 416, 418 and at their thinnest point, the spacer elements 426, 428 have the same cross-sectional width as the third and fourth magnetic portions 426, 428. As a result of this construction, the magnetic flux passing through the voice coil 412 in a direction perpendicular to the longitudinal axis 404 is again slightly decreased compared to the example of FIG. 20. In this particular case, the integral of the magnetic field in a direction perpendicular to the longitudinal axis 404 over the voice coil 412 is increased by 75% compared to the plot of FIG. 17.

However, as shown in FIG. 23, the magnetic flux may be more concentrated in a region outside of the motor assembly.

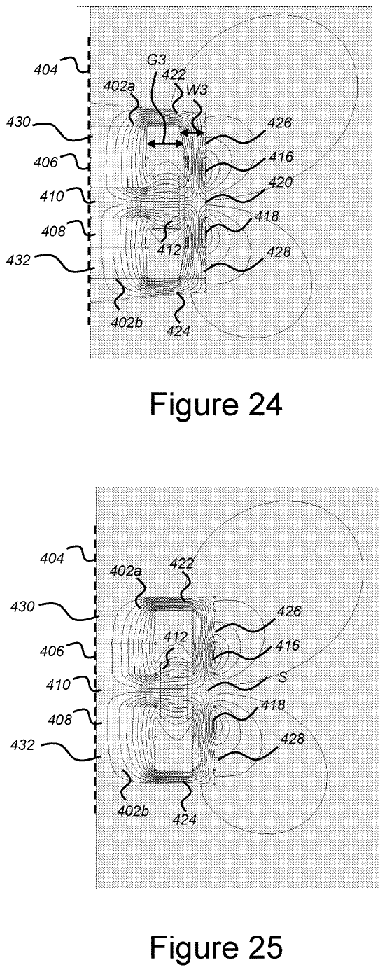

The example motor assembly depicted in FIG. 24 is a modification of the motor assembly of FIG. 21A, where the end pieces 422, 424 have a non-uniform thickness. As shown in FIG. 24, the spacer elements 426, 428 arranged at the outer edges of the end pieces 422, 424 have a cross-sectional width W3 that is wider towards the end pieces 422, 424 and narrower towards the third and fourth magnetic portions 416, 418. As shown, the spacer elements 426, 428 increase in cross-sectional width in a direction towards the magnetic element 402, such that a non-uniform gap spacing G3 extends between the magnetic element 402 and the spacer elements 426, 428. In this particular example, at their widest point, the spacer elements 426, 428 are wider than the greatest cross-sectional widths of the third and fourth magnetic portions 416, 418 and at their thinnest point, the spacer elements 426, 428 have the same cross-sectional width as the third and fourth magnetic portions 426, 428. As a result of this construction, the magnetic flux passing through the voice coil 412 in a direction perpendicular to the longitudinal axis 404 remains substantially the same as that in the example of FIG. 21A. In this particular case, the integral of the magnetic field in a direction perpendicular to the longitudinal axis 404 over the voice coil 412 is increased by 80% compared to the plot of FIG. 17.

In some cases, the central spacer element 420 arranged between the third and fourth magnetic portions 416, 418 may be omitted to provide thermal benefits and/or to allow an element, such as part of a spider, to extend through the gap extending between the third and fourth magnetic portions 416, 418.

To illustrate, FIG. 25 depicts another plot of the magnetic flux at various points around part of a motor assembly. The example motor assembly is a modification of the motor assembly of FIG. 20, where the end pieces 422, 424 have a uniform thickness. As shown in FIG. 25, the central spacer element 420 arranged between the third and fourth magnetic portions 416, 418 is omitted to leave a gap S between the third and fourth magnetic portions 416, 418. The third and fourth magnetic portions 416, 418 are therefore spaced apart from each other in a direction parallel to the longitudinal axis 404 and the gap S extends between the third and fourth magnetic portions 416, 418. In some cases, one or more gaps may exist only at various azimuthal positions around the magnetic element, and in places where there is no gap, one or more spacer elements 420 may be positioned.

In some examples, the gap may extend only partially between the third and fourth magnetic portions 416, 418. For example, the central spacer element 420 may be arranged between the third and fourth magnetic portions 416, 418, but the spacer element 420 may delimit an opening, such as a slit, that extends at least partially along the spacer element 420 in a direction parallel to the longitudinal axis 404. One or more openings may be distributed around the spacer element 420 at various points around the magnetic element.

As a result of this construction, the magnetic flux passing through the voice coil 412 in a direction perpendicular to the longitudinal axis 404 is slightly decreased compared to the example of FIG. 20. However, as mentioned, the gap may be useful for other purposes.

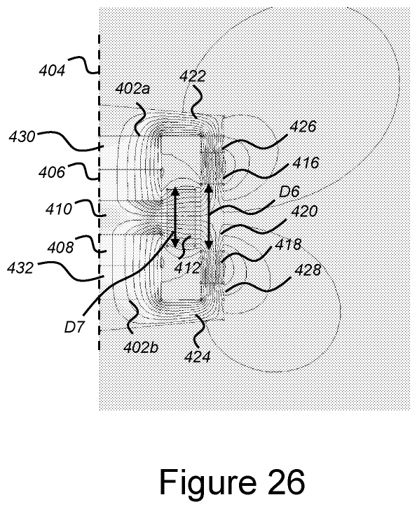

In all of the examples of FIGS. 15 to 25, the central spacer element 420 has a depth, measured parallel to the longitudinal axis 404 that is less than the depth of the voice coil 412. Accordingly, in those examples, part of the voice coil 412, the first magnetic portion 406 and the third magnetic portion 416 overlap along the longitudinal axis 404, and part of the voice coil 412, the second magnetic portion 408 and the fourth magnetic portion 418 overlap along the longitudinal axis 404. FIG. 26 depicts an example where the central spacer element 420 has a depth D6 that is greater than a depth D7 of the voice coil 412. This configuration means that the voice coil 412, the first magnetic portion 406 and the third magnetic portion 416 no longer overlap along the longitudinal axis 404, and the voice coil 412, the second magnetic portion 408 and the fourth magnetic portion 418 no longer overlap along the longitudinal axis 404. The example motor assembly in FIG. 26 is a modification of the motor assembly of FIG. 21A, where the end pieces 422, 424 have a non-uniform thickness.

As a result of this increased separation distance between the third and fourth magnetic portions 416, 418, the magnetic flux passing through the voice coil 412 in a direction perpendicular to the longitudinal axis 404 is slightly decreased compared to the example of FIG. 21A. Although not illustrated, it has been found that decreasing the separation distance between the third and fourth magnetic portions 416, 418 too much can also decrease the magnetic flux passing through the voice coil 412 in a direction perpendicular to the longitudinal axis 404. The separation distance may therefore be selected/optimized as desired.

In the above examples, the third and fourth magnetic portions are all shown to have a depth measured along the longitudinal axis that is the same as the first and second magnetic portions. It will be appreciated that in some examples that is not always the case. For example, the third and fourth magnetic portions may have depths that are less than the depths of the first and second magnetic portions. In one particular case, the third and fourth magnetic portions may be arranged so that midpoints of the third and fourth magnetic portions are aligned with midpoints of the first and second magnetic portions, respectively. This can increase the linearity of the voice coil across the excursion range.

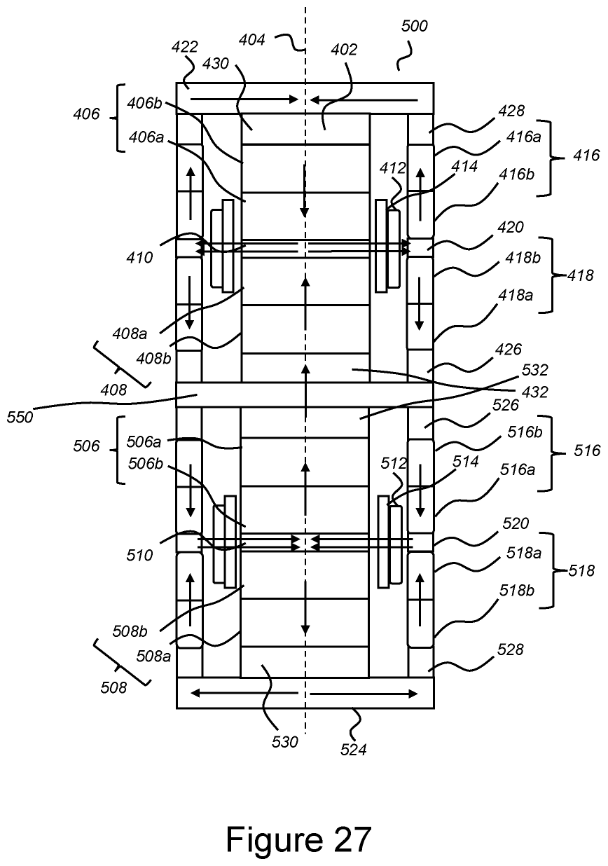

In some examples, a second voice coil may also extend around the magnetic element. In such cases, the components described above may be replicated for the second voice coil. To illustrate, FIG. 27 depicts a cross section of a motor assembly 500 of a transducer. The same reference numbers are used in FIG. 27 for components shared with FIG. 15, and the voice coil 412 will herein be referred to as the first voice coil 412. As shown in FIG. 27, the motor assembly 500 further comprises a second voice coil 512. The first voice coil 412 may drive a first membrane (not shown) arranged at a first end of the magnetic element 402, and the second voice coil 512 may drive a second membrane (not shown) arranged at a second end of the magnetic element.

The second voice coil 512 extends around an extended magnetic element 402, and is offset along the magnetic element 402 from the first voice coil 412. The magnetic element 402 therefore further comprises a fifth magnetic portion 506 and a sixth magnetic portion 508 and a spacer element (pole piece) 510 arranged between the fifth and sixth magnetic portions 506, 508. The second magnetic portion 508 is arranged between the first magnetic portion 506 and the fifth magnetic portion 506. The fifth magnetic portion 506 is arranged between the second magnetic portion 508 and the sixth magnetic portion 508.

The assembly further comprises a second voice coil support 514 for the second voice coil 512.

As shown in FIG. 27, the fifth magnetic portion 506 and the sixth magnetic portion 508 are magnetized having an inverted polarity (i.e., are magnetized in generally opposite directions to each other). For example, a south pole 506b of the fifth magnetic portion 506 is arranged facing a south pole 508b of the sixth magnetic portion 508. A north pole 506a of the fifth magnetic portion 506 is arranged facing away from the sixth magnetic portion 508, and a north pole 508a of the sixth magnetic portion 508 is arranged facing away from the fifth magnetic portion 506. The second and fifth magnetic portions 508, 506 are magnetized in the same direction, such that the north pole 506a of the fifth magnetic portion 506 faces towards the south pole 308b of the second magnetic portion 508. The fifth and sixth magnetic portions 506, 508 therefore have an inverted polarity compared to the first and second magnetic portions 406, 408.

FIG. 27 also shows a midpiece 550 extending through the magnetic element 402 and between the two voice coils 412, 512. In this example, the midpiece 550 comprises the same material as the spacer elements mentioned above, such as 1010 carbon steel.

FIG. 27 also depicts first and second end pieces 422, 424. In this example, the second end piece 424 now extends at least partially between the sixth magnetic portion 508 and the eighth magnetic portion 518.

In the same way as described above, two further magnetic portions may be arranged relative to the second voice coil 512 to provide the same advantages discussed earlier. In particular, the example motor assembly 500 also includes a seventh magnetic portion 516 and an eighth magnetic portion 518. The seventh and eighth magnetic portions 516, 518 both extend at least partially around the magnetic element 402. The seventh and eighth magnetic portions 516, 518 remain stationary relative to the magnetic element 502 as the second voice coil 512 moves.

As shown in FIG. 27, the seventh magnetic portion 516 and the eighth magnetic portion 508 are magnetized having an inverted polarity. For example, a north pole 516a of the seventh magnetic portion 516 is arranged facing a north pole 518a of the eighth magnetic portion 518. A south pole 516b of the seventh magnetic portion 516 is arranged facing away from the eighth magnetic portion 518, and a south pole 518b of the eighth magnetic portion 518 is arranged facing away from the seventh magnetic portion 516. Accordingly, the seventh and eighth magnetic portions 516, 518 are generally axially magnetized in the opposite direction to each other (as shown by the arrows).

As is further shown in FIG. 27, the seventh magnetic portion 516 is magnetized in the opposite direction to the fifth magnetic portion 506 and the eighth magnetic portion 518 is magnetized in the opposite direction to the sixth magnetic portion 508. Given the magnetic orientation of the fifth, sixth, seventh and eighth magnetic portions 506, 508, 516, 518, the magnetic fields of the fifth, sixth, seventh and eighth magnetic portions 506, 508, 516, 518 therefore point in the same direction as they pass through the second voice coil 512 (in particular, in a direction that is perpendicular to the longitudinal axis 404). The magnetic fields also point in the opposite direction through the second voice coil 512 as they do the first voice coil 412. The magnetic fields therefore form a magnetic circuit through the magnetic element 402, and both voice coils 412, 512.

It will be understood that any of the modifications discussed above in relation to the motor assembly 400 and components thereof, can also be applied to the motor assembly 500 of FIG. 27.

As in the above-described examples, various spacer elements may be incorporated into the motor assembly 500. For example, depending upon the design configurations, the assembly 500 may comprise any or all of: a spacer element 420 positioned between the third and fourth magnetic portions 416, 418, a spacer element 520 positioned between the seventh and eighth magnetic portions 516, 518, a spacer element 428 positioned between the third magnetic portion 416 and the first end piece 422, a spacer element 528 positioned between the eighth magnetic portion 518 and the second end piece 524, a spacer element 426 positioned between the fourth magnetic portion 418 and the midpiece 550, a spacer element 526 positioned between the seventh magnetic portion 516 and the midpiece 550, a spacer element 430 positioned between the first magnetic portion 406 and the first end piece 422, a spacer element 530 positioned between the sixth magnetic portion 508 and the second end piece 424, a spacer element 432 positioned between the second magnetic portion 408 and the midpiece 550, and a spacer element 532 positioned between the fifth magnetic portion 506 and the midpiece 550.

### d. Motor Assemblies With At Least One Magnetic Portion

As mentioned, a second type of motor assembly is depicted in FIGS. 28 to 30, where there is at least one (such as a single) magnetic portion arranged relative to the voice coil(s). Accordingly, FIG. 28 depicts a cross section of another motor assembly 600 of a transducer. In FIG. 28, the voice coil 412 is in a rest position. FIG. 29 depicts the motor assembly 600 where the voice coil is displaced from the rest position by an excursion distance. The motor assembly has several similarities with the example motor assemblies described above. Accordingly, the same reference numbers mentioned above are used for the components in FIGS. 28 and 29 which are shared with FIG. 15, and will not be described in detail again.

Unlike the above-described examples, this example motor assembly 600 comprises a third magnetic portion 616 extending at least partially around the magnetic element 402 and the voice coil 412. The third magnetic portion 616 has a magnetic axis 634 arranged substantially perpendicular to the longitudinal axis 404, and oriented such that a magnetic field of the third magnetic portion 616 is in generally the same direction through the voice coil 412 as the magnetic fields of the first and second magnetic portions 406, 408.

The third magnetic portion 616 extends at least partially around the magnetic element 402 and voice coil 412. In this particular example, the third magnetic portion 616 extends fully around the magnetic element 402. In other cases, the third magnetic portions 616 may be comprised of two or more separate elements that together make up the third magnetic portion 616. For example, gaps may extend between each of the separate elements that are distributed around the magnetic element 402.

As shown in FIG. 28, the third magnetic portion 616 is magnetized in a direction perpendicular to the longitudinal axis 404, and in this rest position, the magnetic field is orientated such that a south pole of the third magnetic portion 616 is arranged facing north poles 406a, 408a of the first and second magnetic portions 406, 408. Thus, the third magnetic portion 616 is magnetically oriented in a particular way with respect to the magnetic fields of the first and second magnetic portions 406, 408. Given the magnetic orientation of the first, second and third magnetic portions 406, 408, 616, the magnetic fields of the first, second and third magnetic portions 406, 408, 616 therefore point in the same direction as they pass through the voice coil 412 (in particular, in a direction that is perpendicular to the longitudinal axis 404). The magnetic fields therefore form a magnetic circuit through the magnetic element 402, voice coil 412 and third magnetic portion 616. It will be understood that reversing the polarities of each of the first, second and third magnetic portions 406, 408, 616 from that shown in FIG. 28 would reverse the direction of the arrows.

As mentioned above, the inclusion of the third magnetic portion 616 increases the magnetic flux through the voice coil 412, thereby increasing the BL value of the motor assembly 600. In a particular example the maximum BL value increases to 9.74 Tm from 9.27 Tm by including the third magnetic portion 616 and maintaining the same overall volume of magnetized material (in this case neodymium) in the motor assembly.

As is also shown in FIG. 28, the third magnetic portion 616 is spaced apart further from the longitudinal axis 404 than the voice coil 412. For example, the third magnetic portion 616 is spaced from the longitudinal axis 404 by a distance D8, and the voice coil 412 is spaced from the longitudinal axis 404 by a distance D9, where D8 is greater than D9.

The motor assembly of this example also comprises a cover 636 which at least partially extends around the magnetic element 402, voice coil 412 and third magnetic portion 616. The cover of this example includes an end piece 638 at one end of the magnetic element 402. In examples, the end piece 638 may be omitted, so that the cover is open at the end. In a further example, a second end piece (not shown) is arranged at the opposite end of the magnetic element 402 and cover 636. The cover and end piece(s) comprise magnetic material (such as 1010 carbon steel). As shown, the magnetic fields of the first, second and third magnetic portions 406, 408, 616 are concentrated within the cover 636 and end piece 638, thereby providing a low reluctance return path. The cover and optional end piece(s) can therefore increase the magnetic flux through the voice coil 412, thereby increasing the BL value of the motor assembly 600. As discussed in examples above, the end piece(s) may have a uniform thickness, as shown in FIG. 28, or may have a non-uniform thickness. The cover may be omitted in some examples.

In further examples, a spacer element (not shown) may be arranged between the end piece 638 and second magnetic portion 408. Similarly, in examples comprising a second end piece, a further spacer element may be arranged between the second end piece and first magnetic portion 406.

In this example, the third magnetic portion 616 is coupled to the voice coil 412 such that movement of the voice coil 412 causes the third magnetic portion 616 to move. In particular, in this example, the third magnetic portion 616 is affixed to the voice coil support 614, which takes a slightly different form to that depicted in earlier examples. In other examples, the third magnetic portion 616 is affixed to an actuating element. FIG. 29 therefore shows that when the voice coil 412 is displaced from its rest position, the third magnetic portion 616 moves with the voice coil 412. As mentioned, the third magnetic portion 616 being coupled to the voice coil 412, provides a magnetic assist or boost that effectively overcomes inherent stiffnesses in the system.

In other examples, the third magnetic portion 616 does not move with the voice coil 412. For example, the third magnetic portion 616 may form part of the cover 636.

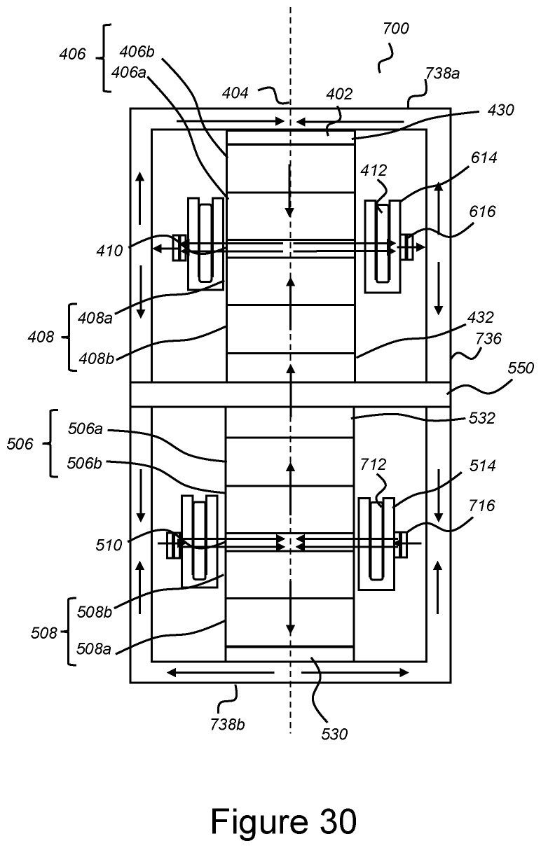

In some examples, a second voice coil may also extend around the magnetic element. In such cases, the components described in FIGS. 28 and 29 may be replicated for the second voice coil. To illustrate, FIG. 30 depicts a cross section of a motor assembly 700 of a transducer. The same reference numbers mentioned above are used for the same components in FIG. 28, and the voice coil 412 will herein be referred to as the first voice coil 412. As shown in FIG. 30, the motor assembly 700 further comprises a second voice coil 512. The first voice coil 412 may drive a first membrane (not shown) arranged at a first end of the magnetic element 402, and the second voice coil 512 may drive a second membrane (not shown) arranged at a second end of the magnetic element.

As in FIG. 30, the second voice coil 712 extends around an extended magnetic element 402, and is offset along the magnetic element 402 from the first voice coil 412. The magnetic element 402 therefore further comprises a fifth magnetic portion 506 and a sixth magnetic portion 508 and a spacer element (pole piece) 510 arranged between the fifth and sixth magnetic portions 506, 508.

The assembly further comprises a second voice coil support 514 for the second voice coil 512.

As shown in FIG. 30, the fifth magnetic portion 506 and the sixth magnetic portion 508 are magnetized having an inverted polarity (i.e., are magnetized in generally opposite directions to each other).

FIG. 30 also shows a midpiece 550 extending through the magnetic element 402 and between the two voice coils 412, 512.

In the same way as described above, a further magnetic portion may be arranged relative to the second voice coil 512 to provide the same advantages discussed earlier. In particular, the example motor assembly 500 also includes a fourth magnetic portion 716 extending at least partially around the magnetic element 402 and the second voice coil 512. The fourth magnetic portion 716 is also coupled to the second voice coil 512, and moves with the second voice coil 512.

As shown in FIG. 30, the fourth magnetic portion 716 is magnetized in a direction perpendicular to the longitudinal axis 404, and in this rest position, the magnetic field is orientated such that a north pole of the fourth magnetic portion 716 is arranged facing south poles 506b, 508b of the fifth and sixth magnetic portions 506, 508. Given the magnetic orientation of the fourth, fifth and sixth magnetic portions 716, 506, 508, the magnetic fields of the fourth, fifth and sixth magnetic portions 716, 706, 708 therefore point in the same direction as they pass through the second voice coil 512 (in particular, in a direction that is perpendicular to the longitudinal axis 404). The magnetic fields therefore form a magnetic circuit through the magnetic element 402, the second voice coil 512 and the fourth magnetic portion 716.

As is further shown in FIG. 30, the fourth magnetic portion 716 is magnetized in the opposite direction to the third magnetic portion 716. The magnetic fields therefore point in the opposite direction through the second voice coil 512 as they do the first voice coil 412. The magnetic fields therefore form a magnetic circuit through the magnetic element 402, and both voice coils 412, 512.

The motor assembly of this example also comprises a cover 736 which at least partially extends around the magnetic element 402, the voice coils 412, 512, the third magnetic portion 616 and the fourth magnetic portion 716. The cover of this example includes end pieces 738a, 738b.

As in the above-described examples, various spacer elements may be incorporated into the motor assembly 700. For example, depending upon the design configurations, the assembly 700 may comprise any or all of: a spacer element 430 positioned between the first magnetic portion 406 and the first end piece 738a, a spacer element 530 positioned between the sixth magnetic portion 508 and the second end piece 738b, a spacer element 432 positioned between the second magnetic portion 408 and the midpiece 550, and a spacer element 532 positioned between the fifth magnetic portion 506 and the midpiece 550.

It will be understood that any of the modifications discussed above in relation to the motor assembly 600 and components thereof, can also be applied to the motor assembly 700 of FIG. 17.

### e. Motor Assembly With Cover for at Least Two Voice Coils

As previously discussed, the present disclosure relates to a motor assembly for a transducer. One or more transducers may be incorporated into a playback device, a network microphone device or a control device such as one of those devices discussed above in relation to FIGS. 1A-H. In some examples, as also described above, one or more transducers according to the disclosed technology can be disposed in/on a vehicle, such as an automobile, boat, etc.

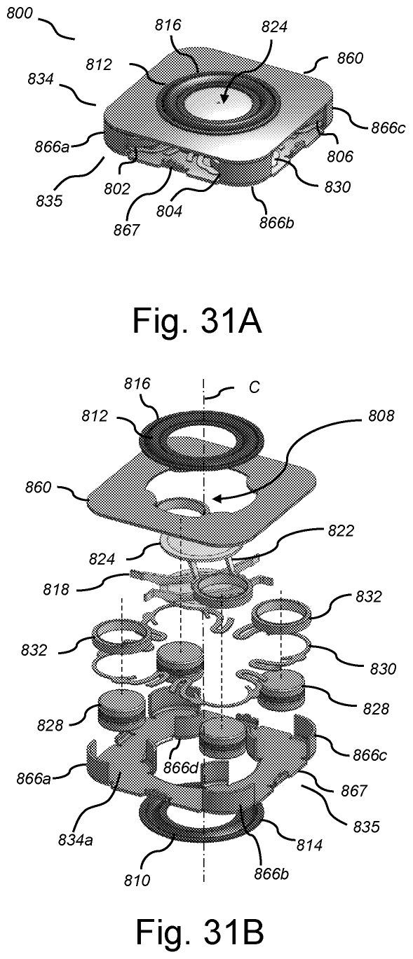

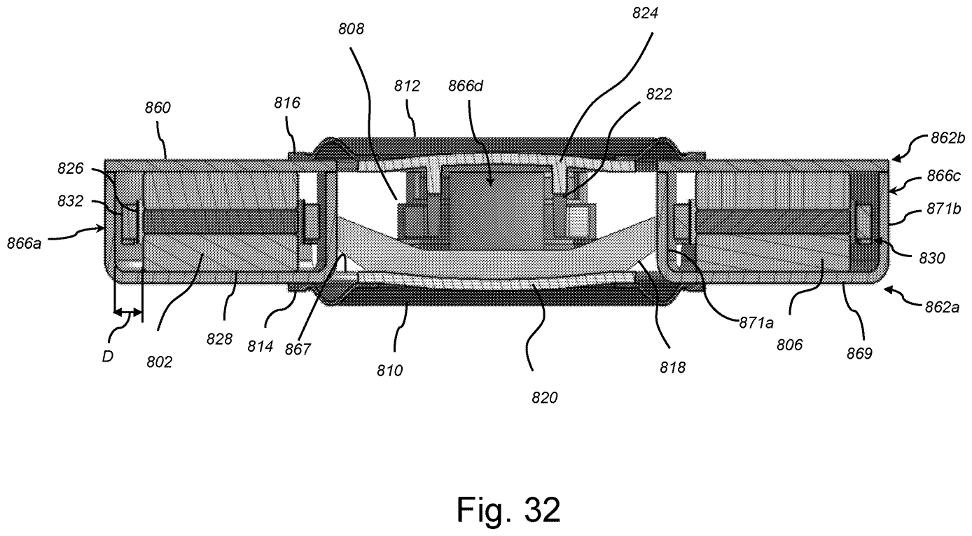

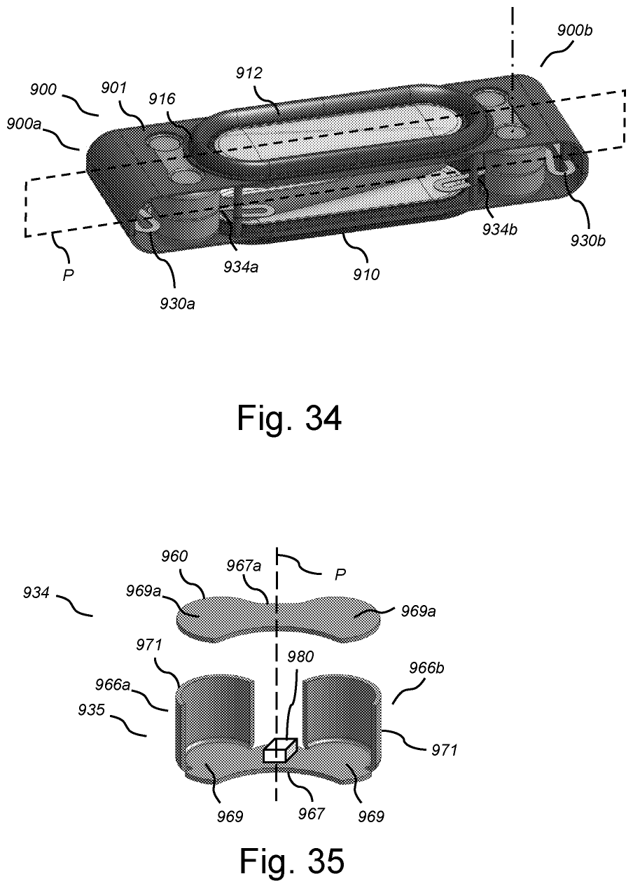

A first type of motor assembly is depicted in FIGS. 31A, 31B and 32. A second type of motor assembly is depicted in FIG. 34. Both types of motor assembly share common features, including a magnetic element, a voice coil, a cover and a member extending through an opening formed in the cover. A single cover houses at least two voice coils, as will be explained in more detail below.

FIG. 31A depicts a transducer 800 comprising a motor assembly. Such a transducer may be fully or at least partially housed within a playback device. In the illustrated example, the motor assembly comprises four motors 802, 804, 806, 808 and a cover 834 that partially encloses each of the four motors 802, 804, 806, 808. In this example, each motor is substantially the same as each other motor. In general, a motor assembly may comprise one or more motors. In some examples, for instance, the motor assembly comprises 6 motors.

In this particular example, motors 802 and 806 are arranged and configured to drive a first membrane 810, and motors 804 and 808 are arranged and configured to drive a second membrane 812. The first and second membranes 810, 812 are annular in this example, but may have alternative shapes in other examples. Motors 802 and 806 are arranged on opposite sides of the first membrane 810 and motors 804 and 808 are arranged on opposite sides of the second membrane 812. The first and second membranes 810, 812 are arranged back-to-back such that acoustic/sound waves, generated by movement of the membranes 810, 812, are directed in opposite directions.

In other examples, the second membrane 812 and associated components, such as motors 804, 808, are omitted. The principles of this disclosure may therefore be applied to single membrane transducers, and is not limited to back-to-back systems.

Further depicted in FIGS. 31A, 31B and 32 is a first suspension ring 814 coupled to the first membrane 810 and a second suspension ring 816 coupled to the second membrane 812. The suspension rings 814, 816 extend around an outer perimeter of the respective membranes 810, 812 and couple the membranes 810, 812 to the cover 834, or frame, of the playback device (as described hereinafter).

Further depicted in FIGS. 31A, 31B and 32 is a first actuating element, where the first actuating element comprises a connecting structure, or ribs, 818 and a first membrane support, or hub, 820. The connecting structure 818 rigidly couples the motors 802, 806 to the first membrane support 820. The first membrane support 820 is generally circular and domed, and is coupled to an underside of the first membrane 810 around an inner perimeter of the first membrane 810. Movement of the first actuating element (such as movement of the connecting structure 818 and the first membrane support 820) transfers movement to the first membrane 810 to generate acoustic waves. In examples, the connecting structure 818 and membrane support 820 are integrally formed.

Similarly, FIGS. 31A, 31B and 32 further depict a second actuating element, where the second actuating element comprises a connecting structure 822 and a second membrane support 824. The connecting structure 822 rigidly couples the motors 804, 808 to the second membrane support 824. The second membrane support 824 is generally circular and domed, and is coupled to an underside of the second membrane 812 around an inner perimeter of the second membrane 812. Movement of the second actuating element (such as movement of the connecting structure 822 and the second membrane support 824) transfers movement to the second membrane 812 to generate acoustic waves. In examples, the connecting structure 822 and membrane support 824 are integrally formed.

Each motor 802, 804, 806, 808 comprises a magnetic element 828 and at least one voice coil 832 extending around the magnetic element. The motors 802, 804, 806, 808 may have any suitable structure, for example as described with reference to any of the earlier examples. In FIG. 31A, the voice coils 832 are contained within respective voice coil supports, such as voice coil support 826, which extend around respective magnetic elements, such as the magnetic element 828 of the first motor 802. In this example, the voice coils 832 are coupled to the respective connecting structures 818, 822 of the respective actuating elements.

Each motor 802, 804, 806, 808 is further associated with a respective suspension element 830 (also referred to as a spider) for coupling the respective voice coils 832 to a support structure, such as a basket or frame of the playback device. As is well known, a spider helps keep a voice coil centered within a motor as the voice coil moves. Example suspension elements are described in PCT Patent Application No. PCT/US2023/074844, entitled “Suspension System for Loudspeaker”, and PCT Patent Application No. PCT/US2023/075366, entitled “Conductive Spider”, both of which are incorporated by reference for all purposes. FIGS. 31A, 31B and 32 for example, depict suspension elements 830 coupled to respective voice coils 832 of the motors 802, 804, 806, 808 via the respective voice coil support 826. In some cases, some or all of the voice coil supports 826 may form part of the respective suspension element 830.

In this example, the motors 802, 804, 806, 808 each comprise a magnetic element 828, which may be of any suitable arrangement, for example as described with reference to any of the earlier examples. The magnetic elements 828 each axially overlap one another along the axis C.

In this particular configuration, the magnetic elements 828 each defines a longitudinal axis of the respective motor 802, 804, 806, 808, as denoted by the dashed lines in FIG. 31B.

As illustrated, the voice coil 832 is arranged relative to the magnetic element 882, such that a magnetic field generated in response to the flow of electric current through the voice coil 832 interacts with magnetic field(s) of the magnetic element 882. This causes the voice coil 832 (and therefore any components coupled to the voice coil 832) to move in a direction along the respective axis. When an audio signal is applied to the voice coil 832, the voice coil 832 therefore oscillates along the axis. FIG. 32 shows the voice coil 832 in a rest or neutral position (having no displacement or excursion along the axis C).

Because the actuating elements are coupled to the voice coils 832 via the voice coil supports 826, movement of the voice coils 832 causes the actuating elements to move. In particular, movement of the voice coils 832 causes the voice coil supports 826 to move, which in turn causes the connecting structures 818, 822 to move, which in turn causes the first and second membrane supports 820, 824 to move, which then causes the respective first and second membranes 210, 212 move. In this way, movement can be transferred to the first and second membranes 210, 212.

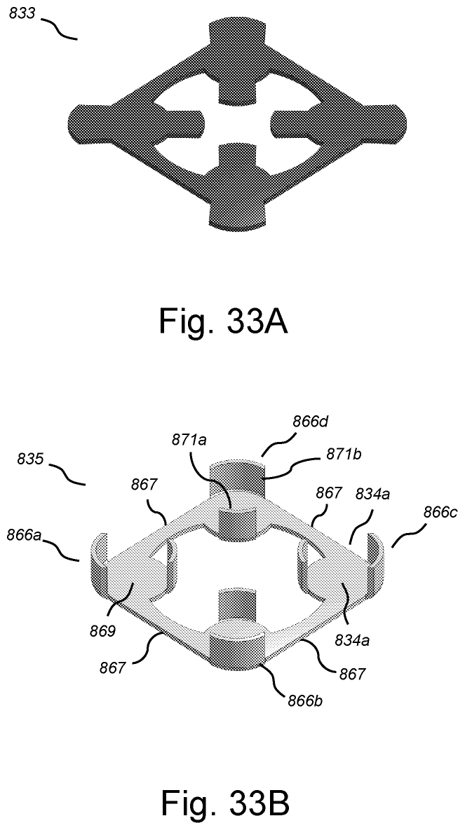

The transducer 800 further comprises a cover 834 having a main body portion 835 and an end-cover 860. In some examples, the main body portion 835 of the cover 834 is formed by stamping a blank 833, as shown in FIG. 33A, to form four portions 866a-d , which are each generally U-shaped cups, connected by four connecting elements 867. Accordingly, the main body portion 835 is integrally formed. The blank 833 is cut from a sheet of material, which in this example has a uniform thickness, but may have a variable thickness in other examples. The main body portion 835 has a thickness substantially equal to the thickness of the sheet from which the blank 833 is formed.

The main body portion 835 is shown in isolation in FIG. 33B. Each of the four portions 866a-d of the main body portion 835, has an endpiece 869, an inner upstanding wall 871a and an outer upstanding wall 871b (collectively referred to as the upstanding walls 871). Respective inner surfaces of the upstanding walls 871 are generally parallel to the direction of movement of the voice coils 832 and the end piece 869 is generally perpendicular to the direction of movement of the voice coils 832. The four connecting elements 867 extend between the end pieces 869 of pairs of adjacent portions 866a-d of the main body portion 835. In this example, the four endpieces 869 and the four connecting elements 867 are substantially co-planar, each lying in a plane that is substantially perpendicular to the direction of movement of the voice coils 832. The four connecting elements 867 act as a heat sink in use of the transducer 800, dissipating heat generated at the four portions 866a-d. In other examples, the cover 834 may have additional heat dissipating features, such as fins.

The inner upstanding wall 871a has a same height, extending parallel to the direction of movement of the voice coils 832, as the outer upstanding wall 871b. The upstanding walls 871 extend partially around the magnetic element 828 and voice coil 832 of a respective one of the motors 802, 804, 806, 808. FIGS. 31A, 31B and 32 for example, depict each portion 866a-d extending around the magnetic element 828, the voice coil support 826 and the voice coil of a respective one of the motors 802, 804, 806, 808. The outer upstanding wall 871b has a greater revolution from the inner upstanding wall 871a in this example.

Each portion 866a-d delimits two openings 834a between opposing ends of the upstanding walls 871 of the respective portion 866a-d. A respective arm of the respective suspension element 830 and respective connecting structure 818, 822 extend through each opening 834a. The openings 834a are aligned with the direction of movement of the respective voice coil 832 so that the members extending through the openings 834a (in this case the arms and connecting structure) can move along the openings, as the voice coil 832 moves.

It will be appreciated that in other examples, the four portions 866a-d may comprise fewer or a greater number of upstanding walls, and thus fewer openings or a greater number of openings. In general, each portion of the main body portion associated with a motor may comprise at least one upstanding wall and at least one opening through which a member (such as part of a suspension element or part of an actuating element) may extend.

The openings 834a are distributed around the four portions 866a-d of the main body portion 835 in a manner such that the main body portion 835 has rotational symmetry about a central axis C of the transducer 800.

In examples, the magnetic element 828 and the respective portion 866a-d are separated by a distance D that is less than 1.3×, less than 1.5×, less than 1.67×, less than 2×, less than 3×, or less than 4× a thickness of the voice coil 832. The distance D and thickness are measured in a direction perpendicular to the direction of movement of the voice coil 832. In examples, this perpendicular direction may be known as a radial direction. The voice coil 832 moves along an excursion path in a direction parallel to the axis.

The cover 834 comprises a first end 862a and a second end 862b, the first end 862a being generally proximal to the first membrane 810, and the second end 862b being generally proximal to the second membrane 812. The main body portion 835 extends from the first end 862a to the second end 862b, and the end-cover 860 is disposed at the second end 862b. In this example, the cover 834 is closed at the first end 862a by the endpieces 869 of the four portions 866a-d and is closed at the second end 862b by the end-cover 860. The end-cover 860 is separate to the main body portion 835 and has a thickness that is substantially equal to the thickness of the main body portion 835. In this example, the end-cover 860 is formed from the same sheet as the blank 833.

Although not present in this example, each of the connecting elements can have one or more apertures extending therethrough. This can reduce an overall weight of the cover 834, and/or may provide routing for wiring.

The cover 834 is made from magnetic material, such as a ferromagnetic material, a ferrimagnetic material or a paramagnetic material. In this particular example, the cover 834 is made from soft iron. As discussed with reference to the earlier examples, this causes at least part of the magnetic field of the magnetic element 828 to be concentrated within the cover 834. In some examples, at least part of the cover 834 is magnetized, for example the upstanding walls 871 and/or the endpieces 869. In some examples, one or more coils may be wound around one of both of the upstanding walls 871 of a portion 866a-d of the main body portion 835.

In this particular example, the end-cover 860 and the main body portion 835 are made from the same material. Accordingly, at least part of the magnetic fields of the magnetic elements 828 is also concentrated within the end-cover 860.

In other examples, the cover 834 omits the end-cover 860 and may instead comprise two main body portions 835 that oppose one another. That is, the two main body portions 835 may be disposed at opposite ends 862a, 862b of the cover 834, and the upstanding walls 877 of the two main body portions 835 may extend towards one another. The two main body portions 835 may be identical to one another.

In this example, the cover 834 acts as a frame of the transducer 800. That is, the suspension elements 830 connect the voice coils 832 to the cover 834. Further, the first and second membranes 810, 812 are mounted to the cover 834 via the respective suspension rings 814, 816.

FIG. 34 depicts a second type of motor assembly. For example, FIG. 34 depicts a transducer 900, comprising a motor assembly, where the motor assembly comprises four motors and two covers 934. Such a transducer 900 may be housed within a playback device. In general, a motor assembly may comprise one or more motors.

The transducer 900 has a somewhat similar arrangement to the transducer 800 described here. Diagonally opposing pairs of the motors are connected to respective first and second membranes 910, 912 by respective actuating elements of a similar connecting structure and membrane support arrangement as described with reference to the transducer 800, and will not be described again in detail, for brevity. The membranes 910, 912 are arranged in a back-to-back configuration such that acoustic/sound waves, generated by movement of the membranes 910, 912, are directed in opposite directions. Rather than being annular, as in the transducer 800, the membranes 910, 912 in this example are of a racetrack shape.

One pair of motors are positioned at a first end 900a of the transducer 900 and a first end of the membranes 910, 912. Another pair of motors are positioned at a second end 900b of the transducer 900 and a second end of the membranes 910, 912. Two motors (one at each end) arranged and configured to drive the first membrane 910, and the other two motors are arranged and configured to drive the second membrane 912 in the same as discussed above for FIG. 31.

The transducer 900 may further comprise a first suspension ring coupled to the first membrane 910 and a second suspension ring 916 coupled to the second membrane 912. The suspension rings 916 may extend around an outer perimeter of the respective membranes 910, 912 and couple the membranes 910, 912 to a basket or frame 901 of the playback device.

Each motor assembly comprises at least a magnetic element, and a voice coil arranged in any suitable manner, such as any motor assembly arrangement described with reference to the earlier examples. The magnetic elements each axially overlap one another along an axis parallel to a direction of movement of the voice coils.

The transducer 900 also comprises first and second suspension elements 930a, 930b (also referred to as spiders). The first suspension element 930a is for coupling the voice coils of the pair of motors to the frame 901 towards the first end 900a. The second suspension element 930b is for coupling the voice coils of the other pair of motors to the frame 901 towards the second end 900b. In other examples, the transducer 900 instead comprises a suspension element for each motor.

As mentioned, the transducer 900 further comprises first and second covers 934a, 934b (collectively referred to as the covers 934), each extending around the two motors at a respective end 900a, 900b of the transducer 900.

As shown most clearly in FIG. 35, which is an exploded view of one of the covers 934, with an end-cover 960 not used in the FIG. 34 example. The covers 934 each delimit two openings through which arms of a respective one of the suspension elements 930a, 930b and connecting structures of the actuating elements extend. The openings are aligned with a direction of movement of the voice coils, so that the members extending through the openings (in this case the arms and connecting structure) can move along the openings, as the voice coils move.

The covers 934 are identical to one another in this example, though may not be in other examples. Whilst only one cover 934 is described herein with reference to FIG. 35, the description is equally applicable to the other cover 934.

The cover 934 has a main body portion 935 and an end-cover 960. The main body portion 935 is formed by stamping a blank, and comprises two portions 966a, 966b and a connecting element 967 extending between the two portions 966a, 966b. Accordingly, the main body portion 935 is integrally formed. The blank is cut from a sheet of magnetic material, which in this example has a uniform thickness, but may have a variable thickness in other examples. The main body portion 935 has a thickness substantially equal to the thickness of the sheet from which the blank is formed. In other examples, the sheet may be magnetizable.

Each of the two portions 966a, 966b of the main body portion 935, has an endpiece 969 and an upstanding wall 971. Respective inner surfaces of the upstanding walls 971 are generally parallel to the direction of movement of the voice coils, denoted by the dashed line in FIG. 34, and the end piece 969 is generally perpendicular to the direction of movement of the voice coils. The connecting element 967 extends between the endpieces 969 of the two portions 966a, 966b. In this example, the endpieces 969 and the connecting element 967 are co-planar, each lying in a plane that is perpendicular to the direction of movement of the voice coils. The connecting element 967 acts as a heat sink in use of the transducer 900, dissipating heat generated at the portions 966a,966b. In other examples, the cover 934 may have additional heat dissipating features, such as fins.

The upstanding walls 971 have a same height, extending parallel to the direction of movement of the voice coils, and revolution as one another. The upstanding walls 971 extend partially around the magnetic element and voice coil of a respective one of the motors. FIG. 34 for example, depicts each portion 966a, 966b extending around the magnetic element, the voice coil support and the voice coil of a respective one of the motors.

Each portion 966a, 966b delimits an opening 934a extending around the respective motor between opposing ends of the upstanding wall 871 of the respective portion 966a, 966b. A respective arm of the suspension element 930 and respective connecting structure extend through each opening 934a. The openings 934a are aligned with the direction of movement of the respective voice coil, so that the members extending through the openings 934a (in this case the arms and connecting structure) can move along the openings, as the voice coil moves.

It will be appreciated that in other examples, the two portions 966a, 966b may comprise a greater number of upstanding walls, and thus a greater number of openings.

The openings 934a are distributed around the two portions 966a, 966b of the main body portion 935 in a manner such that the main body portion 935 has mirror symmetry about a central plane P of the transducer 900, the plane extending from the first end 900a to the second end 900b.

In examples, the magnetic element and the respective portion 966a, 966b are separated by a distance that is less than 1.3×, less than 1.5×, less than 1.67×, less than 2×, less than 3×, or less than 4× a thickness of the voice coil. The distance and thickness are measured in a direction perpendicular to the direction of movement of the voice coil. In examples, this perpendicular direction may be known as a radial direction. The voice coil moves along an excursion path in a direction parallel to the axis.

FIG. 35 shows that the cover 934 comprises a first end and a second end, the first end being generally proximal to the first membrane 910, and the second end being generally proximal to the second membrane 912. The main body portion 935 extends from the first end to the second end, and the end-cover 960 (not used in FIG. 34) is disposed at the second end. In this example, the end-cover 960 comprises two endpieces 969a connected to one another by a connecting element 967a. The end-cover 960 has the same shape as a combined shape of the endpieces 969 and connecting element 967 of the main body portion 935. In FIG. 35, the cover 934 is closed at the first end by the endpieces 969 of the two portions 966a, 966b, and is closed at the second end by the end-cover 960. The end-cover 960 is separate to the main body portion 935 and has a thickness that is substantially equal to the thickness of the main body portion 935. In this example, the end-cover 960 is cut from the same sheet as the blank from which the main body portion 935 is cut.

In other examples, one or both of the covers 934 omits the end-cover 960 and may instead comprise two main body portions 935 that oppose one another. Both the covers 934 may share a single end-cover, or the end cover 960 may be omitted completely. That is, the two main body portions 935 may be disposed at opposite ends of the cover 934, and the upstanding walls 977 of the two main body portions 935 may extend towards one another. The two main body portions 935 may be identical to, and/or a mirror image of, one another. In the construction of FIG. 34, there is no end-cover 960. A gap of distance up to 1 mm between the two covers can be seen, such a gap allows for manufacturing tolerances and has been found to have a very small impact on performance compared to a continuous cover.

As shown in FIG. 35, a position sensor 980 is disposed on the connecting member 967 of the main body portion 935 of each cover 934 (the position sensor 980 is depicted in diagrammatic form). The position sensor 980 is arranged to detect a position of the voice coils surrounded by the respective cover 934 relative to the respective magnetic element 828. The position sensor 980 is configured to output a signal indicative of the detected position to a controller (not shown) of the transducer 900 or a playback device comprising the transducer 900. It will be appreciated that other electronic components, such as thermistor, may alternatively or additionally be mounted to one or both of the covers 934, in any suitable position. Suitable positions include those where electronic components are not in the path of a moving element.

In both example motor assemblies discussed above in FIGS. 31A, 31B, 32 and 34, the covers 834, 934, in particular the portions 866a-c, 966a and 966b, act as a magnetic field return path for the respective magnetic elements for example as described with reference to the earlier example motor assemblies.

It will be appreciated that features and components discussed in the examples of FIGS. 31A, 31B and 32 may apply equally to the examples discussed in FIG. 34 (and vice versa). For example, the cover 834 may have one or more electrical components mounted thereon. For example, one or both of the connecting elements 967, 967a and/or one or both of the portions 966a, 966b may have one or more apertures extending therethrough. A blank from which the cover is stamped may comprise the one or more apertures. The apertures may be arranged in a predefined pattern, for example relative to a load path along the connecting element(s) or a magnetic field path through the portion(s). For example, the materials of the cover 934 can be the same as described for the cover 834 of FIG. 34B.

### IV. Conclusion

The description above discloses, among other things, various example motor assemblies. It is understood that such examples are merely illustrative and should not be considered as limiting.

The above discussions relating to playback devices, controller devices, playback zone configurations, and media content sources provide only some examples of operating environments within which functions and methods described may be implemented. Other operating environments and/or configurations of media playback systems, playback devices, and network devices not explicitly described may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software examples or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references to “example” means that a particular feature, structure, or characteristic described in connection with the example can be included in at least one example of an invention. The appearances of this phrase in various places in the specification are not necessarily all referring to the same example, nor are separate or alternative examples mutually exclusive of other examples. As such, the examples described, explicitly and implicitly understood by one skilled in the art, can be combined with other examples.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples of the present disclosure can be practiced without certain, specific details. In other instances, well known methods, procedures, components, and circuitry have not been described in detail to avoid unnecessarily obscuring examples of the examples. Accordingly, the scope of the present disclosure is defined by the appended claims rather than the foregoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

I/We claim:

1. A motor assembly for a transducer, the motor assembly comprising:
a magnetic element having a longitudinal axis;
a voice coil at least partially surrounding the magnetic element, the voice coil being moveable in a direction parallel to the longitudinal axis;
a cover at least partially enclosing the voice coil and the magnetic element, wherein at least part of a magnetic field of the magnetic element is concentrated within the cover;
and an auxiliary magnetic element arranged between the magnetic element and the cover, wherein the auxiliary magnetic element:
is coupled to the voice coil, such that movement of the voice coil causes the auxiliary magnetic element to move; and
has a second magnetic field arranged relative to the magnetic field of the magnetic element such that a magnetic flux density through the voice coil and cover is increased.

2. The motor assembly of claim 1, wherein the auxiliary magnetic element is offset from the voice coil along the direction of movement of the voice coil, and wherein the magnetic flux density through the voice coil and cover is increased by arranging the second magnetic field relative to the magnetic field of the magnetic element such that the magnetic field of the magnetic element is focused onto the voice coil and into the cover.

3. The motor assembly of claim 2, wherein the voice coil has a first dimension in a radial direction perpendicular to the longitudinal axis, and the auxiliary magnetic element has a second dimension in the radial direction, wherein the second dimension is greater than the first dimension.

4. The motor assembly of claim 2, wherein an inner surface of the cover is spaced from the magnetic element by a gap width in a radial direction perpendicular to the longitudinal axis, and wherein the auxiliary magnetic element has a dimension in the radial direction which is between about 50% and 95% of the gap width.

5. The motor assembly of claim 4, wherein the gap width is between about 3 mm and 15 mm, and the dimension in the radial direction is between about 2 mm and 13 mm.

6. The motor assembly of claim 1, wherein:
the auxiliary magnetic element is offset from the voice coil in a direction perpendicular to the direction of movement of the voice coil;
the auxiliary magnetic element has a magnetic axis; and
the magnetic flux density through the voice coil and cover is increased by arranging the magnetic axis substantially perpendicular to the direction of movement of the voice coil.

7. The motor assembly of claim 1, further comprising a second auxiliary magnetic element arranged between the magnetic element and the cover, wherein the second auxiliary magnetic element:
is coupled to the voice coil, such that movement of the voice coil causes the second auxiliary magnetic element to move; and
has a third magnetic field arranged relative to the magnetic field of the magnetic element such that the magnetic flux density through the voice coil and cover is further increased.

8. The motor assembly of claim 7, further comprising a third auxiliary magnetic element arranged between the magnetic element and the cover, wherein the third auxiliary magnetic element:
is coupled to the voice coil, such that movement of the voice coil causes the third auxiliary magnetic element to move; and
has a fourth magnetic field arranged relative to the magnetic field of the magnetic element such that the magnetic flux density through the voice coil and cover is further increased; and
wherein:
the auxiliary magnetic element is offset from the voice coil along the direction of movement of the voice coil in a first direction;
the second auxiliary magnetic element is offset from the voice coil along the direction of movement of the voice coil in a second direction, opposite to the first direction; and
the third auxiliary magnetic element is offset from the voice coil in a direction perpendicular to the direction of movement of the voice coil.

9. The motor assembly of claim 1, wherein:
the voice coil is a first voice coil;
the auxiliary magnetic element is a first auxiliary magnetic element; and
the motor assembly further comprises:
a second voice coil at least partially surrounding the magnetic element and offset along the magnetic element from the first voice coil, the cover at least partially enclosing the second voice coil;
a midpiece extending between the first and second voice coils; and
a second auxiliary magnetic element arranged between the magnetic element and the cover, wherein the second auxiliary magnetic element:
is coupled to the second voice coil, such that movement of the second voice coil causes the second auxiliary magnetic element to move; and
is offset from the second voice coil along the direction of movement of the second voice coil and positioned between the second voice coil and the midpiece along the direction of movement of the second voice coil;
wherein the first auxiliary magnetic element is offset from the first voice coil along the direction of movement of the first voice coil and positioned between the first voice coil and the midpiece along the direction of movement of the first voice coil.

10. The motor assembly of claim 9, wherein the first and second voice coils are each moveable from a rest position to a maximum excursion position, and wherein the first and second auxiliary magnetic elements are arranged such that when the first and second voice coils are both at the maximum excursion positions, the first and second auxiliary magnetic elements are separated by a distance that is great enough to avoid magnetic interference.

11. A transducer, comprising:
a motor assembly comprising:
a magnetic element having a longitudinal axis;
a voice coil at least partially surrounding the magnetic element, the voice coil being moveable in a direction parallel to the longitudinal axis;
a cover at least partially enclosing the voice coil and the magnetic element, wherein at least part of a magnetic field of the magnetic element is concentrated within the cover; and
an auxiliary magnetic element arranged between the magnetic element and the cover, wherein the auxiliary magnetic element:
is coupled to the voice coil, such that movement of the voice coil causes the auxiliary magnetic element to move; and
has a second magnetic field arranged relative to the magnetic field of the magnetic element such that a magnetic flux density through the voice coil and cover is increased; and
a membrane coupled to the voice coil.

12. The transducer of claim 11, wherein the auxiliary magnetic element is offset from the voice coil along the direction of movement of the voice coil, and wherein the magnetic flux density through the voice coil and cover is increased by arranging the second magnetic field relative to the magnetic field of the magnetic element such that the magnetic field of the magnetic element is focused onto the voice coil and into the cover.

13. The transducer of claim 12, wherein the voice coil has a first dimension in a radial direction perpendicular to the longitudinal axis, and the auxiliary magnetic element has a second dimension in the radial direction, wherein the second dimension is greater than the first dimension.

14. The transducer of claim 12, wherein an inner surface of the cover is spaced from the magnetic element by a gap width in a radial direction perpendicular to the longitudinal axis, and wherein the auxiliary magnetic element has a dimension in the radial direction which is between about 50% and 95% of the gap width.

15. The transducer of claim 11, wherein:
the auxiliary magnetic element is offset from the voice coil in a direction perpendicular to the direction of movement of the voice coil;
the auxiliary magnetic element has a magnetic axis; and
the magnetic flux density through the voice coil and cover is increased by arranging the magnetic axis substantially perpendicular to the direction of movement of the voice coil.

16. The transducer of claim 11, wherein the motor assembly further comprises a second auxiliary magnetic element arranged between the magnetic element and the cover, wherein the second auxiliary magnetic element:
is coupled to the voice coil, such that movement of the voice coil causes the second auxiliary magnetic element to move; and
has a third magnetic field arranged relative to the magnetic field of the magnetic element such that the magnetic flux density through the voice coil and cover is further increased.

17. The transducer of claim 16, wherein the motor assembly further comprises a third auxiliary magnetic element arranged between the magnetic element and the cover, wherein the third auxiliary magnetic element:
is coupled to the voice coil, such that movement of the voice coil causes the third auxiliary magnetic element to move; and
has a fourth magnetic field arranged relative to the magnetic field of the magnetic element such that the magnetic flux density through the voice coil and cover is further increased; and
wherein:
the auxiliary magnetic element is offset from the voice coil along the direction of movement of the voice coil in a first direction;
the second auxiliary magnetic element is offset from the voice coil along the direction of movement of the voice coil in a second direction, opposite to the first direction; and
the third auxiliary magnetic element is offset from the voice coil in a direction perpendicular to the direction of movement of the voice coil.

18. The transducer of claim 11, wherein:
the voice coil is a first voice coil;
the auxiliary magnetic element is a first auxiliary magnetic element; and
the motor assembly further comprises:
a second voice coil at least partially surrounding the magnetic element and offset along the magnetic element from the first voice coil, the cover at least partially enclosing the second voice coil;
a midpiece extending between the first and second voice coils; and
a second auxiliary magnetic element arranged between the magnetic element and the cover, wherein the second auxiliary magnetic element:
is coupled to the second voice coil, such that movement of the second voice coil causes the second auxiliary magnetic element to move; and
is offset from the second voice coil along the direction of movement of the second voice coil and positioned between the second voice coil and the midpiece along the direction of movement of the second voice coil;
wherein the first auxiliary magnetic element is offset from the first voice coil along the direction of movement of the first voice coil and positioned between the first voice coil and the midpiece along the direction of movement of the first voice coil.

19. The transducer of claim 18, wherein the first and second voice coils are each moveable from a rest position to a maximum excursion position, and wherein the first and second auxiliary magnetic elements are arranged such that when the first and second voice coils are both at the maximum excursion positions, the first and second auxiliary magnetic elements are separated by a distance that is great enough to avoid magnetic interference.

20. A playback device comprising a transducer, the transducer comprising:
a motor assembly comprising:
a magnetic element having a longitudinal axis;
a voice coil at least partially surrounding the magnetic element, the voice coil being moveable in a direction parallel to the longitudinal axis;
a cover at least partially enclosing the voice coil and the magnetic element, wherein at least part of a magnetic field of the magnetic element is concentrated within the cover; and
an auxiliary magnetic element arranged between the magnetic element and the cover, wherein the auxiliary magnetic element:
is coupled to the voice coil, such that movement of the voice coil causes the auxiliary magnetic element to move; and
has a second magnetic field arranged relative to the magnetic field of the magnetic element such that a magnetic flux density through the voice coil and cover is increased; and
a membrane coupled to the voice coil.
